(19) United States
(12) Patent Application Publication
(10) Pub. No.: US 2025/0023380 A1
(43) Pub. Date: Jan. 16, 2025

(54) ELECTRIC POWER DEVICE, ELECTROMECHANICAL CONVERSION DEVICE, ELECTRICITY STORAGE DEVICE, ELECTRIC POWER SYSTEM, METHOD FOR CONTROLLING ELECTRIC POWER SYSTEM, AND STORAGE MEDIUM

(71) Applicant: HONDA MOTOR CO., LTD., Tokyo (JP)

(72) Inventor: Yukihiro Hosoe, Wako-shi, Saitama (JP)

(21) Appl. No.: 18/712,811

(22) PCT Filed: Nov. 25, 2022
(86) PCT No.: PCT/JP2022/043623

§ 371 Date: May 23, 2024

(30) Foreign Application Priority Data
Nov. 25, 2021 (JP) 2021-191015

(51) Int. Cl. H02J 7/34; H02J 1/10; H02J 7/14; B60L 53/57

(52) U.S. Cl. CPC H02J 7/345; H02J 1/106; H02J 7/14; B60L 53/57

(57) ABSTRACT

An electromechanical conversion unit of an electric power device includes an input unit and a conversion unit. When kinetic energy generated by the movement of a power storage device is input to the input unit, the conversion unit converts the kinetic energy into electric energy.

### TECHNICAL FIELD

The present invention relates to an electrical power device, a mechanical/electrical conversion device (an electromechanical conversion device), an electrical power storage device (an electricity storage device), an electrical power system, a method of controlling an electrical power system, a program, and a storage medium.

### BACKGROUND ART

In WO 2018/147046 A1, a storage battery management system is disclosed which is equipped with two electrical power storage devices, and an electrical power device in which the two electrical power storage devices are attachably and detachably mounted. Each of the two electrical power storage devices includes an electrical power storage unit.

The electrical power device includes a sub-battery that is another electrical power storage unit. The electrical power device generates a starting signal (an activation signal) based on the electrical power supplied from the sub-battery. The electrical power device starts outputting a starting signal, which is generated based on the electrical power supplied from the sub-battery, to the two electrical power storage devices, in the form of a starting command in order to cause the two electrical power storage devices to be started. In accordance with this feature, based on the activation signal from the electrical power device, each of the two electrical power storage devices switches from an inactive state to an active state. Moreover, the inactive state is a state in which the electrical power storage unit in the interior of the electrical power storage device and the exterior of the electrical power storage device are incapable of being electrically connected. The active state is a state in which the electrical power storage unit in the interior of the electrical power storage device and the exterior of the electrical power storage device are capable of being electrically connected.

### SUMMARY OF THE INVENTION

In this manner, in order to cause the electrical power storage devices to be started, it is necessary for the electrical power to be supplied from the sub-battery to the electrical power storage devices. Consequently, for example, at a time when the electrical power storage device is transported by itself, it is possible to prevent the electrical power storage device from being started and unnecessarily outputting electrical power to the exterior.

However, a separate sub-battery is required in order to cause the electrical power storage devices to be started. Additionally, a sensor is required in order to monitor the sub-battery. Due to the presence of the sub-battery, the cost burden imposed on the user becomes larger. The cost, as well as the weight and size of the electrical power device increases. Further, when a lead battery or a lithium ion battery is used as a sub-battery, it is necessary to replace the sub-battery when the useful lifetime of the sub-battery comes to an end. The expense burden as well as the work burden imposed on the user becomes larger when the sub-battery is replaced. Further, since the used sub-battery after having been replaced is discarded, the environmental burden also becomes greater. In view of such problems, it is desired to reduce the size and scale of the sub-battery, or alternatively, to eliminate the sub-battery.

The present invention has the object of solving the aforementioned problem.

A first aspect of the present invention is characterized by an electrical power device equipped with a connection unit to which an electrical power storage device is connected, an electrical operation unit electrically connected to the connection unit, a retaining unit configured to attachably and detachably retain the electrical power storage device, and a mechanical-electrical conversion unit, wherein the electrical power storage device includes an electrical power storage unit, and an activation processing unit configured to switch a state of the electrical power storage device to an active state in which the electrical power storage unit and an exterior of the electrical power storage unit are electrically connectable, or alternatively, to an inactive state in which the electrical power storage unit and the exterior of the electrical power storage unit are not electrically connectable, wherein the electrical power device, or alternatively, an installation device installed in the electrical power device includes an activation command unit configured to output a command to the activation processing unit, and another electrical power storage unit electrically connected to the activation command unit, and wherein the activation processing unit is provided so as to be switched to the active state or the inactive state in accordance with the command output from the activation command unit, and the mechanical-electrical conversion unit includes an input unit disposed in a manner so as to receive kinetic energy accompanying movement of the electrical power storage device in a case that the electrical power storage device is attached and detached with respect to the retaining unit, and a conversion unit configured to convert the kinetic energy input to the input unit into electrical energy, the mechanical-electrical conversion unit being electrically connected to the other electrical power storage unit.

A second aspect of the present invention is characterized by an electrical power device equipped with a connection unit to which an electrical power storage device is connected, an electrical operation unit electrically connected to the connection unit, a retaining unit configured to attachably and detachably retain the electrical power storage device, and a mechanical-electrical conversion unit, wherein the electrical power storage device includes an electrical power storage unit, and an activation processing unit configured to switch a state of the electrical power storage device to an active state in which the electrical power storage unit and an exterior of the electrical power storage unit are electrically connectable, or alternatively, to an inactive state in which the electrical power storage unit and the exterior of the electrical power storage unit are not electrically connectable, wherein the electrical power device, or alternatively, an installation device installed in the electrical power device includes an activation command unit configured to output a command to the activation processing unit, and another electrical power storage unit electrically connected to the activation command unit, and wherein the activation processing unit is provided so as to be switched to the active state or the inactive state in accordance with the command output from the activation command unit, and the mechanical-electrical conversion unit includes an input unit disposed in a manner so as to receive kinetic energy accompanying an input of human power, and a conversion unit configured to convert the kinetic energy input to the input unit into electrical energy, the mechanical-electrical conversion unit being electrically connected to the other electrical power storage unit.

A third aspect of the present invention is characterized by a mechanical-electrical conversion device equipped with an input unit, and a conversion unit configured to convert kinetic energy input to the input unit into electrical energy, wherein, in a retention device including a retaining unit on which a component is attachably and detachably retained, the input unit is disposed in a manner so as to receive the kinetic energy accompanying movement of the component in a case that the component is attached and detached with respect to the retaining unit.

A fourth aspect of the present invention is characterized by an electrical power storage device including an electrical power storage unit, the electrical power storage device including an activation processing unit configured to switch a state of the electrical power storage device to an active state in which the electrical power storage unit and an exterior of the electrical power storage device are electrically connectable, or alternatively, an inactive state in which the electrical power storage unit and the exterior of the electrical power storage device are not electrically connectable, and another connection unit, wherein the other connection unit is electrically connected to a mechanical-electrical conversion unit including an input unit disposed in a manner so as to receive kinetic energy accompanying an input of human power, and a conversion unit configured to convert the kinetic energy input to the input unit into electrical energy, is electrically connected to the activation processing unit, or alternatively, is electrically connected to an activation command unit configured to output a command to the activation processing unit.

A fifth aspect of the present invention is characterized by an electrical power system including the electrical power device and the electrical power storage device according to the first aspect or the second aspect.

A sixth aspect of the present invention is characterized by a method of controlling an electrical power system equipped with an electrical power storage device, and an electrical power device to which the electrical power storage device is connected, wherein the electrical power storage device includes an electrical power storage unit, and an activation processing unit configured to switch a state of the electrical power storage device to an active state in which the electrical power storage unit and an exterior of the electrical power storage unit are electrically connectable, or alternatively, to an inactive state in which the electrical power storage unit and the exterior of the electrical power storage unit are not electrically connectable, the electrical power device includes a connection unit to which the electrical power storage device is connected, an electrical operation unit electrically connected to the connection unit, a retaining unit configured to attachably and detachably retain the electrical power storage device, and a mechanical-electrical conversion unit, the electrical power device, or alternatively, an installation device installed in the electrical power device includes an activation command unit configured to output a command to the activation processing unit, and another electrical power storage unit electrically connected to the activation command unit, and the mechanical-electrical conversion unit includes an input unit disposed in a manner so as to receive kinetic energy accompanying movement of the electrical power storage device in a case that the electrical power storage device is attached and detached with respect to the retaining unit, and a conversion unit configured to convert the kinetic energy input to the input unit into electrical energy, the mechanical-electrical conversion unit being electrically connected to the other electrical power storage unit, the method of controlling including a first step in which the electrical power storage device is installed in the retaining unit, a second step in which the mechanical-electrical conversion unit receives the kinetic energy accompanying movement of the electrical power storage device, and converts the kinetic energy into electrical energy, a third step in which the other electrical power storage unit stores the electrical energy converted by the mechanical-electrical conversion unit, a fourth step in which the activation command unit outputs the command to the activation processing unit by a stored electrical power of the other electrical power storage unit, and a fifth step in which the activation processing unit receives the command, and switches the electrical power storage device to the active state.

A seventh aspect of the present invention is characterized by a program configured to cause a computer to execute the method of controlling the electrical power system according to the sixth aspect.

An eighth aspect of the present invention is characterized by a storage medium configured to store the program according to the seventh aspect.

According to the present invention, it is possible to reduce the size and scale of the sub-battery, or to eliminate the sub-battery. More specifically, it is possible to reduce the size and scale of the other electrical power storage unit that is mounted in the electrical power device, and thus the capacity of the other electrical power storage unit can be reduced. Consequently, together with making it possible to avoid an increase in the size and scale of the electrical power device, it is possible to suppress a rise in the cost of the electrical power device. Accordingly, with the present invention, the cost and weight of the electrical power device can be reduced, and the size of the electrical power device can be made smaller. Further, it becomes unnecessary to carry out maintenance on the electrical power device.

### BRIEF DESCRIPTION OF DRAWINGS

FIG. 1 is a configuration diagram of an electrical power device according to a first embodiment;

FIG. 2 is a graph showing a change over time in an amount of electrical charge when discharging an electrical charge accumulated in a capacitor;

FIG. 3 is a flowchart showing operations of the first embodiment;

FIG. 4 is a configuration diagram of an electrical power device according to a second embodiment;

FIG. 5 is a flowchart showing operations of the second embodiment;

FIG. 6A, FIG. 6B, and FIG. 6C are diagrams showing operations of a first exemplary embodiment;

FIG. 7A and FIG. 7B are diagrams showing operations of a second exemplary embodiment;

FIG. 8A and FIG. 8B are diagrams showing operations of a third exemplary embodiment;

FIG. 9A and FIG. 9B are diagrams showing operations of a fourth exemplary embodiment;

FIG. 10A and FIG. 10B are diagrams showing operations of the fourth exemplary embodiment;

FIG. 11 is a perspective view of an electrical power device according to the third embodiment;

FIG. 12 is a perspective view of the attachment and detachment of an electrical power storage device with respect to the electrical power device;

FIG. 13 is a diagram illustrating the attachment and detachment of the electrical power storage device with respect to the electrical power device;

FIG. 14A and FIG. 14B are diagrams showing a fitting operation of a connector;

FIG. 15 is a configuration diagram of the electrical power system;

FIG. 16A and FIG. 16B are diagrams showing a first exemplary modification;

FIG. 17A and FIG. 17B are diagrams showing a second exemplary modification;

FIG. 18 is a diagram showing the second exemplary modification;

FIG. 19 is a diagram showing a third exemplary modification;

FIG. 20 is a diagram showing a fourth exemplary modification;

FIG. 21 is a diagram showing a fifth exemplary modification;

FIG. 22A and FIG. 22B are diagrams showing a sixth exemplary modification;

FIGS. 23A and 23B are diagrams showing a seventh exemplary modification;

FIG. 24 is a configuration diagram showing an eighth exemplary modification;

FIG. 25 is a flowchart showing operations of the electrical power system;

FIG. 26A and FIG. 26B are diagrams showing a ninth exemplary modification;

FIG. 27 is a diagram showing the ninth exemplary modification;

FIG. 28A and FIG. 28B are diagrams showing a tenth exemplary modification;

FIG. 29 is a diagram showing the tenth exemplary modification;

FIG. 30A and FIG. 30B are diagrams showing an eleventh exemplary modification;

FIG. 31 is a diagram showing the eleventh exemplary modification;

FIG. 32A and FIG. 32B are diagrams showing a twelfth exemplary modification;

FIG. 33A and FIG. 33B are diagrams showing the twelfth exemplary modification;

FIG. 34A and FIG. 34B are diagrams showing the twelfth exemplary modification;

FIG. 35 is a diagram showing a thirteenth exemplary modification;

FIG. 36 is a diagram showing a fourteenth exemplary modification;

FIG. 37A and FIG. 37B are diagrams showing a fifteenth exemplary modification;

FIG. 38 is a diagram showing a sixteenth exemplary modification;

FIG. 39A and FIG. 39B are diagrams showing a seventeenth exemplary modification;

FIG. 40A and FIG. 40B are diagrams showing the seventeenth exemplary modification; and

FIG. 41 is a diagram showing an eighteenth exemplary modification.

### DESCRIPTION OF THE INVENTION

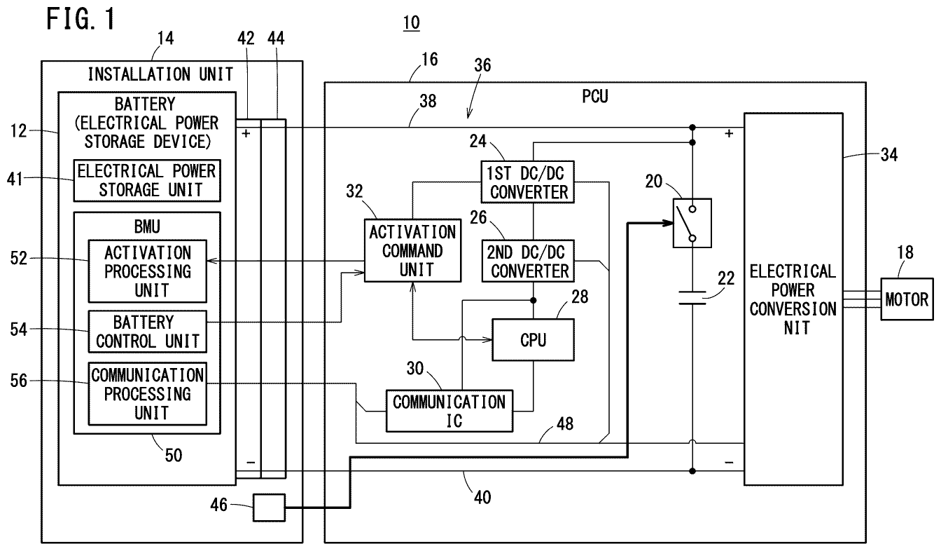

FIG. 1 is a configuration diagram of an electrical power device 10 (a retention device) according to a first embodiment;

The electrical power device 10 includes a battery 12 (an electrical power storage device, a component), an installation unit 14 (a retaining unit), a PCU (a Power Control Unit) 16, and a motor 18 (an electrical operation unit). The battery 12 is installed in the installation unit 14 such as a slot or the like. The battery 12 is attachable and detachable with respect to the installation unit 14. More specifically, the battery 12 is a mobile battery that is attachable to and detachable from the electrical power device 10. Further, the battery 12 is a mobile battery that is capable of being charged and discharged. The battery 12, for example, is preferably a removable lithium ion battery pack. Moreover, in the first embodiment, the battery 12 may be fixed in the installation unit 14.

The electrical power device 10 need only be equipped with one of the batteries 12. In the case that the electrical power device 10 is equipped with a plurality of the batteries 12, it is sufficient if at least one of the batteries 12 from among the plurality of the batteries 12 is attachable and detachable with respect to the electrical power device 10. In this case, it is more preferable for the battery 12 to be attachable and detachable with respect to the electrical power device 10 without using a separate working tool or the like. Stated otherwise, the battery 12 is configured in a manner so as to be attachable and detachable with respect to the electrical power device 10 without using a working tool or the like. Further, the term “attached and detached with respect to the electrical power device 10” includes a case in which the battery 12 is attached to the electrical power device 10, and a case in which the battery 12 is detached from the electrical power device 10. In the following description, a description will be given concerning a case in which one battery 12 is attachable and detachable with respect to the electrical power device 10.

A PCU 16 is disposed between the battery 12 and the motor 18. The PCU 16 is an electrical power source circuit for the purpose of supplying electrical power to the motor 18. The PCU 16 includes a connection/disconnection unit 20, a capacitor 22 (another electrical power storage unit), a first DC/DC converter 24, a second DC/DC converter 26, a CPU (Central Processing Unit) 28, a communication IC (Integrated Circuit) 30, an activation command unit 32, and an electrical power conversion unit 34 (an electrical operation unit).

In the case that the battery 12 is installed in the installation unit 14, the battery 12 and the electrical power conversion unit 34 are capable of transmitting and receiving electrical power via an electrical power transmission pathway 36. More specifically, a positive electrode of the battery 12 is electrically connected, via one electrical power line 38, to a positive electrode of an input side (a primary side) of the electrical power conversion unit 34. A negative electrode of the battery 12 is electrically connected, via another electrical power line 40, to a negative electrode on the input side of the electrical power conversion unit 34. The motor 18 is electrically connected to an output side (a secondary side) of the electrical power conversion unit 34.

The electrical power conversion unit 34 includes an inverter. The electrical power conversion unit 34 converts the DC electrical power supplied from the battery 12 into an AC electrical power. The motor 18 is driven by the AC electrical power supplied from the electrical power conversion unit 34. In the case that electrical power is generated by the motor 18, the electrical power conversion unit 34 converts the AC electrical power supplied from the motor 18 into a DC electrical power. The battery 12 stores (is charged by) the DC electrical power supplied from the electrical power conversion unit 34.

A positive electrode of the capacitor 22 is electrically connected to the one electrical power line 38 via the connection/disconnection unit 20. A negative electrode of the capacitor 22 is electrically connected to the other electrical power line 40. More specifically, a series circuit of the connection/disconnection unit 20 and the capacitor 22 is connected in parallel with respect to the battery 12, the electrical power conversion unit 34, and the motor 18.

The capacitor 22 functions as a smoothing capacitor with respect to an electrical power conversion operation in the electrical power conversion unit 34, the first DC/DC converter 24, or the second DC/DC converter 26. Accordingly, the capacitor 22 can also be included in the interior of the electrical power conversion unit 34, the first DC/DC converter 24, or the second DC/DC converter 26. Further, the capacitor 22 stores as an electrical charge the DC electrical power supplied via the electrical power transmission pathway 36. Alternatively, the capacitor 22 discharges the electrical charge via the electrical power transmission pathway 36 or the like. Moreover, the capacitor 22 may be provided so as to be attachable and detachable with respect to the PCU 16.

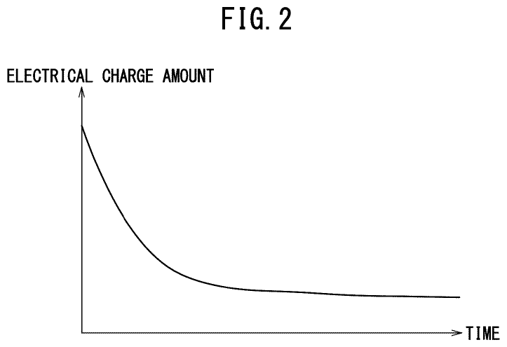

As shown in FIG. 2, the amount of electrical charge (electrical charge amount) accumulated in the capacitor 22 (refer to FIG. 1) decreases accompanying the elapse of time. As will be discussed later, if the amount of electrical charge is comparatively large, an amount of electrical charge sufficient to start the CPU 28 (the computer) and the activation command unit 32 can be secured. Further, as time elapses, and the amount of electrical charge decreases to a certain value, it becomes impossible for the amount of electrical charge sufficient to activate the CPU 28 and the activation command unit 32 to be secured. Moreover, it should be noted that the curve illustrating changes in the amount of electrical charge over time shown in FIG. 2 changes in accordance with the capacitance of the capacitor 22. Specifically, in the case of a capacitor having a comparatively large capacitance such as an electric double layer capacitor or the like, even as time elapses, the amount of electrical charge does not decrease much over time. Further, in the case of a capacitor having a comparatively small capacitance such as a multilayer ceramic capacitor or an electrolytic capacitor or the like, there is a possibility that, as time elapses, an amount of electrical charge sufficient to start the CPU 28 and the activation command unit 32 cannot be secured.

The connection/disconnection unit 20 is a changeover switch that is switched from OFF to ON by way of an operation of the user.

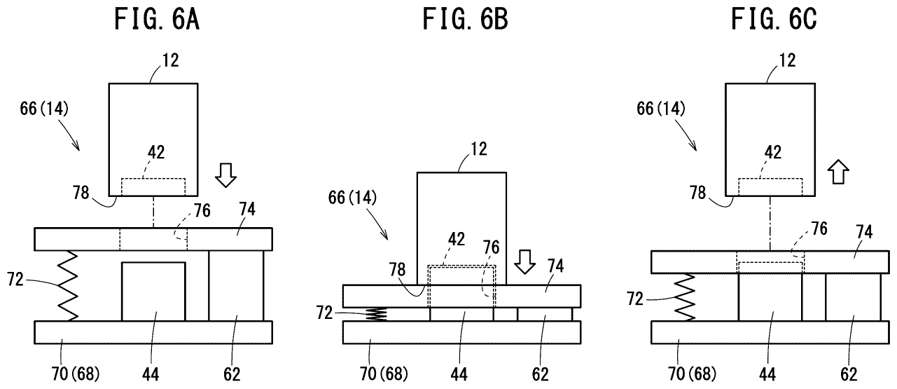

The battery 12 includes an electrical power storage unit 41 and a connector 42 (another connection unit). The electrical power storage unit 41 is made up from a plurality of cells that are connected in series. The electrical power storage unit 41 is a secondary battery. The connector 42 is a female connector (refer to FIG. 6A). The connector 42 is also referred to as a receptacle.

The installation unit 14 includes a connector 44 (a connection unit) and a detection unit 46. The connector 44 is a male connector (refer to FIG. 6A). The connector 44 is also referred to as a plug.

When the user has installed the battery 12 in the installation unit 14, the two connectors 42 and 44 are connected (fitted together). Further, when the user has taken out the battery 12 from the installation unit 14, the two connectors 42 and 44 become placed in a disconnected state.

The detection unit 46 detects that the two connectors 42 and 44 have become placed in a disconnected state. In the case that the detection unit 46 has detected that the two connectors 42 and 44 have been placed in the disconnected state, then based on the detection result of the detection unit 46, the connection/disconnection unit 20 is switched from ON to OFF. Moreover, it should be noted that the detection unit 46 and the connection/disconnection unit 20 may be mechanically connected by a coupling mechanism (not shown). In accordance therewith, in the case that the detection unit 46 has detected the disconnected state of the two connectors 42 and 44, the connection/disconnection unit 20 can be mechanically switched from ON to OFF.

When the battery 12 is installed in the installation unit 14, and the two connectors 42 and 44 are placed in the connected state, the electrical power storage unit 41 of the battery 12 is capable of supplying the DC electrical power to the PCU 16. More specifically, when the battery 12 is installed in the installation unit 14, the electrical power device 10 is placed in a started state in which the motor 18 can be driven. Further, when the two connectors 42 and 44 are placed in the disconnected state, the electrical power storage unit 41 of the battery 12 is incapable of supplying the DC electrical power to the PCU 16. More specifically, when the two connectors 42 and 44 are placed in the disconnected state, the electrical power device 10 is placed in an unstarted state in which the motor 18 is incapable of being driven.

The first DC/DC converter 24 steps down a DC voltage of the electrical power transmission pathway 36 to a predetermined value of the DC voltage. The stepped down DC voltage is supplied to the second DC/DC converter 26 and the activation command unit 32. The second DC/DC converter 26 further steps down the DC voltage supplied from the first DC/DC converter 24. The second DC/DC converter 26 supplies the stepped-down DC voltage to the CPU 28 and the communication IC 30.

Each of the CPU 28 and the communication IC 30 is driven by the DC voltage supplied from the second DC/DC converter 26. The CPU 28 controls each of components of the electrical power device 10. The communication IC 30 enables transmission and reception of signals or information, via a communication line 48 such as a CAN (Controller Area Network) or the like, to and from the electrical power conversion unit 34, the first DC/DC converter 24, the second DC/DC converter 26, and the battery 12.

The activation command unit 32 generates the activation signal based on the DC electrical voltage supplied from the second DC/DC converter 26. The activation command unit 32 supplies the generated activation signal to the battery 12 via the two connectors 42 and 44.

The battery 12 further includes a BMU (Battery Management Unit) 50 for the purpose of controlling the battery 12 as a whole. The BMU 50 includes an activation processing unit 52, a battery control unit 54, and a communication processing unit 56.

Based on the activation signal, the activation processing unit 52 switches the state of the battery 12 from an inactive state in which the electrical power storage unit 41 and the exterior of the battery 12 are not electrically connectable to each other, to an active state in which the electrical power storage unit 41 and the exterior of the battery 12 are electrically connectable. Accordingly, in the inactive state, electrical power is incapable of being output from the electrical power storage unit 41. Further, in the active state, electrical power is capable of being output from the electrical power storage unit 41.

For example, the battery control unit 54 detects changes in the state (the voltage, the SOC, etc.) of each of the cells of the electrical power storage units 41 of the battery 12, and adjusts the state of charge of each of the cells to be uniform. Further, the battery control unit 54 controls a switch (not shown) under a control from the CPU 28 or the like, and thereby enables electrical power to be output from the electrical power storage unit 41.

The communication processing unit 56 communicates with the CPU 28 in accordance with a predetermined protocol. For example, via the communication line 48 and the communication IC 30, the communication processing unit 56 communicates information with the CPU 28 for the purpose of controlling charging and discharging of the battery 12.

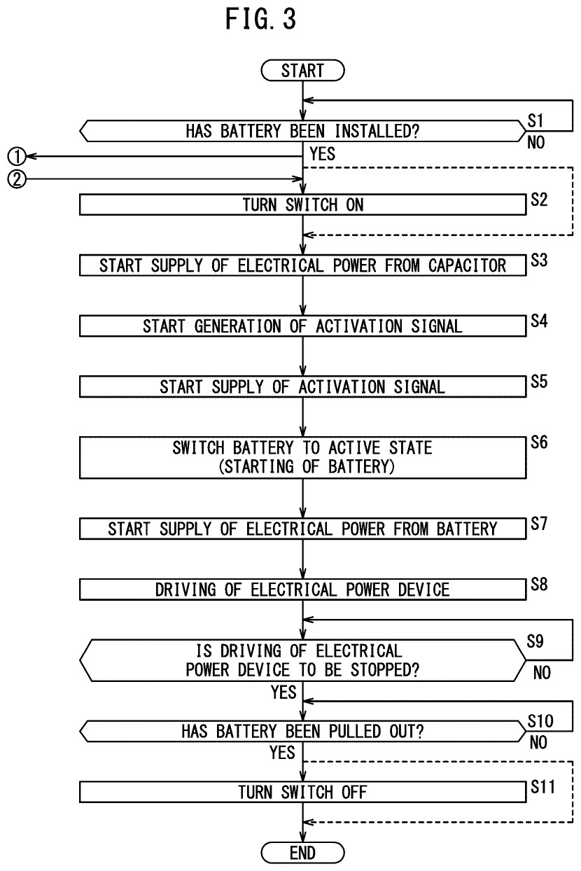

The electrical power device 10 according to the first embodiment is configured in the manner described above. Next, a description will be given with reference to the flowchart of FIG. 3 concerning the operations of the electrical power device 10. In this instance, as necessary, descriptions will be given also with reference to FIG. 1 and FIG. 2. Moreover, in the description that follows, a case will be described in which an amount of electrical charge, which is sufficient to cause the CPU 28, the communication IC 30, and the activation command unit 32 to be started, is accumulated beforehand in the capacitor 22.

First, in step S1 (the first step), when the user installs the battery 12 (refer to FIG. 1) in the installation unit 14, the connector 42 of the battery 12 and the connector 44 of the installation unit 14 are connected (step S1: YES).

In the next step S2, the user turns ON the connection/disconnection unit 20.

Consequently, in step S3, the capacitor 22 discharges the electrical charge that is accumulated in the capacitor 22. In accordance therewith, the supply of the DC electrical power (the DC voltage) from the capacitor 22 to the first DC/DC converter 24 is started. The first DC/DC converter 24 steps down the DC voltage supplied from the capacitor 22. The second DC/DC converter 26 further steps down the DC voltage supplied from the first DC/DC converter 24.

In the next step S4, the CPU 28 is started by the DC voltage supplied from the second DC/DC converter 26. The CPU 28 issues an instruction with respect to the activation command unit 32 to generate an activation signal. The activation command unit 32 receives the instruction from the CPU 28, and based on the DC voltage supplied from the first DC/DC converter 24, initiates generation of the activation signal. Consequently, in step S5 (the fourth step), the activation command unit 32 starts supplying the activation signal to the activation processing unit 52.

In the next step S6 (the fifth step), based on the activation signal supplied from the activation command unit 32, the activation processing unit 52 switches the battery 12 from the inactive state to the active state. Consequently, the battery 12 is started.

In the next step S7, the BMU 50 executes a starting process for the battery 12 including an initialization process for the battery 12. By the execution of the starting process, it becomes possible to supply the DC electrical power from the electrical power storage unit 41 of the battery 12 to the PCU 16. Further, by the execution of the starting process, various signals or information become capable of being transmitted and received between the communication processing unit 56 and the communication IC 30.

In the next step S8, based on a control from the CPU 28, the electrical power storage unit 41 of the battery 12 supplies the DC electrical power to the electrical power conversion unit 34 via the electrical power transmission pathway 36. The electrical power conversion unit 34 converts the DC electrical power into an AC electrical power. The motor 18 is driven by the AC electrical power supplied from the electrical power conversion unit 34.

Thereafter, in the case that the user has decided to stop driving the electrical power device 10 (step S9: YES), the user takes out the battery 12 from the installation unit 14 (step S10: YES). Consequently, by the two connectors 42 and 44 being placed in the disconnected state, the supply of the DC electrical power from the electrical power storage unit 41 of the battery 12 to the PCU 16 is suspended. As a result, the electrical power device 10 switches from the started state to the unstarted state. Further, the supply of the activation signal from the activation command unit 32 to the activation processing unit 52 is suspended. As a result, the battery 12 is switched from the active state to the inactive state.

In step S11, the detection unit 46 detects that the two connectors 42 and 44 have become placed in the disconnected state. Based on the detection result of the detection unit 46, the connection/disconnection unit 20 is switched from ON to OFF.

By the connection/disconnection unit 20 being turned OFF, in the electrical power device 10, the number of the circuit elements and the wires electrically connected to the capacitor 22 is reduced. Consequently, it is possible to suppress the amount of electrical charge that is accumulated in the capacitor 22 from decreasing accompanying the elapse of time. As a result, at the next time that the electrical power device 10 is started, based on the electrical charge accumulated in the capacitor 22, the activation command unit 32 and the CPU 28 can be started, and the battery 12 can be switched from the inactive state to the active state.

In addition, in the description provided above, a description has been given concerning a case in which the connection/disconnection unit 20 is provided inside the PCU 16. In the case that the capacitor 22 is a capacitor having a comparatively large capacitance, the connection/disconnection unit 20 may be omitted. In this case, even if the electrical charge of the capacitor 22 is discharged, at the next time that the electrical power device 10 is started, an amount of electrical charge sufficient to cause the activation command unit 32 and the CPU 28 to be started can be ensured. In this case, in the flowchart of FIG. 3, as indicated by the dashed line, the processes of steps S2 and S11 are skipped.

Further, in the description provided above, a description has been given concerning a case in which the capacitor 22 (refer to FIG. 1) and the connection/disconnection unit 20 are arranged in series. The connection/disconnection unit 20 may be disposed on a discharging pathway of the electrical charge in the PCU 16. For example, the connection/disconnection unit 20 may be placed on the wiring leading from the capacitor 22 to the CPU 28. Even in this case, it is possible to suppress the amount of electrical charge that is accumulated in the capacitor 22 from decreasing.

Furthermore, in the description provided above, in the case that the battery 12 is taken out from the installation unit 14, the electrical charge accumulated in the capacitor 22 may be actively discharged. In accordance with this feature, an electrical shock to the user or the like can be prevented from occurring when the connector 42 of the installation unit 14 is exposed.

Further still, in the description provided above, a case has been described in which the electrical charge accumulated in the capacitor 22 is primarily used in order to switch the battery 12 to the active state. In the first embodiment, in addition to switching the battery 12 to the active state, the electrical charge accumulated in the capacitor 22 may be utilized for the purpose of driving the CPU 28 and the communication IC 30, or for a process of providing a display on a display unit (not shown).

Further, in the description provided above, a description has been given concerning a case in which the battery 12 is maintained in an active state until the battery 12 is pulled out from the installation unit 14. In the first embodiment, even in the case that the battery 12 is installed in the installation unit 14, the battery 12 may be switched to the inactive state. In this case, in order to suppress self-discharging of the capacitor 22, when the battery 12 is in the inactive state, it is desirable for the connection/disconnection unit 20 to be turned OFF. Moreover, in the case that the battery 12 is switched again to the active state, the connection/disconnection unit 20 may be turned ON again.

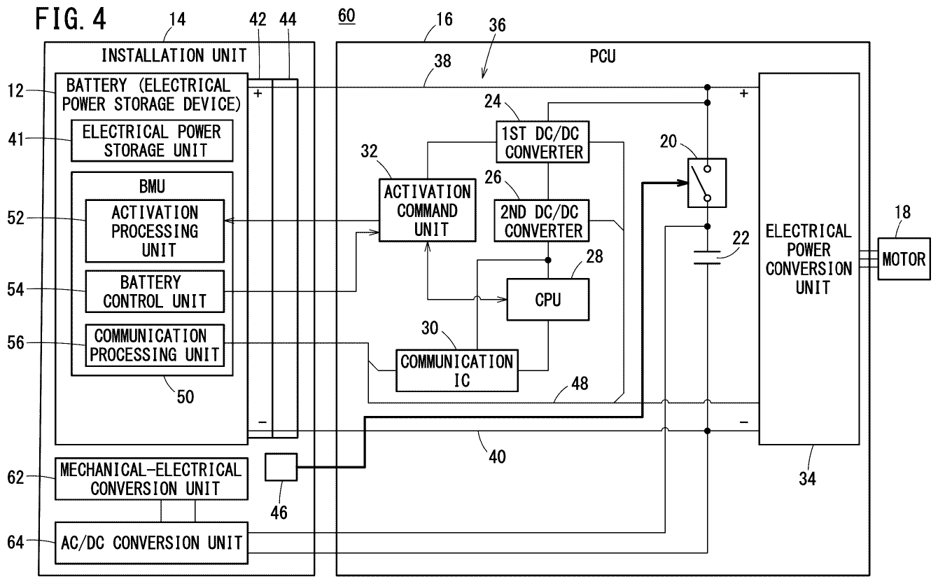

Next, with reference to FIG. 4 to FIG. 10B, a description will be given concerning an electrical power device 60 (a retention device) according to a second embodiment. In the electrical power device 60 according to the second embodiment, concerning the same constituent elements as those in the electrical power device 10 (refer to FIG. 1 to FIG. 3) according to the first embodiment, the same reference numerals will be applied thereto, and detailed description of such features will be omitted.

The electrical power device 60 according to the second embodiment differs from the electrical power device 10 according to the first embodiment, in that a configuration in order to charge (store) the electrical charge in the capacitor 22 is provided. More specifically, in the case that the capacitor 22 having a comparatively small capacitance is used, there is a possibility that, due to the discharging of the capacitor 22, an amount of charge sufficient to activate the activation command unit 32 and the CPU 28 may not be accumulated in the capacitor 22. Thus, in the electrical power device 60 according to the second embodiment, the capacitor 22 is actively charged at a time when the electrical power device 60 is in the unstarted state. For this purpose, the electrical power device 60 further includes a mechanical-electrical conversion unit 62 and an AC/DC conversion unit 64. The mechanical-electrical conversion unit 62 and the AC/DC conversion unit 64 are provided in the installation unit 14. The AC/DC conversion unit 64, for example, is a diode bridge. The AC/DC conversion unit 64 is electrically connected in parallel with the capacitor 22.

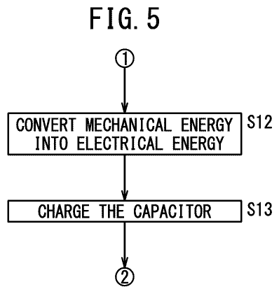

Next, with reference to the flowcharts of FIG. 3 and FIG. 5, a description will be given concerning operations of the electrical power device 60 according to the second embodiment. The operations of the second embodiment differ from the operations of the first embodiment, in that the processes of steps S12 and S13 are executed between step S1 and step S2.

In the second embodiment, when the battery 12 (refer to FIG. 4) is installed in the installation unit 14 (step S1: YES), the process proceeds to step S12 (the second step). In step S12, the mechanical-electrical conversion unit 62 converts the mechanical energy generated by movement of the battery 12 into electrical energy. Specifically, the mechanical-electrical conversion unit 62 converts the mechanical energy into an AC electrical power.

In the next step S13 (the third step), the AC/DC conversion unit 64 converts the AC electrical power supplied from the mechanical-electrical conversion unit 62 into a DC electrical power. The AC/DC conversion unit 64 charges the capacitor 22 with the converted DC electrical power. Thereafter, in the electrical power device 60, the processes of steps S2 to S11 in FIG. 3 are executed.

In this manner, according to the second embodiment, electrical charge is accumulated in the capacitor 22 prior to the connection/disconnection unit 20 (see FIG. 4) being turned ON. Consequently, even in the case that a capacitor 22 having a comparatively small capacitance is used, an amount of electrical charge sufficient to activate the activation command unit 32 and the CPU 28 can be secured.

Next, a description will be given with reference to FIG. 6A to FIG. 10B concerning specific configurations (a first exemplary embodiment to a fourth exemplary embodiment) of the electrical power device 10 according to the second embodiment. In this instance, a description will be given concerning a specific configuration of the installation unit 14 including the mechanical-electrical conversion unit 62.

Concerning the first exemplary embodiment, a description thereof will be given with reference to FIG. 6A to FIG. 6C.

According to the first exemplary embodiment, a case is illustrated in which the installation unit 14 is a slot 66. In FIG. 6A, the slot 66 is a case 68 having an opening (not shown) into and from which the battery 12 is capable of being inserted and removed. The male connector 44 is disposed at a bottom part 70 of the case 68. Further, the mechanical-electrical conversion unit 62 and a spring 72 (a pushing back member) are arranged at the bottom part 70 of the case 68 with the connector 44 sandwiched therebetween. A plate body 74 (an input unit) connected to the mechanical-electrical conversion unit 62 and the spring 72 is disposed inside the slot 66. The plate body 74 faces toward the bottom part 70 of the case 68 via the mechanical-electrical conversion unit 62 and the spring 72.

A hole 76 through which the connector 42 can be inserted is formed in the plate body 74. Each of the mechanical-electrical conversion unit 62 and the spring 72 is capable of expanding and retracting in a direction in which the battery 12 is inserted and removed (the vertical direction shown in FIG. 6A to FIG. 6C). Specifically, the mechanical-electrical conversion unit 62 is a piezoelectric element. A female connector 42 that is fitted into the connector 44 of the installation unit 14 is provided on a bottom part 78 of the battery 12 (a lower side portion of the battery 12 shown in FIG. 6A to FIG. 6C).

Next, a description will be given concerning the operations of the first exemplary embodiment.

FIG. 6A is an explanatory diagram showing a state (a second position) in which the user inserts the battery 12 into the slot 66. In this case, each of the mechanical-electrical conversion unit 62 and the spring 72 extends in the upward direction shown in FIG. 6A. More specifically, the plate body 74 receives an upwardly directed elastic force of the spring 72. Consequently, the plate body 74 is positioned so as to be spaced apart from the bottom part 70 of the case 68.

Next, when the user inserts the battery 12 into the slot 66, the bottom part 78 of the battery 12 abuts against the plate body 74. When the user pushes in the battery 12, the plate body 74 receives a downwardly directed force from the battery 12. Consequently, the plate body 74 descends toward the bottom part 70 of the case 68 in opposition to the elastic force from the spring 72. At this time, the plate body 74 descends while the battery 12 is decelerated due to the elastic force from the spring 72. Further, each of the spring 72 and the mechanical-electrical conversion unit 62 receives a downwardly directed force from the plate body 74. Consequently, as shown in FIG. 6B, each of the spring 72 and the mechanical-electrical conversion unit 62 is compressed in a downward direction. The mechanical-electrical conversion unit 62 converts the force received from the plate body 74 into an AC electrical power. When the user pushes the battery 12 further in the downward direction, the connector 44 passes through the hole 76, and is fitted with the connector 42 of the battery 12. As a result, the battery 12 is installed inside the slot 66.

In the case that the user takes out the battery 12 from the slot 66, the user pulls the battery 12 in the upward direction. In accordance therewith, the two connectors 42 and 44 are released from the fitted state. Next, when the user further pulls the battery 12 in the upward direction, the plate body 74 is released from the state of being pressed by the battery 12. As a result, as shown in FIG. 6C, each of the mechanical-electrical conversion unit 62 and the spring 72 extends in the upward direction. At this time, the mechanical-electrical conversion unit 62 converts the force that acts to extend the mechanical-electrical conversion unit 62 in the upward direction into the AC electrical power.

Accordingly, in the first embodiment, when the user inserts the battery 12 into the slot 66, and when the user takes out the battery 12 from the slot 66, the mechanical-electrical conversion unit 62 generates electrical power. Consequently, the electrical charge is capable of suitably charging the capacitor 22.

Further, prior to the two connectors 42 and 44 being fitted together, the bottom part 78 of the battery 12 and the plate body 74 abut against each other. More specifically, prior to the two connectors 42 and 44 coming into contact with each other, the bottom part 78 of the battery 12 and the plate body 74 are abut against each other. Consequently, it is possible to avoid a situation in which the connector 44 is damaged by an impact from the battery 12.

Moreover, according to the first exemplary embodiment, the plate body 74 may be the bottom part of the slot 66. In this situation, the case 68 becomes a case in which the slot 66 is accommodated. Accordingly, the slot 66 is capable of moving in the direction in which the battery 12 is inserted and removed.

Further, according to the first embodiment, the spring 72 may be replaced by a pressure accumulating damper, or alternatively, by a rack and pinion. Even in this case, the aforementioned operation of expanding and retracting can be realized.

Furthermore, according to the first embodiment, only the spring 72 may be capable of expanding and contracting in the vertical direction. In this case, a dynamo, a solenoid, or the like can be used as the mechanical-electrical conversion unit 62.

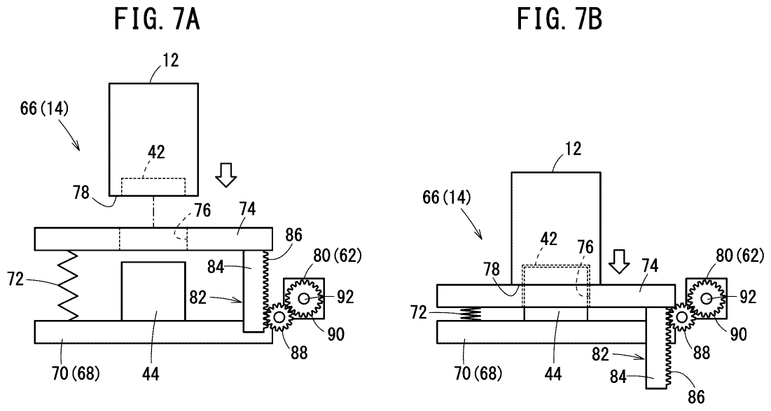

Concerning the second exemplary embodiment, a description thereof will be given with reference to FIG. 7A and FIG. 7B.

According to the second exemplary embodiment, the mechanical-electrical conversion unit 62 is a rotating electric machine 80 (a conversion unit). Further, according to the second exemplary embodiment, a mechanical conversion unit 82 is disposed between the plate body 74 and the rotating electric machine 80. The mechanical conversion unit 82 further includes a columnar body 84, a rack 86, a first pinion 88 (a motive power transmission unit), and a second pinion 90 (a motive power transmission unit).

The columnar body 84 is a columnar-shaped member that is attached to the bottom surface of the plate body 74. On the bottom surface of the plate body 74, the columnar body 84 is attached at a location opposite to the spring 72 with the connector 44 being sandwiched therebetween. The columnar body 84 extends downward from the bottom surface of the plate body 74. Moreover, it should be noted that the columnar body 84 is attached to the bottom surface of the plate body 74, in a manner so as not to collide with the bottom part 70 of the case 68 when the plate body 74 is moved up and down.

The rack 86 is formed in the vertical direction on the side wall of the columnar body 84. The first pinion 88 is a gear that enmeshes with the rack 86. The second pinion 90 is a gear with a larger diameter than the first pinion 88. The second pinion 90 enmeshes with the first pinion 88. The second pinion 90 is connected to a rotating shaft member 92 of the rotating electric machine 80.

Next, a description will be given concerning the operations of the second exemplary embodiment.

As shown in FIG. 7A, when the user inserts the battery 12 into the slot 66, the plate body 74 receives an upwardly directed elastic force of the spring 72, and is positioned (in the second position) away from the bottom part 70 of the case 68. In accordance with this feature, the columnar body 84 attached to the plate body 74 also moves upwardly. The first pinion 88 enmeshes with a lower side portion of the rack 86.

In this instance, when the user inserts the battery 12 into the slot 66, the bottom part 78 of the battery 12 abuts against the plate body 74. When the user further pushes in the battery 12, the plate body 74 descends toward the bottom part 70 of the case 68 in opposition to the elastic force from the spring 72. The plate body 74 descends while the battery 12 is decelerated due to the elastic force from the spring 72. At this time, the columnar body 84 descends in an integral manner together with the plate body 74. Since the first pinion 88 is enmeshed with the rack 86, it acts to convert a force (a kinetic energy) that causes the columnar body 84 to move downward into a rotational force (a rotational energy). The rotational force converted by the first pinion 88 causes the rotating shaft member 92 to be rotated via the second pinion 90. The rotating electric machine 80 generates electrical power due to the rotation of the rotating shaft member 92. More specifically, the rotating electric machine 80 converts the kinetic energy when the plate body 74 descends into electrical energy (AC electrical power). When the user pushes the battery 12 further in the downward direction, as shown in FIG. 7B, the connector 44 passes through the hole 76, and is fitted with the connector 42 of the battery 12. As a result, the battery 12 is installed in the slot 66 (in a first position).

In the case that the user takes out the battery 12 from the slot 66, the user pulls the battery 12 in the upward direction. In accordance therewith, the two connectors 42 and 44 are released from the fitted state. Next, when the user further pulls the battery 12 in the upward direction, the plate body 74 is released from the state of being pressed by the battery 12. As a result, the spring 72 extends in the upward direction, and the plate body 74 and the columnar body 84 move upwardly together in an integral manner. The first pinion 88 converts the force that moves the columnar body 84 in the upward direction into a rotational force. The rotational force converted by the first pinion 88 causes the rotating shaft member 92 to be rotated via the second pinion 90. The rotating electric machine 80 generates electrical power due to the rotation of the rotating shaft member 92. More specifically, the rotating electric machine 80 converts the kinetic energy when the plate body 74 rises into electrical energy.

Accordingly, in the second embodiment as well, when the user inserts the battery 12 into the slot 66, and when the user takes out the battery 12 from the slot 66, the rotating electric machine 80 generates electrical power. Consequently, the electrical charge is capable of suitably charging the capacitor 22. Further, in the second embodiment as well, prior to the two connectors 42 and 44 being fitted together, the bottom part 78 of the battery 12 and the plate body 74 abut against each other. Consequently, it is possible to avoid a situation in which the connector 44 is damaged by an impact from the battery 12.

Moreover, according to the second exemplary embodiment as well, the plate body 74 may be the bottom part of the slot 66. Further, according to the second exemplary embodiment as well, the spring 72 may be replaced by a pressure accumulating damper, or alternatively, by a rack and pinion.

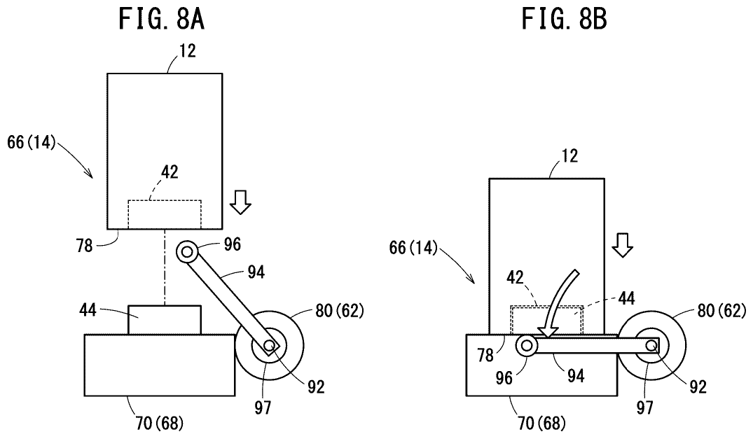

Concerning the third exemplary embodiment, a description thereof will be given with reference to FIG. 8A and FIG. 8B.

According to the third exemplary embodiment as well, the mechanical-electrical conversion unit 62 is the rotating electric machine 80. Further, according to the third exemplary embodiment, an arm 94 (an input unit, a mechanical-electrical conversion unit) is connected to the rotating shaft member 92 of the rotating electric machine 80. A proximal end part of the arm 94 is connected to the rotating shaft member 92. The arm 94 extends in a direction (a diametrical direction of the rotating shaft member 92) perpendicular to the rotating shaft member 92. A distal end of the arm 94 is positioned downwardly of the bottom part 78 of the battery 12. A roller 96 is attached to the distal end of the arm 94. Moreover, it should be noted that the roller 96 can be omitted. Further, a torsion spring 97 (a pushing back member) may be provided at the proximal end portion of the arm 94 or on the rotating shaft member 92. The torsion spring 97 applies a spring force to the arm 94 and the rotating shaft member 92 so as to undergo rotational movement about the rotating shaft member 92 in a clockwise direction in FIG. 8A and FIG. 8B.

Next, a description will be given concerning the operations of the third exemplary embodiment.

As shown in FIG. 8A, when the user inserts the battery 12 into the slot 66, the distal end of the arm 94 is positioned in a space downwardly of the bottom part 78 of the battery 12, and further, upwardly of the connector 44.

In this instance, when the user inserts the battery 12 into the slot 66, the bottom part 78 of the battery 12 abuts against the roller 96. In this case, the roller 96 and the arm 94 receive a downwardly directed force from the battery 12. When the user further pushes in the battery 12, the arm 94 and the rotating shaft member 92 rotate (undergo rotational movement) in a counterclockwise direction about the rotating shaft member 92, due to the force from the battery 12, and in opposition to the spring force from the torsion spring 97. More specifically, the arm 94 converts the force (the kinetic energy) that moves the battery 12 in the downward direction into a rotational force (a rotational energy). In this case, the arm 94, by abutting against the bottom part 78 of the battery 12, undergoes rotational movement while causing the battery 12 to decelerate. Further, the rotating electric machine 80 generates electrical power due to the rotation of the rotating shaft member 92. More specifically, the rotating electric machine 80 converts the kinetic energy when the battery 12 descends into electrical energy (AC electrical power). When the user pushes the battery 12 further in the downward direction, as shown in FIG. 8B, the connector 44 is fitted with the connector 42 of the battery 12. As a result, the battery 12 is installed inside the slot 66.

In the case that the user takes out the battery 12 from the slot 66, the user pulls the battery 12 in the upward direction. In accordance therewith, the two connectors 42 and 44 are released from the fitted state. Next, when the user further pulls the battery 12 in the upward direction, the arm 94 is released from the state of being pressed by the battery 12. In this case, due to the spring force of the torsion spring 97, the arm 94 and the rotating shaft member 92 rotate in a clockwise direction about the rotating shaft member 92. As a result, the distal end of the arm 94 returns to the position shown in FIG. 8A. At this time, the rotating electric machine 80 generates electrical power due to the rotation of the rotating shaft member 92. More specifically, the rotating electric machine 80 converts the kinetic energy when the battery 12 rises into electrical energy.

Accordingly, in the third embodiment as well, when the user inserts the battery 12 into the slot 66, and when the user takes out the battery 12 from the slot 66, the rotating electric machine 80 generates electrical power. Consequently, the electrical charge is capable of suitably charging the capacitor 22.

Further, prior to the two connectors 42 and 44 being fitted together, the bottom part 78 of the battery 12 and the distal end part (the roller 96) of the arm 94 abut against each other. Consequently, it is possible to avoid a situation in which the connector 44 is damaged by an impact from the battery 12.

Moreover, according to the third exemplary embodiment, the bottom part 70 may be the bottom part of the slot 66.

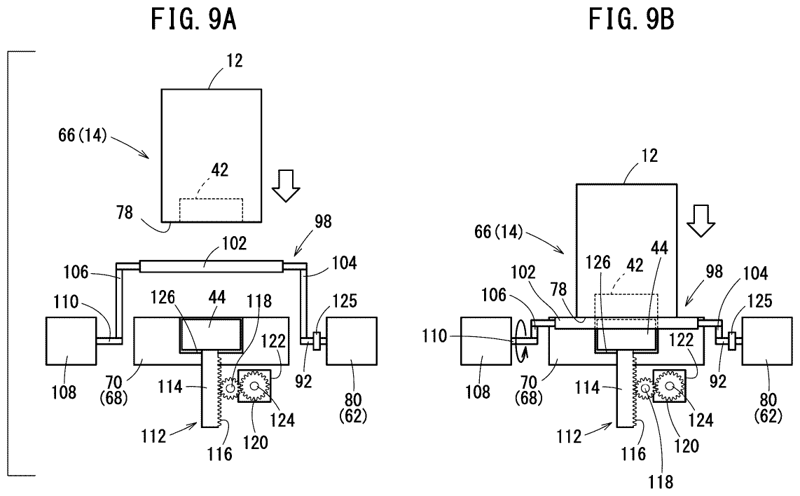

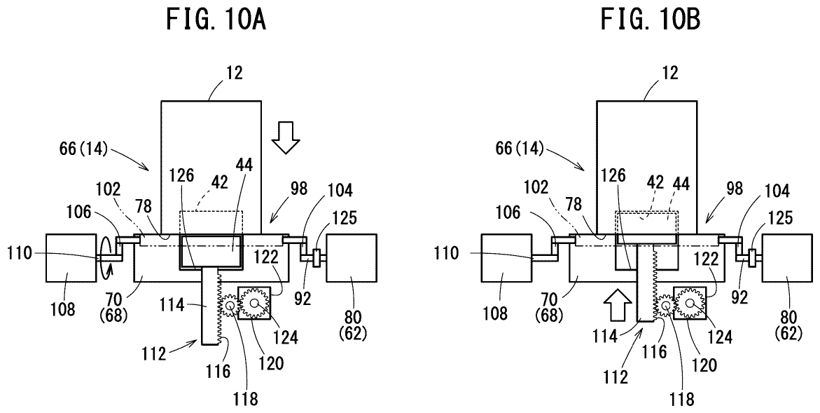

Concerning the fourth exemplary embodiment, a description thereof will be given with reference to FIG. 9A to FIG. 10B.

According to the fourth exemplary embodiment as well, the mechanical-electrical conversion unit 62 is the rotating electric machine 80. Further, according to the fourth exemplary embodiment, a mechanical conversion unit 98 is disposed between the rotating electric machine 80 and the battery 12. The mechanical conversion unit 98 includes a push-down bar 102 (an input unit), arms 104 and 106, and a rotational mechanism unit 108. The push-down bar 102 extends in a horizontal direction between the bottom part 78 of the battery 12 and the bottom part 70 of the case 68. One end part of the arm 104 (a motive power transmission unit) is connected to a right end part of the push-down bar 102. Another end part of the arm 104 is connected to the rotating shaft member 92 of the rotating electric machine 80. One end part of the arm 106 is connected to a left end part of the push-down bar 102. Another end part of the arm 106 is connected to a rotating shaft member 110 of the rotational mechanism unit 108. The rotational mechanism unit 108 is a bearing or a rotating electric machine. In the case that the rotational mechanism unit 108 is a bearing, the rotating shaft member 110 is supported by the bearing. In the case that the rotational mechanism unit 108 is a rotating electric machine, the rotating shaft member 110 is rotated by driving of the rotating electric machine.

According to the fourth exemplary embodiment, an advancing/retracting mechanism 112 is provided in the slot 66. The advancing/retracting mechanism 112 advances and retracts the connector 44 with respect to the connector 42 of the battery 12. Specifically, the advancing/retracting mechanism 112, similar to the mechanical conversion unit 82 (refer to FIGS. 7A and 7B) includes a columnar body 114, a rack 116, a third pinion 118, a fourth pinion 120, and a rotating electric machine 122.

The columnar body 114 is a columnar-shaped member that is attached to the bottom surface of the connector 44. The columnar body 114 extends in a downward direction from the bottom surface of the connector 44. Moreover, it should be noted that the columnar body 114 is attached to the bottom surface of the connector 44, in a manner so as not to collide with the bottom part 70 of the case 68 when the connector 44 is advanced and retracted with respect to the connector 42.

The rack 116 is formed in the vertical direction on the side wall of the columnar body 114. The third pinion 118 is a gear that enmeshes with the rack 116. The fourth pinion 120 is a gear with a larger diameter than the third pinion 118. The fourth pinion 120 enmeshes with the third pinion 118. The fourth pinion 120 is connected to a rotating shaft member 124 of the rotating electric machine 122.

Moreover, a torsion spring 125 (a push-back member) may be provided on another end part of at least one from among the two arms 104 and 106, or on at least one from among the two rotating shaft members 92 and 110. The torsion spring 125 applies a spring force to the arms 104 and 106 and the rotating shaft members 92 and 110, so that the push-down bar 102 is placed in the position shown in FIG. 9A, and thereby causes the arms 104 and 106 to undergo rotational movement about the rotating shaft members 92 and 110. A case is illustrated in FIG. 9A to FIG. 10B in which the torsion spring 125 is provided on the rotating shaft member 92.

Next, a description will be given concerning the operations of the fourth exemplary embodiment.

As shown in FIG. 9A, when the user inserts the battery 12 into the slot 66, the push-down bar 102 is positioned in a space downwardly of the bottom part 78 of the battery 12, and further, upwardly of the connector 44. Further, the connector 44 is accommodated in a concave portion 126 that is formed in the bottom part 70 of the case 68.

In this instance, when the user inserts the battery 12 into the slot 66, the bottom part 78 of the battery 12 abuts against the push-down bar 102. In this case, the push-down bar 102 receives a downwardly directed force from the battery 12. When the user further pushes in the battery 12, the push-down bar 102, the two arms 104 and 106, and the two rotating shaft members 92 and 110 undergo rotational movement about the rotating shaft members 92 and 110, due to the force from the battery 12, and in opposition to the spring force from the torsion spring 125. More specifically, the mechanical conversion unit 98 converts the force (the kinetic energy) that moves the battery 12 in the downward direction into a rotational force (a rotational energy). In this case, the push-down bar 102, by abutting against the bottom part 78 of the battery 12, is displaced while causing the battery 12 to decelerate. Further, the rotating electric machine 80 generates electrical power due to the rotation of the rotating shaft member 92. More specifically, the rotating electric machine 80 converts the kinetic energy when the battery 12 descends into electrical energy (AC electrical power).

When the user pushes the battery 12 further in the downward direction, as shown in FIG. 9B, the bottom part 78 of the battery 12 abuts against the bottom part 70 of the case 68. In this case, the connector 44 is accommodated in the concave portion 126, and does not project out from the bottom part 70 of the case 68. Consequently, it is possible to avoid a situation in which the connector 44 is damaged by an impact from the battery 12.

Next, as shown in FIG. 10A, the rotating electric machine 122 of the advancing/retracting mechanism 112 is driven, and thereby causes the rotating shaft member 124 to rotate.

Consequently, the rotational force of the rotating shaft member 124 is transmitted to the rack 116 via the fourth pinion 120 and the third pinion 118. The rack 116 converts the rotational force from the third pinion 118 into an upwardly directed translational motion. In accordance with this feature, as shown in FIG. 10B, the connector 44 and the columnar body 114 rise upwardly toward the battery 12. As a result, the connector 44 and the connector 42 of the battery 12 are fitted together, and the battery 12 is installed inside the slot 66. It should be noted that, in FIG. 10A and FIG. 10B, the push-down bar 102 is illustrated with a two-dot dashed line.

In the case that the user takes out the battery 12 from the slot 66, the rotating electric machine 122 is driven, and the rotating shaft member 124 is made to rotate, in a manner so that the connector 44 and the columnar body 114 descend. Consequently, the rotational force of the rotating shaft member 124 is transmitted to the rack 116 via the fourth pinion 120 and the third pinion 118. The rack 116 converts the rotational force from the third pinion 118 into a downwardly directed translational motion. In accordance with this feature, the connector 44 and the columnar body 114 descend in a manner so as to separate away from the battery 12. As a result, the connectors 42 and 44 are released from the fitted state. Further, the connector 44 returns to the position shown in FIG. 9B and FIG. 10A, and is accommodated in the concave portion 126.

Next, when the user pulls the battery 12 in the upward direction, the push-down bar 102 is released from the state of being pressed by the battery 12. Consequently, due to the spring force from the torsion spring 125, the push-down bar 102, the two arms 104 and 106, and the two rotating shaft members 92 and 110 undergo rotational movement about the rotating shaft members 92 and 110. As a result, the push-down bar 102 returns to the position shown in FIG. 9A. At this time, the rotating electric machine 80 generates electrical power due to the rotation of the rotating shaft member 92. More specifically, the rotating electric machine 80 converts the kinetic energy when the battery 12 rises into electrical energy.

Accordingly, in the fourth embodiment as well, when the user inserts the battery 12 into the slot 66, and when the user takes out the battery 12 from the slot 66, the rotating electric machine 80 generates electrical power. Consequently, the electrical charge is capable of suitably charging the capacitor 22.

Moreover, according to the fourth exemplary embodiment, in the case that the rotational mechanism unit 108 is a rotating electric machine, when the rotating shaft member 110 is rotated accompanying the rotational movement of the arm 106, the rotating electric machine may generate electrical power. In accordance with this feature, the capacitor 22 can be charged with more electrical charge.

Further, as in the first exemplary embodiment to the third exemplary embodiment, in the fourth exemplary embodiment as well, the bottom part 70 may be the bottom part of the slot 66.

Further, in the fourth exemplary embodiment, accompanying the driving of the rotating electric machine 122, the connector 44 is advanced and retracted with respect to the connector 42. In the fourth exemplary embodiment, a handle (not shown) that can be operated by the user, and the connector 44 may be mechanically connected. By an operating force of the user being transmitted from the handle to the connector 44, the connector 44 advances and retracts with respect to the connector 42.

Furthermore, a rotating electric machine (not shown) may be mechanically connected to a motive power transmission pathway between the handle and the connector 44. Such a rotating electric machine may be a device equivalent to the rotating electric machine 80. In the case that the user operates the handle, a kinetic energy when the connector 44 advances and retracts with respect to the connector 42 is converted into electrical energy by the rotating electric machine.

Moreover, in the description provided above, the rotating electric machine converts the kinetic energy, which is generated when the user operates the handle and causes the connector 44 to move, into electrical energy. From the standpoint of converting the kinetic energy into electrical energy, the handle need not necessarily be a handle for the purpose of driving the connector 44. The handle may be used only in order to cause the rotating electric machine to be operated.

Moreover, in the first embodiment and the second embodiment, the electrical power devices 10 and 60 can be used as an electrical power source for various types of vehicles, such as a one-wheeled vehicle, a two-wheeled vehicle, a three-wheeled vehicle, a four-wheeled vehicle, or the like. However, the first embodiment and the second embodiment are not limited to being electrical power source devices for a vehicle. The electrical power devices 10 and 60 may be various types of electrical power source devices, such as various chargers, electrical power supplying devices, exchangers, and the like.

Furthermore, in the description provided above, a description has been given concerning a case in which each of the electrical power devices 10 and 60 includes one battery 12. In the first embodiment and the second embodiment, each of the electrical power devices 10 and 60 may include two or more of the batteries 12. In this case, the above-described processes can be easily applied also in relation to the activation process of the second and subsequent batteries 12.

The electrical power devices 10 and 60 are capable of being applied to various types of electrical power source systems that supply electrical power to a load or the like from the plurality of batteries 12, or alternatively, that serve to charge the plurality of batteries 12. The electrical power devices 10 and 60 are capable of being installed in a residence, a business office, or alternatively, a public facility or the like.

The electrical power devices 10 and 60 are also capable of being applied to electrical power source systems of various types of mobile bodies. Mobile bodies on which people are capable of riding, or alternatively, mobile bodies on which people are incapable of riding are included in the various types of mobile bodies. As the mobile bodies of such a type, there may be cited vehicles, aircraft, flying objects, ships, and the like. Further, as the electrical power supply systems of the vehicles, there may be cited an electrical power source system of an electric vehicle, and an electrical power source system of a vehicle in which a drive motor is mounted such as a hybrid vehicle. More specifically, the electrical power devices 10 and 60 are capable of being applied to electrical power supply systems of various types of vehicles such as a one-wheeled vehicle, a two-wheel vehicle, or alternatively, a four-wheel vehicle or the like.

The electrical power devices 10 and 60 can also be applied to electrical power supply systems for various general-purpose devices. Specifically, as the various general-purpose devices, there may be cited (1) various charging devices, (2) various discharging devices, and (3) various working machines such as general-purpose working machines, lawn mowers, tillers, and blowers or the like. Further, as the various general-purpose devices, there may be cited (4) electrical devices in which electric motors are not included, such as floodlights and lighting devices or the like, and (5) various devices installed in residential dwellings, buildings, or the like.

Concerning items (1) through (5), such devices may be general-purpose devices that do not have a person riding thereon. Further, concerning item (3), the working machine may be a working machine that does not have a person riding thereon. Alternatively, concerning item (3), the working machine may be a working machine that has a person riding thereon. Furthermore, as examples of the aforementioned item (5), there may be cited (A) equipment that operates on the basis of DC electrical power, as in audio equipment such as clocks and radio cassette recorders and the like, and (B) equipment that operates on the basis of AC electrical power such as electric fans, juicers, mixers, or alternatively, incandescent electric lamps or the like. Further, as other examples of the aforementioned item (5), there may be cited (C) equipment that operates on the basis of DC electrical power that is converted from AC electrical power, such as televisions, radios, stereos, or alternatively, personal computers or the like. Furthermore, as other examples of the aforementioned item (5), there may be cited (D) inverter type equipment including washing machines, refrigerators, air conditioners, microwave ovens, and fluorescent lamps. The equipment of the aforementioned item (D) is equipment that operates on the basis of the AC electrical power, which after having been temporarily converted from the AC electrical power to the DC electrical power, is then further converted from the DC electrical power.

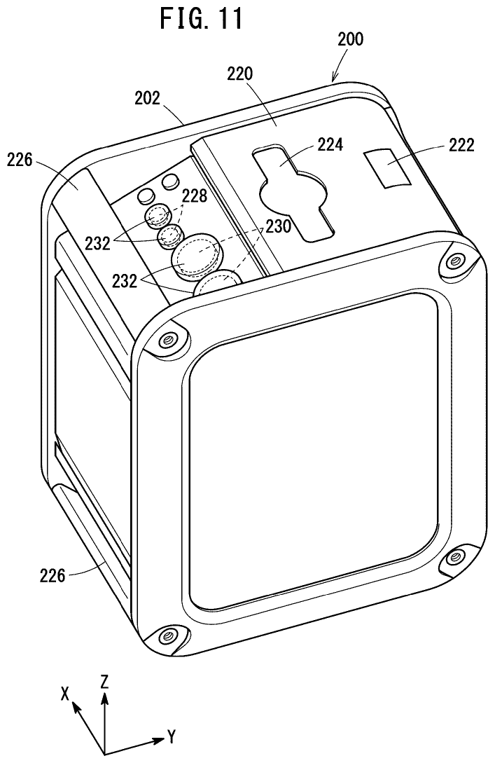

FIG. 11 is a perspective view of an electrical power device 200 (a retention device) according to the third embodiment. In the description that follows, a widthwise direction of the electrical power device 200 will be referred to as an X-direction or the left-right direction. A depth direction of the electrical power device 200 is referred to as a Y-direction or a front-back direction. The height direction of the electrical power device 200 is referred to as a Z-direction or an upper-lower direction.

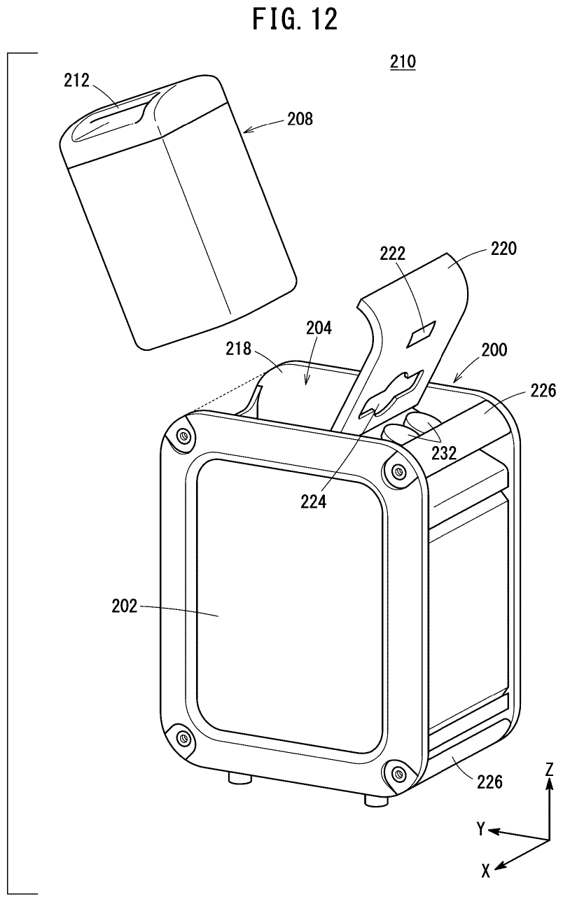

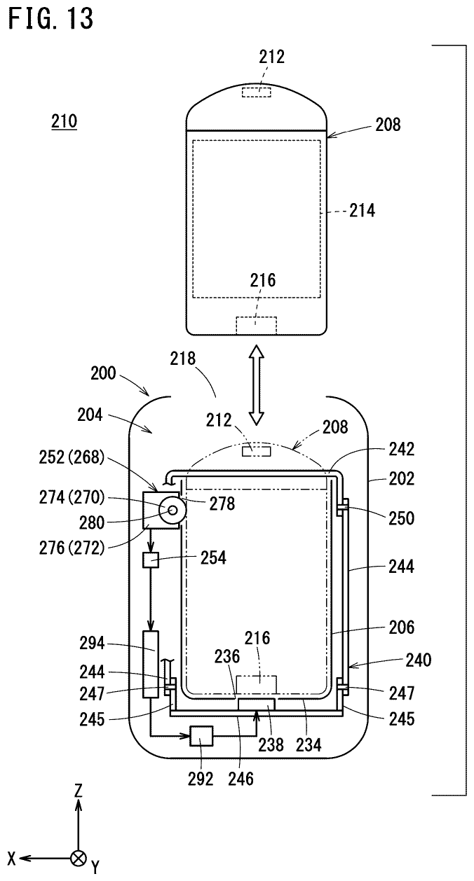

The electrical power device 200, for example, has approximately the same external shape as the electrical power device disclosed in WO 2020/235618 A1. More specifically, the electrical power device 200 is equipped with a casing 202. The shape of the casing 202 is approximately in the shape of a rectangular parallelepiped. As shown in FIG. 12 and FIG. 13, the casing 202 includes an interior space 204 therein. A retaining unit 206 is provided in the interior space 204 of the casing 202. The retaining unit 206 is a slot in order to accommodate (retain) an electrical power storage device 208 (a component). The electrical power storage device 208 is attachable and detachable with respect to the retaining unit 206. An electrical power system 210 is configured to include the electrical power device 200 and the electrical power storage device 208. Moreover, it should be noted that, in FIG. 13, the interior of the casing 202 is schematically illustrated.

At least one electrical power storage device 208 may be installed in the electrical power device 200. In the case that the electrical power device 200 is equipped with a plurality of the electrical power storage devices 208, it is sufficient that at least one of the electrical power storage devices 208 from among the plurality of the electrical power storage devices 208 is attachable and detachable with respect to the electrical power device 200. In this case, it is more preferable for the electrical power storage device 208 to be attachable and detachable with respect to the electrical power device 200 without using a separate working tool or the like. Stated otherwise, the electrical power storage device 208 is configured in a manner so as to be attachable and detachable with respect to the electrical power device 200 without using a working tool or the like. Further, the term “attached and detached with respect to the electrical power device 200” includes a case in which the electrical power storage device 208 is attached to the electrical power device 200, and a case in which the electrical power storage device 208 is detached from the electrical power device 200. In the following description, a description will be given concerning a case in which one electrical power storage device 208 is attachable and detachable with respect to the electrical power device 200.

The electrical power storage device 208 is a mobile battery that is attachable and detachable with respect to the electrical power device 200. The shape of the electrical power storage device 208 is substantially in the shape of a rectangular parallelepiped. The electrical power storage device 208 is a mobile battery that is capable of being charged and discharged. The electrical power storage device 208, for example, is preferably a removable lithium ion battery pack. A handle member 212 is provided on a top part of the electrical power storage device 208. By gripping the handle member 212, the user can carry the electrical power storage device 208. An electrical power storage unit 214 is accommodated in the interior of the electrical power storage device 208. A female connector 216 (another connection unit) is provided on a bottom part of the electrical power storage device 208. The connector 216 is also referred to as a receptacle.

An opening 218 communicating with the interior space 204 is formed in an upper part of the casing 202. A cover 220 that covers the opening 218 is provided in the upper part of the casing 202. An opening button 222 is provided on the cover 220. When the user presses the opening button 222, the cover 220 opens, and the exterior of the casing 202 and the interior space 204 communicate with each other (refer to FIG. 12 and FIG. 13). In a state with the cover 220 being open, the user is capable of attaching and detaching the electrical power storage device 208 with respect to the retaining unit 206. Moreover, in FIG. 11, a state is shown in which the cover 220 is closed. In FIG. 12 and FIG. 13, a state is shown in which the cover 220 is open.

As shown in FIG. 11, an indicator 224 for the purpose of indicating the residual capacity of the electrical power storage device 208 is provided on the cover 220. The indicator 224 may include the function of a switch that can be operated by the user. As shown in FIG. 11 and FIG. 12, from among the four corners of the casing 202, recessed spaces that are recessed toward the inner side of the casing 202 are formed at three corners other than the corner where the cover 220 is provided. Handle members 226 are provided at the three corners. The three handle members 226 extend in the X-direction.

A plurality of DC output terminals 228 and a plurality of AC output terminals 230 are provided on the upper part of the casing 202 between the cover 220 and one of the handle members 226. The plurality of DC output terminals 228 are terminals for the purpose of outputting DC electrical power from the electrical power device 200 to the exterior of the electrical power device 200. The plurality of DC output terminals 228, for example, are USB terminals. USB cables can be connected to the USB terminals. The plurality of AC output terminals 230 are terminals for the purpose of outputting AC electrical power from the electrical power device 200 to the exterior of the electrical power device 200. The plurality of AC output terminals 230, for example, are insertion ports for commercial electrical power source plugs. Each of the plurality of DC output terminals 228 and each of the plurality of AC output terminals 230 are covered respectively by caps 232. The plurality of caps 232 protect the plurality of DC output terminals 228 and the plurality of AC output terminals 230.

FIG. 13 is a diagram illustrating the attachment and detachment of the electrical power storage device 208 with respect to the retaining unit 206. Moreover, it should be noted that, in FIG. 13, the interior of the casing 202 is schematically illustrated. The shape of the retaining unit 206 is approximately in the form of a rectangular parallelepiped that matches the shape of the electrical power storage device 208. The shape of the retaining unit 206 is a bottomed tubular shape. The retaining unit 206 is disposed in the Z-direction in the interior space 204 of the casing 202. An opening on the upper end of the retaining unit 206 faces toward the opening 218 of the casing 202. When the cover 220 is opened (refer to FIG. 12), and the user inserts the electrical power storage device 208 into the retaining unit 206 in a state with the bottom part of the electrical power storage device 208 facing toward the retaining unit 206, the electrical power storage device 208 is moved downwardly inside the retaining unit 206. By the bottom part of the electrical power storage device 208 coming into contact with a bottom plate 234, which is the lower end of the retaining unit 206, the electrical power storage device 208 is accommodated in the retaining unit 206.

An insertion hole 236 is formed in the bottom plate 234 of the retaining unit 206. When the electrical power storage device 208 is accommodated in the retaining unit 206, the connector 216 of the electrical power storage device 208 and the insertion hole 236 face toward each other.

In the interior space 204 of the casing 202, a connector 238 (connection unit) is provided below the retaining unit 206. The connector 238 is a male connector. The connector 238 is also referred to as a plug. The connector 238 is positioned downwardly of the retaining unit 206, so as to be capable of being inserted through the insertion hole 236 of the retaining unit 206. The connector 238 can be fitted (connected) to the connector 216 of the electrical power storage device 208.

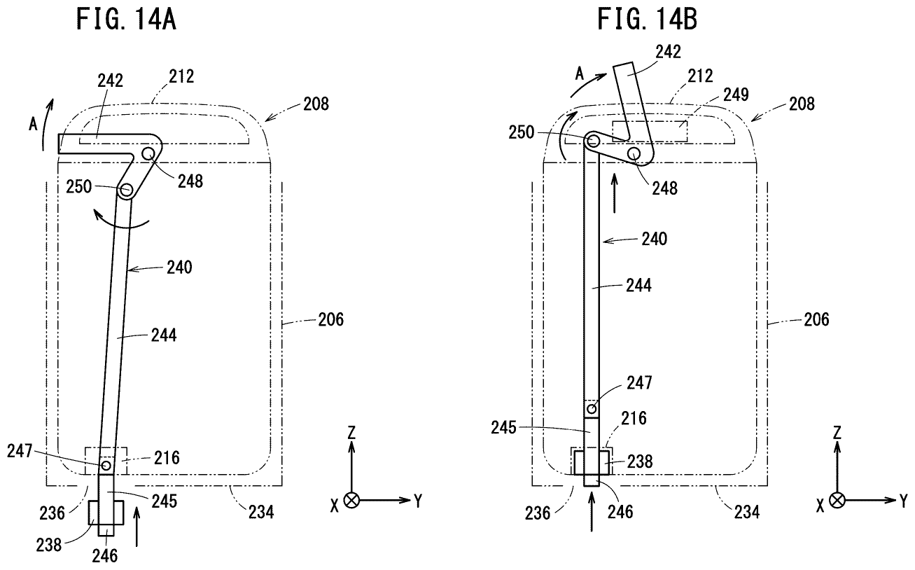

As shown in FIG. 13 to FIG. 14B, a connector displacement mechanism 240 (motive power transmission mechanism) is provided in the interior space 204 of the casing 202. When the electrical power storage device 208 is accommodated in the retaining unit 206, the connector displacement mechanism 240, by causing the connector 238 to be displaced with respect to the connector 216 of the electrical power storage device 208, causes the connector 238 and the connector 216 to be connected. The connector displacement mechanism 240, for example, is a mechanism in which the terminal displacement mechanism disclosed in WO 2019/064556 A1 is used. The connector displacement mechanism 240 includes an operating lever 242, two link plates 244, two connecting walls 245, and a connector retaining member 246.

The operating lever 242 extends in the X-direction upwardly of the retaining unit 206. Both end parts of the operating lever 242 are bent and extend in the Z-direction and the Y-direction. Accordingly, the operating lever 242 is a U-shaped lever. Moreover, it should be noted that, in FIG. 13, illustration of one end of the operating lever 242 is omitted.

Each of the bent portions on both sides of the operating lever 242 is pivotally supported by each of rotating shaft members 248 that extend in the X-direction. Each of the two rotating shaft members 248 is connected to each of support stays (not shown) that are fixed to the retaining unit 206. Both end parts of the operating lever 242 are connected to end parts of the two link plates 244 via connecting pins 250 that extend in the X-direction. The two link plates 244 extend in the Z-direction. Other end parts of the two link plates 244 are connected to ends of the connecting walls 245 via connecting pins 247 that extend in the X-direction. Other end parts of the two connecting walls 245 are connected to both ends of the connector retaining member 246 that extend in the X-direction. The connector retaining member 246 is a plate-shaped member that extends in the X-direction downwardly of the retaining unit 206. The connector 238 is attached to a central portion on the upper surface of the connector retaining member 246.

In the case that the cover 220 is opened, and further, the operating lever 242 is positioned in the angular position shown in FIG. 14A, the user can insert the electrical power storage device 208 into the retaining unit 206. After the electrical power storage device 208 has been inserted into the retaining unit 206, and the electrical power storage device 208 has been accommodated in the retaining unit 206, the user operates the operation lever 242 in the direction of the arrow A shown in FIG. 14A. Consequently, the operating lever 242 rotates in the direction of the arrow A about the rotating shaft members 248. The two link plates 244, the two connecting pins 247, and the two connecting walls 245 convert the rotational force of the operating lever 242, which is transmitted via the connecting pins 250, into a force along the Z-direction. Consequently, the two link plates 244, the two connecting pins 247, and the two connecting walls 245 are pulled upwardly. Accompanying the movement of the two connecting walls 245, the connector retaining member 246 rises. The connector 238 that is attached to the connector retaining member 246 passes through the insertion hole 236 and rises.

When the user causes the operating lever 242 to be rotated to the angular position shown in FIG. 14B, the two link plates 244, the two connecting pins 247, and the two connecting walls 245 rise further. In accordance with this feature, the connector 238 rises and is fitted (connected) into the connector 216. Accordingly, prior to the connector 216 and the connector 238 being fitted together, the bottom part of the electrical power storage device 208 abuts against the bottom plate 234 of the retaining unit 206. More specifically, prior to the two connectors 216 and 238 coming into contact with each other, the bottom part of the electrical power storage device 208 and the bottom plate 234 abut against each other. Stated otherwise, prior to the connector 216 and the connector 238 being placed in contact, the bottom part of the electrical power storage device 208 is retained by the retaining unit 206. Consequently, it is possible to avoid a situation in which the connector 238 is damaged by an impact from the electrical power storage device 208.

Moreover, a restricting member 249 (a pressing member) may be operated in conjunction with the rotation of the operating lever 242. The restricting member 249 is retained by the retaining unit 206. At a time when the operating lever 242 is rotated to the angular position shown in FIG. 14B, the restricting member 249 is pressed against the upper part of the electrical power storage device 208 from above. In accordance with this feature, displacement of the electrical power storage device 208 in the Z-direction is restricted.

In the case that the user pulls out the electrical power storage device 208 from the electrical power device 200, the user presses the opening button 222 and thereby opens the cover 220. The user causes the operating lever 242 to be rotated from the angular position shown in FIG. 14B to the angular position shown in FIG. 14A. When the operating lever 242 is rotated in the opposite direction to the direction of the arrow A, the two link plates 244, the two connecting pins 247, and the two connecting walls 245 descend. Consequently, the connector retaining member 246 and the connector 238 also descend. As a result, the fitted state (the connected state) between the connector 238 and the connector 216 is released. Moreover, by being separated away from the electrical power storage device 208 in conjunction with the rotation of the operating lever 242, the restricting member 249 releases the restriction on the displacement of the electrical power storage device 208 in the Z-direction. Thereafter, by grasping the handle member 212 of the electrical power storage device 208 and pulling up the electrical power storage device 208 along the Z-direction, the user pulls out the electrical power storage device 208 from the electrical power device 200.

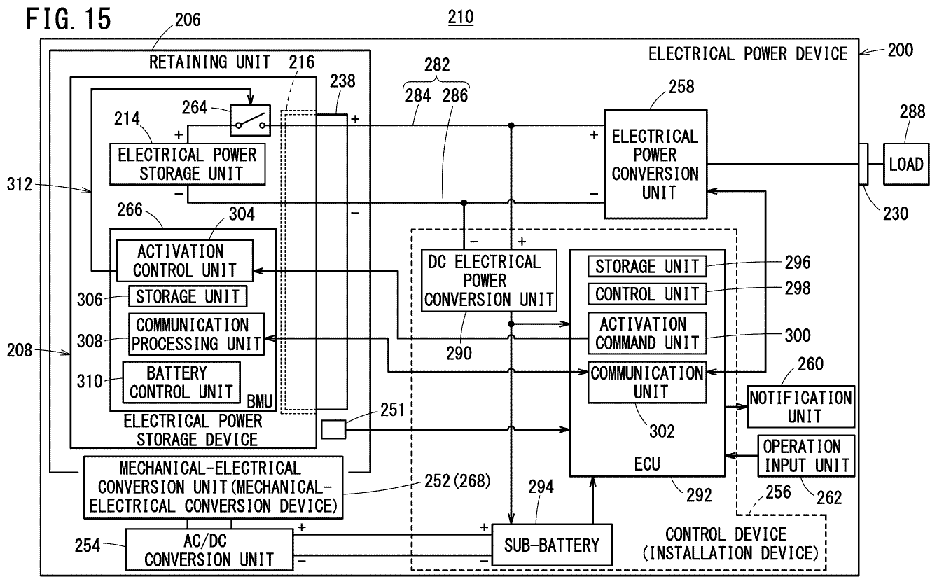

FIG. 15 is a configuration diagram of the electrical power system 210. The electrical power device 200 further comprises, in addition to the casing 202 (refer to FIG. 11), the retaining unit 206, and the connector 238, a detection unit 251, a mechanical-electrical conversion unit 252, an AC/DC conversion unit 254, a control device 256 (an installation device), an electrical power conversion unit 258 (an electrical operation unit), a notification unit 260, and an operation input unit 262. In addition to the electrical power storage unit 214 and the connector 216, the electrical power storage device 208 further includes a connection/disconnection unit 264 and a BMU (battery management unit) 266. Moreover, in FIG. 15, illustration of the DC output terminals 228 (refer to FIG. 11) is omitted.

The detection unit 251 sequentially detects the connected state between the connector 238 and the connector 216. The detection unit 251 sequentially outputs the detection result to the control device 256.

When the electrical power storage device 208 is attached and detached with respect to the retaining unit 206, the mechanical-electrical conversion unit 252 converts the kinetic energy that accompanies the movement of the electrical power storage device 208 into electrical energy (electrical power). Moreover, as will be discussed later, the mechanical-electrical conversion unit 252 also is capable of functioning as a mechanical-electrical conversion device 268 independently from the electrical power device 200 and the electrical power storage device 208. More specifically, the mechanical-electrical conversion unit 252 (the mechanical-electrical conversion device 268) may be configured to be attachable and detachable with respect to the electrical power device 200 or the electrical power storage device 208.

Specifically, as shown in FIG. 13, the mechanical-electrical conversion unit 252 includes an input unit 270 and a conversion unit 272.

When the electrical power storage device 208 is attached and detached with respect to the retaining unit 206, the input unit 270 receives the kinetic energy accompanying the movement of the electrical power storage device 208. Therefore, when the electrical power storage device 208 is attached and detached with respect to the retaining unit 206, the input unit 270 is desirably disposed at a position where it is capable of coming into contact with the electrical power storage device 208. More specifically, when the electrical power storage device 208 is attached and detached with respect to the retaining unit 206, the input unit 270 is desirably positioned on a movement trajectory of the electrical power storage device 208.

The conversion unit 272 converts the kinetic energy input to the input unit 270 into electrical energy.

In FIG. 13, as a specific example of the mechanical-electrical conversion unit 252, a case is shown in which the input unit 270 is a roller 274, and together therewith, the conversion unit 272 is a generator 276 (a rotating electric machine) connected to the roller 274. As shown in FIG. 13, a hole 278 is formed in a side wall of the retaining unit 206. A portion of the roller 274 passes through the hole 278, and enters on an inner side of the retaining unit 206. A rotating shaft member 280 of the generator 276 extends in the Y-direction. The roller 274 is coaxially connected to the rotating shaft member 280. The roller 274 is capable of rotating about the rotating shaft member 280.

When the user inserts the electrical power storage device 208 into the retaining unit 206, the roller 274 comes into contact with a side surface of the electrical power storage device 208. At a time when the electrical power storage device 208 is moving toward the bottom plate 234 of the retaining unit 206, the roller 274 comes into contact with the side surface of the electrical power storage device 208 and rotates. The generator 276 generates electrical power based on the rotation of the roller 274 and the rotating shaft member 280, and outputs an AC electrical power (electrical energy). When the bottom part of the electrical power storage device 208 comes into contact with the bottom plate 234 of the retaining unit 206, the movement of the electrical power storage device 208 stops. Consequently, the roller 274 and the rotating shaft member 280 stop rotating. As a result, the generator 276 stops generating electrical power.

Further, when the user pulls out the electrical power storage device 208 from the retaining unit 206, accompanying the electrical power storage device 208 moving upwardly, the roller 274 comes into contact with the side surface of the electrical power storage device 208 and rotates. The generator 276 generates electrical power based on the rotation of the roller 274 and the rotating shaft member 280, and outputs an AC electrical power. When the electrical power storage device 208 is pulled out from the retaining unit 206, the roller 274 becomes placed in a non-contact state with respect to the electrical power storage device 208, and stops rotating. By the rotation of the roller 274 and the rotating shaft member 280 being stopped, the generator 276 stops generating electrical power.

As shown in FIG. 13 and FIG. 15, the AC/DC conversion unit 254 converts the AC electrical power converted by the generator 276 into a DC electrical power. The AC/DC conversion unit 254, for example, is a diode bridge.

In the case that the electrical power storage device 208 is installed in the retaining unit 206, and further, the connector 238 and the connector 216 are electrically connected, the electrical power storage device 208 and the electrical power conversion unit 258 are capable of transmitting and receiving the electrical power via an electrical power transmission pathway 282. More specifically, a positive electrode of the electrical power storage device 208 is electrically connected, via one electrical power line 284, to a positive electrode on an input side (a primary side) of the electrical power conversion unit 258. A negative electrode of the electrical power storage device 208 is electrically connected, via another electrical power line 286, to a negative electrode on the input side of the electrical power conversion unit 258. The AC output terminals 230 are electrically connected to an output side (a secondary side) of the electrical power conversion unit 258. An external load 288 is capable of being attachably and detachably connected to the AC output terminals 230. Accordingly, the electrical power device 200 functions as an electrical supply power device that supplies the electrical power to the load 288. A typical example of the load 288 is an AC electrical power consuming device such as a home appliance or the like.

The electrical power conversion unit 258 includes an inverter. The electrical power conversion unit 258 converts the DC electrical power supplied from the electrical power storage device 208 into an AC electrical power. The load 288 is driven by an AC electrical power supplied from the electrical power conversion unit 258. Further, in the case that the load 288 is a rotating electric machine or the like, and the load 288 is regeneratively driven (generates electrical power), the electrical power conversion unit 258 converts the AC electrical power supplied from the load 288 into a DC electrical power. The electrical power storage device 208 stores the DC electrical power supplied from the electrical power conversion unit 258.

The control device 256 is an electrical power source device for the purpose of starting the electrical power storage device 208. Further, the control device 256 is a control device in order to control each of respective components of the electrical power device 200 and the electrical power storage device 208. The control device 256 may be attachable and detachable with respect to the electrical power device 200. Alternatively, the control device 256 may be capable of being fixed to the electrical power device 200.

The control device 256 includes a DC electrical power conversion unit 290 (electrical operation unit), an ECU (electronic control unit) 292, and a sub-battery 294 (another electrical power storage unit, a battery). The ECU 292 (a computer), by reading and executing programs stored in a storage unit 296 (a storage medium), realizes the functions of a control unit 298, an activation command unit 300, and a communication unit 302.

The two electrical power lines 284 and 286 are electrically connected to an input side of the DC electrical power conversion unit 290. The DC electrical power conversion unit 290 is a DC/DC converter. The DC electrical power conversion unit 290 converts the DC voltage of the DC electrical power supplied from the electrical power storage device 208 into a low voltage DC voltage. The DC electrical power conversion unit 290 supplies the converted DC voltage to the ECU 292.

The sub-battery 294 supplies the DC electrical power to the ECU 292. Further, the sub-battery 294 stores (is charged by) the DC electrical power converted by the AC/DC conversion unit 254. Moreover, it should be noted that the sub-battery 294 is capable of being charged by the DC electrical power converted by the DC electrical power conversion unit 290.

The activation command unit 300 generates the activation signal (command) in order to place the electrical power storage device 208 in a state of being usable. Specifically, based on the DC voltage supplied from the sub-battery 294 to the ECU 292, the activation command unit 300 generates as the activation signal a voltage equivalent to such a DC voltage. The activation command unit 300 supplies the generated activation signal to the electrical power storage device 208. Moreover, it should be noted that the activation signal, which is the starting command, is a low voltage electrical power (a low voltage) in order to cause an activation control unit 304 in the interior of the electrical power storage device 208 to be operated. Further, it should be noted that the activation signal is not limited to being a voltage signal (an electrical power signal) based on the voltage of the sub-battery 294. The activation signal may be a command signal in order to switch the electrical power storage device 208 to the active state.

The control unit 298 controls each of the components of the electrical power device 200 including those in the interior of the control device 256. For example, the control unit 298 controls the operations of the electrical power conversion unit 258. The communication unit 302 carries out transmission and reception of signals or information to and from the electrical power storage device 208.

The notification unit 260, based on an instruction from the ECU 292, issues a notification of various types of information to the exterior. The notification unit 260, for example, is the indicator 224 (refer to FIG. 11).

The operation input unit 262 receives an operation input from the user, and outputs to the ECU 292 the contents of the operation input that was received.

The electrical power storage unit 214 of the electrical power storage device 208 is made up from a plurality of cells that are connected in series. The electrical power storage unit 214 is a secondary battery. The connection/disconnection unit 264 is a switching element such as a contactor, a semiconductor switch, or the like. The electrical power storage unit 214 and the connection/disconnection unit 264 are provided in series with the electrical power conversion unit 258. A conductive state of the connection/disconnection unit 264 is determined by a control from the BMU 266. The BMU 266 detects the state of the electrical power storage unit 214, and issues a notification to the ECU 292 of the detected state. The operating state of the BMU 266 is determined by a control from the ECU 292. In accordance with the determined operating state, the BMU 266 controls the conductive state of the connection/disconnection unit 264.

The BMU 266 monitors the charging or discharging status of the electrical power storage device 208, the amount of electrical power stored in the electrical power storage unit 214, the temperature, and the like. The BMU 266 shares the monitoring results with the ECU 292. Further, based on control commands from the ECU 292, or alternatively, the aforementioned monitoring results, by controlling the connection/disconnection unit 264 and the like, the BMU 266 controls the charging or discharging between the electrical power storage unit 214 and the exterior of the electrical power storage device 208.

The BMU 266 is a computer such as a processor or the like. The BMU 266, by reading out and executing programs stored in a storage unit 306, realizes the functions of the activation control unit 304, a communication processing unit 308, and a battery control unit 310.

Based on the activation signal supplied from the activation command unit 300, the activation control unit 304 carries out a control in order to switch the state of the electrical power storage device 208 from an inactive state in which the electrical power storage unit 214 and the exterior of the electrical power storage device 208 are not electrically connectable, to an active state in which the electrical power storage unit 214 and the exterior of the electrical power storage device 208 are electrically connectable. Specifically, the activation control unit 304 receives the supply of the activation signal, and causes the connection/disconnection unit 264 to be turned ON. Further, when the supply of the activation signal is stopped, the activation control unit 304 causes the connection/disconnection unit 264 to be turned OFF. Accordingly, in the inactive state, electrical power is incapable of being output from the electrical power storage unit 214 to the exterior of the electrical power storage device 208. Further, in the active state, electrical power is capable of being output from the electrical power storage unit 214 to the exterior of the electrical power storage device 208.

Specifically, when the activation control unit 304 has detected that the activation signal is in a significant state, by causing the connection/disconnection unit 264 to be turned ON, the activation control unit switches the electrical power storage device 208 to the active state. For example, when the signal level of the activation signal is equivalent to the voltage output from the sub-battery 294, the activation control unit 304 considers that the activation signal is in a significant state (a state in which the activation signal is being supplied), and causes the connection/disconnection unit 264 to be turned ON.

Further, when the activation control unit 304 has detected that the activation signal is not in the significant state, the activation control unit switches the electrical power storage device 208 to the inactive state. For example, when the signal level of the activation signal has become a level less than a threshold value (roughly a zero level), the activation control unit 304 considers that the activation signal is not in the significant state (a state in which the activation signal is not being supplied), and causes the connection/disconnection unit 264 to be turned OFF.

In this manner, the connection/disconnection unit 264 and the activation control unit 304 function as an activation processing unit 312 that acts to switch the electrical power storage device 208 into the active state or the inactive state.

For example, the battery control unit 310 detects changes in the state (the voltage, the SOC, etc.) of each of the cells of the electrical power storage unit 214, and adjusts the state of charge of each of the cells to be uniform. The communication processing unit 308 carries out transmission and reception of signals or information to and from the ECU 292.

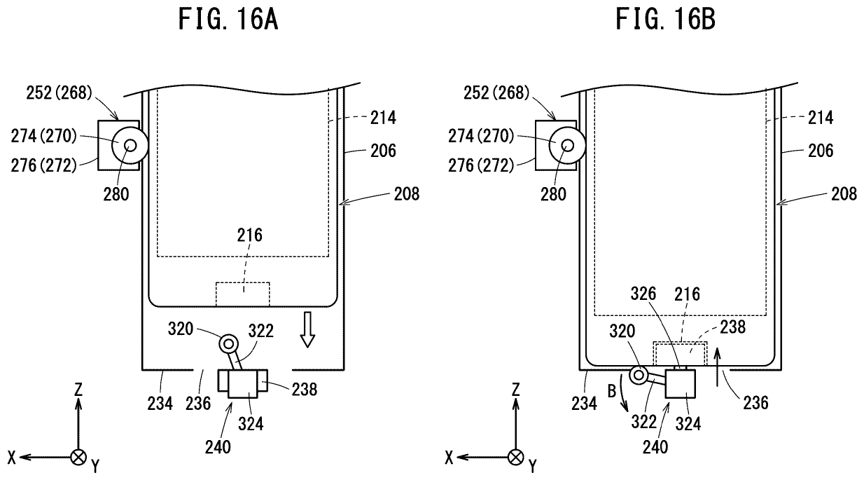

Next, a description will be given, with reference to FIG. 16A to FIG. 24, concerning exemplary modifications (a first exemplary modification to an eighth exemplary modification) of the third embodiment. These exemplary modifications are exemplary modifications of the electrical power device 200, the electrical power storage device 208, or the electrical power system 210. Moreover, in the description of the respective exemplary modifications, concerning the same constituent elements shown in FIG. 11 to FIG. 15, the same reference numerals will be applied thereto, and detailed description of such features will be omitted.

FIG. 16A and FIG. 16B are diagrams showing a first exemplary modification. The first exemplary modification differs from the configuration shown in FIG. 13 to FIG. 14B, in that the configuration of the connector displacement mechanism 240 is changed. The connector displacement mechanism 240 in the first exemplary modification, for example, is a mechanism in which the motive power transmission device disclosed in WO 2020/235618 A1 is used.

The connector displacement mechanism 240 is disposed downwardly of the retaining unit 206, in a manner so as to face toward the insertion hole 236 of the retaining unit 206. According to the first exemplary modification, the insertion hole 236 is formed to be larger than in the configuration shown in FIG. 13 to FIG. 14B. The connector displacement mechanism 240 includes a roller 320, an arm 322, a motive power transmission unit 324, and a connector displacement unit 326.

The motive power transmission unit 324 is disposed downwardly of the retaining unit 206, in a manner so as to face toward the insertion hole 236 of the retaining unit 206. The motive power transmission unit 324 extends in the Y-direction. The arm 322 extends at an angle upwardly from the motive power transmission unit 324. The arm 322 passes through the insertion hole 236, and enters on an inner side of the retaining unit 206. The arm 322 is capable of rotating about an axis of rotation (not shown) extending in the Y-direction. The roller 320 is connected to a distal end of the arm 322. Accordingly, when the electrical power storage unit 214 is not installed in the retaining unit 206, the roller 320 is positioned on the inner side of the retaining unit 206. The connector displacement unit 326 is connected to the motive power transmission unit 324 at a distance separated away in the Y-direction from the arm 322. The connector displacement unit 326 extends in the Z-direction. The connector displacement unit 326 is capable of being displaced in the Z-direction. The connector 238 is connected to the upper end of the connector displacement unit 326.

In the first exemplary modification, when the electrical power storage device 208 is accommodated in the retaining unit 206, the connector displacement mechanism 240, by transmitting from the electrical power storage device 208 to the connector 238 a force that acts on the connector displacement mechanism 240, causes the connector 238 to be raised. In accordance with this feature, the connector 238 and the connector 216 are connected.

Specifically, as shown in FIG. 16A, in a state in which the bottom part of the electrical power storage device 208 is not in contact with the roller 320 of the connector displacement mechanism 240, together with the arm 322 having entered into the inner side of the retaining unit 206, the roller 320 is positioned on the inner side of the retaining unit 206.

When the user inserts the electrical power storage device 208 into the retaining unit 206, and the bottom part of the electrical power storage device 208 abuts against the roller 320, the roller 320 receives a pressing force from the bottom part of the electrical power storage device 208. The pressing force from the electrical power storage device 208 is input to the arm 322 via the roller 320. Consequently, the arm 322 undergoes rotational movement about the axis of rotation in the direction of the arrow B shown in FIG. 16B. A spring (not shown) is provided in the motive power transmission unit 324. The spring stores a portion of the kinetic energy (energy) transmitted to the arm 322 from the electrical power storage device 208. Thereafter, as shown in FIG. 16B, by outputting (releasing) the energy that is stored in the spring to the connector displacement unit 326, the motive power transmission unit 324 thereby causes the connector displacement unit 326 to be displaced upwardly. By the connector displacement unit 326 moving upwardly, the connector 238 passes through the insertion hole 236 and rises. In accordance with this feature, the connector 238 and the connector 216 are connected. Stated otherwise, in the first exemplary modification as well, prior to the connector 238 and the connector 216 being placed in contact, the bottom part of the electrical power storage device 208 is retained by the retaining unit 206. Consequently, it is possible to avoid a situation in which the connector 238 is damaged by an impact from the electrical power storage device 208.

Further, when the user pulls out the electrical power storage device 208 from the retaining unit 206, the connected state between the connector 238 and the connector 216 is released. By the electrical power storage device 208 being pulled out from the retaining unit 206, the roller 320 is released from the pressing force of the electrical power storage device 208. As a result, due to the restoring force of the spring, the roller 320 and the arm 322 return to the initial position shown in FIG. 16A. Further, the connector displacement unit 326 (see FIG. 16B) and the connector 238 move downward.

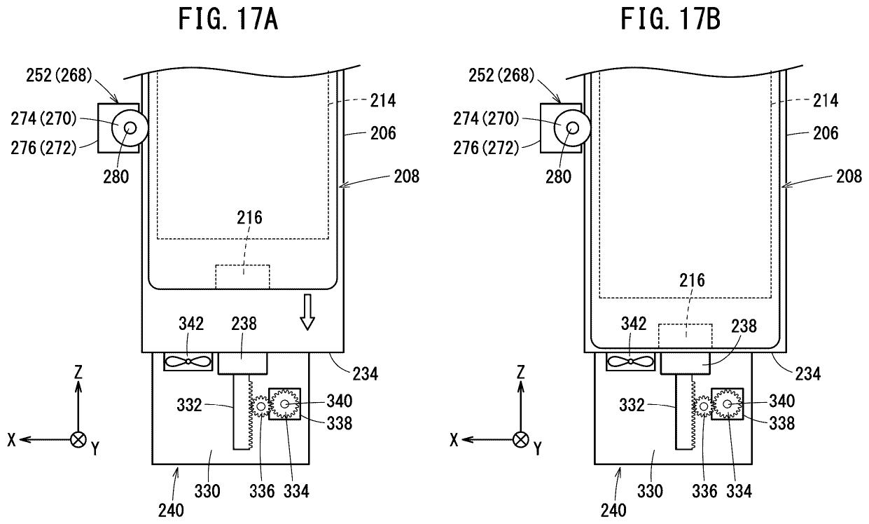

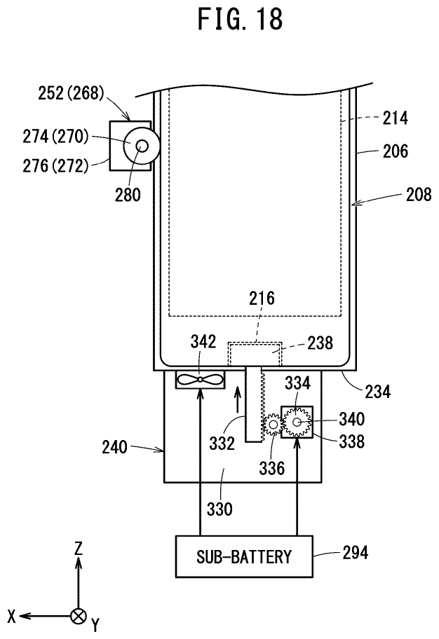

FIG. 17A to FIG. 18 are diagrams showing a second exemplary modification. The second exemplary modification differs from the configuration shown in FIG. 13 to FIG. 14B, in that the configuration of the connector displacement mechanism 240 is changed. The connector displacement mechanism 240 in the second exemplary modification, for example, is a mechanism in which the connector unit disclosed in WO 2022/075427 A1 is used.

The connector displacement mechanism 240 is provided downwardly of the retaining unit 206. The connector displacement mechanism 240 includes a base plate 330, a first rack 332, a first pinion 334, a second pinion 336, and a motor 338. The base plate 330 is attached to the bottom plate 234 of the retaining unit 206. The base plate 330 extends downwardly from the bottom plate 234. The motor 338 is disposed on the base plate 330. The first pinion 334 is coaxially attached to a rotating shaft member 340 of the motor 338. The first rack 332 extends in the Z-direction. The connector 238 is connected to a distal end part of the first rack 332. The first rack 332 is supported to be capable of sliding in the Z-direction with respect to a support member (not shown) provided on the base plate 330. The second pinion 336 enmeshes with the first rack 332 and the first pinion 334. Moreover, in the second exemplary modification, the second pinion 336 may be omitted, and the first rack 332 and the first pinion 334 may be configured in a manner so as to enmesh with each other.

As shown in FIG. 17A, when the user inserts the electrical power storage device 208 into the retaining unit 206, and electrical power storage device 208 is accommodated in the retaining unit 206, the connector 216 and connector 238 face toward each other as shown in FIG. 17B. Next, as shown in FIG. 18, when the DC electrical power is supplied from the sub-battery 294 to the motor 338, the motor 338 is driven. When the rotating shaft member 280 is rotated by the motor 338 being driven, the rotational force of the rotating shaft member 280 is transmitted to the first rack 332 via the first pinion 334 and the second pinion 336. The first rack 332 converts the rotational force transmitted from the second pinion 336 into a force in the Z-direction. Consequently, the first rack 332 and the connector 238 rise toward the electrical power storage device 208. As a result, the connector 238 is inserted through the insertion hole 236 (refer to FIG. 13), and is connected to the connector 216.

A fan 342 is attached to the base plate 330. The fan 342 is driven by the DC electrical power supplied from the sub-battery 294. The fan 342, by blowing cooling air into the inner side of the retaining unit 206, cools the electrical power storage device 208 that is accommodated in the retaining unit 206.

When the user pulls out the electrical power storage device 208 from the retaining unit 206, the connected state between the connector 238 and the connector 216 is released. Next, when the DC electrical power is supplied from the sub-battery 294 to the motor 338, the motor 338 is driven. In this case, the motor 338 causes the rotating shaft member 280 to be rotated, in a manner so that the connector 238 and the first rack 332 descend. The rotational force of the rotating shaft member 280 is transmitted to the first rack 332 via the first pinion 334 and the second pinion 336. The first rack 332 converts the rotational force transmitted from the second pinion 336 into a force in the Z-direction. Consequently, the first rack 332 and the connector 238 return from the position shown in FIG. 18 to the initial position shown in FIG. 17A.

In this manner, according to the second exemplary modification, the electrical power stored in the sub-battery 294 may be supplied to the motor 338 and the fan 342. Consequently, the electrical power generated by the mechanical-electrical conversion unit 252 can be used for a purpose other than starting the electrical power storage device 208. Further, according to the second exemplary modification as well, prior to the connector 238 and the connector 216 being placed in contact, the bottom part of the electrical power storage device 208 is retained by the retaining unit 206. Therefore, according to the second exemplary modification as well, it is possible to avoid a situation in which the connector 238 is damaged by an impact from the electrical power storage device 208.

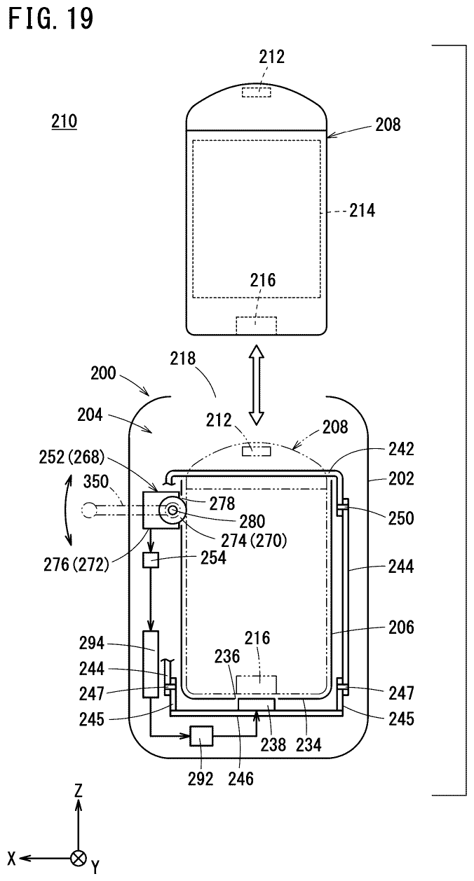

FIG. 19 is a diagram showing a third exemplary modification. In the third exemplary modification, a lever 350 (another input unit) serving as another input unit is connected to the rotating shaft member 280 of the generator 276. When the user causes the lever 350 to be rotated under human power, the generator 276 generates electrical power. More specifically, the generator 276 functions as a hand-cranked generator.

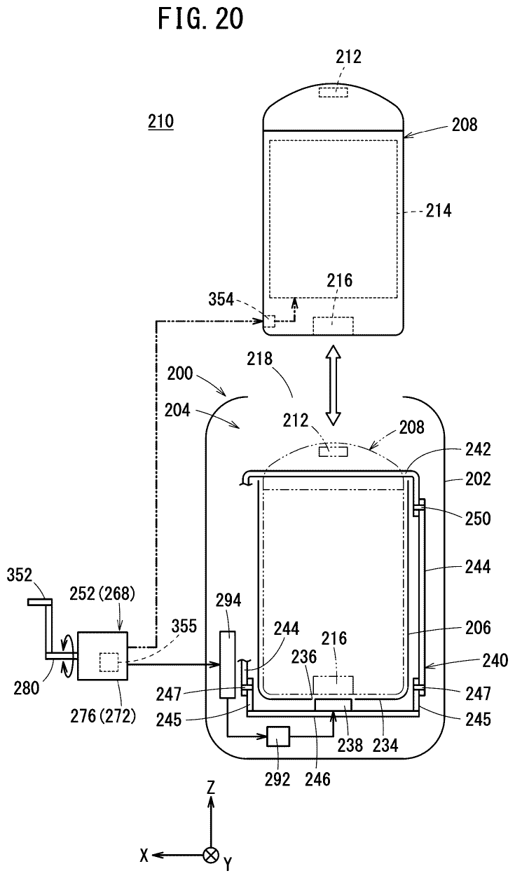

FIG. 20 is a diagram showing a fourth exemplary modification. The fourth exemplary modification shows a case in which the mechanical-electrical conversion device 268, which is the mechanical-electrical conversion unit 252, is disposed at the exterior of the electrical power device 200 and the electrical power storage device 208. The mechanical-electrical conversion device 268 includes the generator 276 and a lever 352 (another input unit). The generator 276 is a DC generator. Alternatively, the generator 276 may be an AC generator. The lever 352 is connected to the rotating shaft member 280 of the generator 276. When the user causes the lever 352 to be rotated under human power, the generator 276 generates electrical power. More specifically, the generator 276 functions as a hand-cranked generator. The generator 276 supplies the generated electrical power (the DC electrical power) to the sub-battery 294, and thereby charges the sub-battery 294. Alternatively, as shown by the two-dot dashed line, the generator 276 may supply the generated electrical power to the electrical power storage unit 214 of the electrical power storage device 208, and may thereby charge the electrical power storage unit 214. In this case, in order to receive the electrical power from the generator 276, it is sufficient if the electrical power storage device 208 includes a connector 354 (another connection unit) such as an input terminal or the like. The connector 354, for example, may be a female connector such as a receptacle or the like. Further, the generator 276 may include an electrical power storage unit 355 in order to store the generated electrical power.

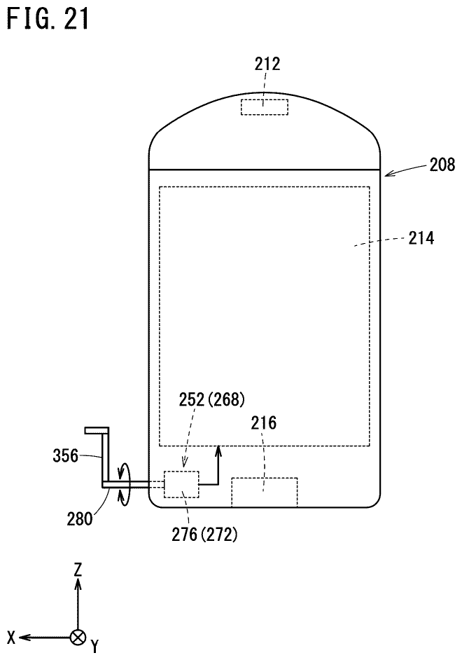

FIG. 21 is a diagram showing a fifth exemplary modification. The fifth exemplary modification shows a case in which the mechanical-electrical conversion unit 252 is provided in the electrical power storage device 208. In the same manner as in the third exemplary modification, the mechanical-electrical conversion unit 252 includes the generator 276 and a lever 356 (another input unit). The generator 276 is a DC generator. Alternatively, the generator 276 may be an AC generator. The lever 356 is connected to the rotating shaft member 280 of the generator 276. When the user causes the lever 356 to be rotated under human power, the generator 276 generates electrical power. More specifically, the generator 276 functions as a hand-cranked generator. The generator 276 supplies the generated electrical power (the DC electrical power) to the electrical power storage unit 214, and thereby charges the electrical power storage unit 214.

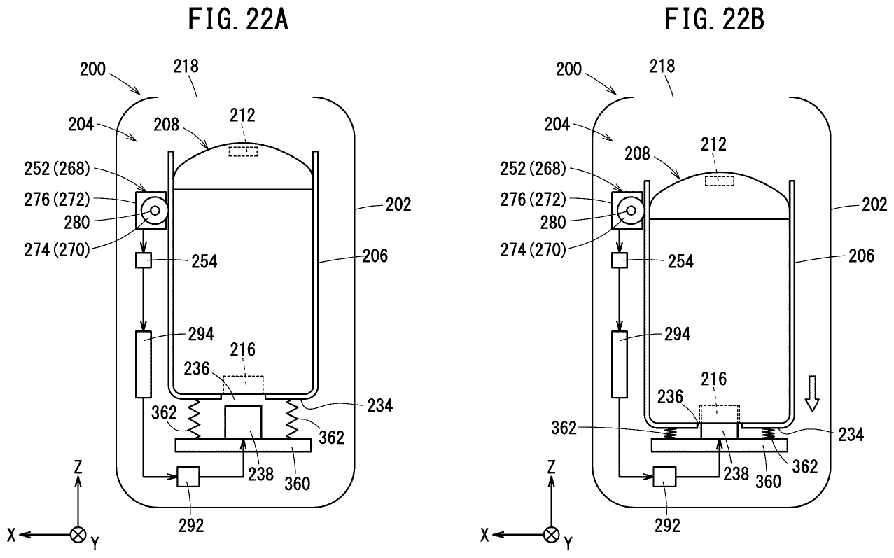

FIG. 22A and FIG. 22B are diagrams showing a sixth exemplary modification. In the sixth exemplary modification, the retaining unit 206 is configured to be capable of moving in the Z-direction. Therefore, according to the sixth exemplary modification, the connector displacement mechanism 240 is not provided inside the casing 202. Moreover, it should be noted that, in FIG. 22A and FIG. 22B, the retaining unit 206 is illustrated so as to have a constant thickness.

In the sixth exemplary modification, a support plate 360 is disposed downwardly of the retaining unit 206. The support plate 360 extends in the X-direction and the Y-direction. The connector 238 is disposed at a location downwardly of the insertion hole 236 on an upper surface of the support plate 360. A plurality of spring members 362 are inserted between the bottom plate 234 of the retaining unit 206 and the support plate 360. The plurality of spring members 362 extend in the upward direction. The retaining unit 206 receives an upwardly directed elastic force of the spring members 362.

The mechanical-electrical conversion unit 252 is disposed so as to be in contact with the retaining unit 206. Stated otherwise, the roller 274, which is the input unit 270, is disposed so as to be in contact with a side plate of the retaining unit 206. More specifically, when the retaining unit 206 moves, the input unit 270 receives a kinetic energy accompanying the movement of the retaining unit 206. Therefore, according to the sixth exemplary modification, when the retaining unit 206 moves, it is desirable for the input unit 270 be disposed at a position where it is capable of coming into contact with the retaining unit 206. In other words, when the retaining unit 206 moves, it is desirable for the input unit 270 be positioned on a movement trajectory of the retaining unit 206.

As shown in FIG. 22A, the user inserts the electrical power storage device 208 into the retaining unit 206, and pushes the electrical power storage device 208 into the retaining unit 206. Consequently, the electrical power storage device 208 is accommodated in the retaining unit 206. Due to the weight of the electrical power storage device 208 itself, the retaining unit 206 descends in opposition to the elastic force of the plurality of spring members 362. At this time, the retaining unit 206 descends while the movement speed of the electrical power storage device 208 decelerates due to the elastic force from the spring members 362. Consequently, the plurality of spring members 362 are compressed in the downward direction. When the user pushes the electrical power storage device 208 further in the downward direction, as shown in FIG. 22B, the connector 238 is inserted through the insertion hole 236, and is connected to the connector 216. Therefore, according to the sixth exemplary modification as well, prior to the connector 238 and the connector 216 being placed in contact, the bottom part of the electrical power storage device 208 is retained by the retaining unit 206, and therefore, it is possible to avoid a situation in which the connector 238 is damaged by an impact from the electrical power storage device 208. In this case, the roller 274 rotates when the retaining unit 206 descends. Accordingly, the generator 276 generates electrical power accompanying the rotation of the roller 274 and the rotating shaft member 280.

When the user pulls out the electrical power storage device 208 from the retaining unit 206, the connected state between the connector 238 and the connector 216 is released. Further, the retaining unit 206 is released from the state of being pressed by the electrical power storage device 208. As a result, together with the plurality of spring members 362 extending in the upward direction, the retaining unit 206 rises in a manner so as to separate away from the support plate 360. The roller 274 rotates when the retaining unit 206 rises. Accordingly, the generator 276 generates electrical power accompanying the rotation of the roller 274 and the rotating shaft member 280.

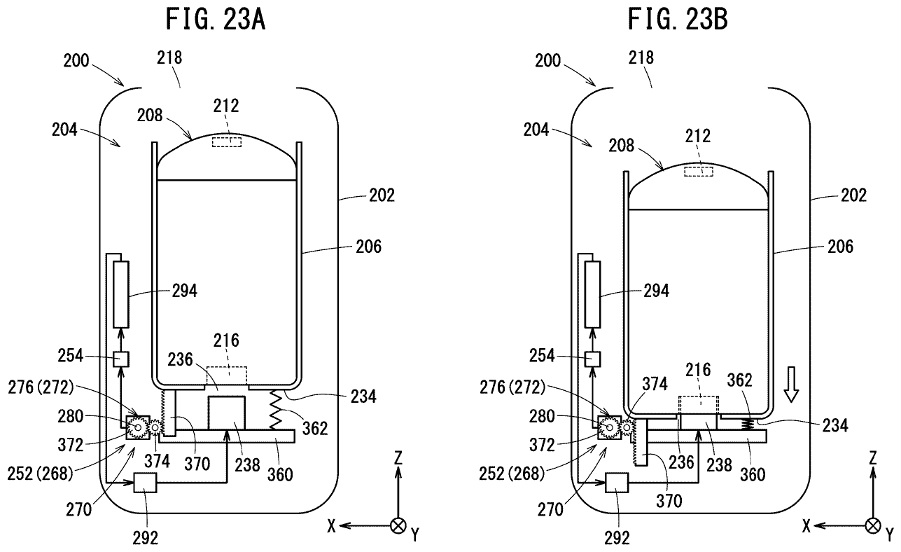

FIG. 23A and FIG. 23B are diagrams showing a seventh exemplary modification. The seventh exemplary modification differs from the sixth exemplary modification, in that the mechanical-electrical conversion unit 252 is disposed downwardly of the retaining unit 206. More specifically, the seventh exemplary modification differs from the sixth exemplary modification in that, from among the plurality of the spring members 362, one of the spring members 362 is replaced by the mechanical-electrical conversion unit 252. Moreover, the mechanical-electrical conversion unit 252 is not connected to the support plate 360.

Specifically, the mechanical-electrical conversion unit 252 includes a second rack 370, a third pinion 372 (a motive power transmission unit), a fourth pinion 374 (a motive power transmission unit), and the generator 276. The second rack 370, the third pinion 372, and the fourth pinion 374 constitute the input unit 270. The second rack 370 is connected to the bottom plate 234 of the retaining unit 206. The second rack 370 extends downwardly from the bottom plate 234 of the retaining unit 206. The third pinion 372 is coaxially connected to the rotating shaft member 280 of the generator 276. The fourth pinion 374 enmeshes with the third pinion 372 and the second rack 370. Moreover, in the seventh exemplary modification, the fourth pinion 374 may be omitted, and the second rack 370 and the third pinion 372 may be configured in a manner so as to enmesh with each other.

As shown in FIG. 23A, the user inserts the electrical power storage device 208 into the retaining unit 206, and pushes the electrical power storage device 208 into the retaining unit 206. Consequently, the electrical power storage device 208 is accommodated in the retaining unit 206. Therefore, according to the seventh exemplary modification as well, prior to the connector 238 and the connector 216 being placed in contact, the bottom part of the electrical power storage device 208 is retained by the retaining unit 206. Consequently, it is possible to avoid a situation in which the connector 238 is damaged by an impact from the electrical power storage device 208. Thereafter, due to the weight of the electrical power storage device 208 itself, the retaining unit 206 descends in opposition to the elastic force of the spring members 362. At this time, the retaining unit 206 descends while the electrical power storage device 208 decelerates due to the elastic force from the spring members 362. Consequently, the spring members 362 are compressed in the downward direction. Further, the second rack 370 descends together with the retaining unit 206. Since the fourth pinion 374 enmeshes with the second rack 370 and the third pinion 372, it converts the downwardly directed movement force of the second rack 370 into a rotational force. By the rotational force being transmitted from the fourth pinion 374 to the third pinion 372 and thereby rotating the rotating shaft member 280, the generator 276 generates electrical power.

When the user pushes the electrical power storage device 208 further in the downward direction, as shown in FIG. 23B, the connector 238 is inserted through the insertion hole 236, and is connected to the connector 216. At this time, the retaining unit 206 and the second rack 370 stop descending (the first position). Further, the rotation of the third pinion 372 and the fourth pinion 374 is also stopped. Consequently, the generator 276 stops generating electrical power.

When the user pulls out the electrical power storage device 208 from the retaining unit 206, the connected state between the connector 238 and the connector 216 is released. Further, the retaining unit 206 is released from the state of being pressed by the electrical power storage device 208. As a result, the spring members 362 extend in the upward direction, and the retaining unit 206 rises in a manner so as to separate away from the support plate 360. At this time, the second rack 370 ascends together with the retaining unit 206. The fourth pinion 374 converts the upwardly direction movement force of the second rack 370 into a rotational force. The generator 276 generates electrical power due to the rotational force that is transmitted from the fourth pinion 374 to the third pinion 372.

Thereafter, the retaining unit 206 is supported upwardly of the support plate 360, in a state with the spring members 362 being fully extended in the upward direction. More specifically, the retaining unit 206 and the second rack 370 stop rising. Consequently, the retaining unit 206 and the second rack 370 return to the initial position (the second position) shown in FIG. 23A. As a result, the third pinion 372 and the fourth pinion 374 stop rotating, and therefore, the generator 276 stops generating electrical power.

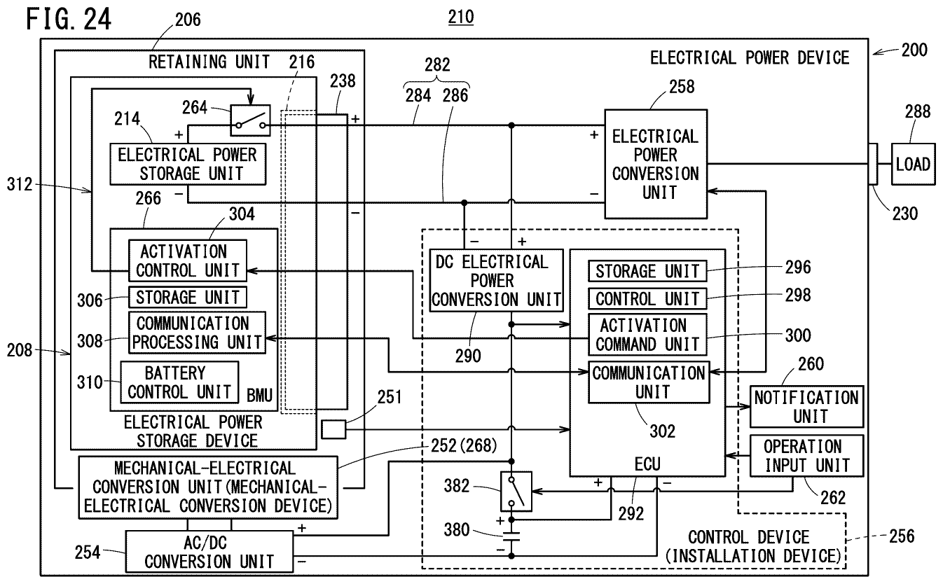

FIG. 24 is a diagram showing an eight exemplary modification. The eighth exemplary modification differs from the configuration shown in FIG. 15, in that a capacitor 380 (another electrical power storage unit) is provided instead of the sub-battery. In the eighth exemplary modification, a switch 382 (a connection/disconnection unit) and the capacitor 380 are connected in series with respect to the AC/DC conversion unit 254. The switch 382, for example, is a switch that is turned ON or OFF in accordance with an operation input of the operation input unit 262 made by the user. The switch 382 is a switching element such as a contactor, a semiconductor switch, or the like. For the capacitor 380, various types of capacitors can be used therefor, such as a capacitor having a comparatively large capacitance such as an electric double layer capacitor or the like, or a capacitor having a comparatively small capacitance such as a multilayer ceramic capacitor, an electrolytic capacitor, or the like.

When the switch 382 is turned ON, the DC electrical power from the AC/DC conversion unit 254 or the DC electrical power conversion unit 290 is supplied to the capacitor 380, and thereby it is possible to charge the capacitor 380. Further, it is possible to supply the DC electrical power from the capacitor 380 to the ECU 292. Furthermore, by turning OFF the switch 382, it is possible to suppress the discharging of the capacitor 380.

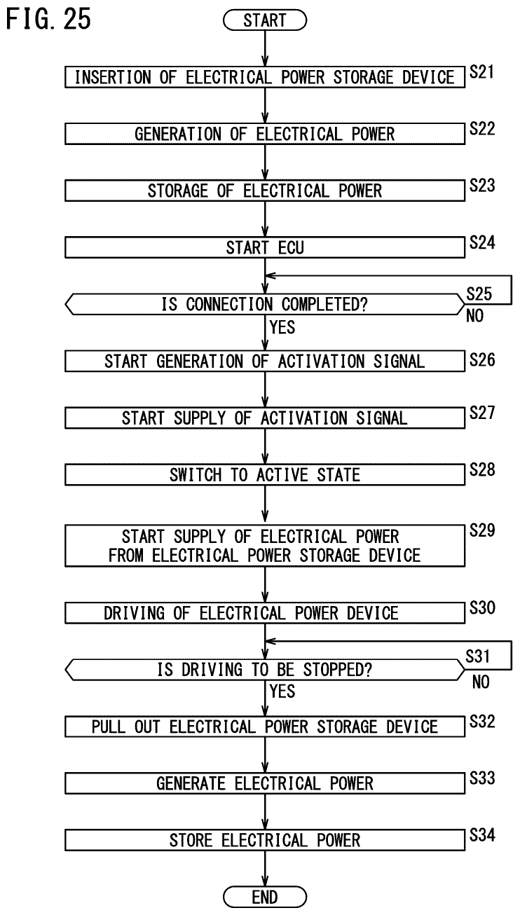

Next, with reference to FIG. 25, a description will be given concerning operations of the electrical power system 210 including the electrical power device 200 according to the third embodiment. Moreover, it should be noted that the description of these operations is common to each of the configurations of the electrical power system 210 described in FIG. 11 to FIG. 24.

First, in step S21 (the first step), the user inserts the electrical power storage device 208 into the retaining unit 206 of the electrical power device 200.

In step S22 (the second step), when the electrical power storage device 208 is inserted into the retaining unit 206, or alternatively, when the retaining unit 206 in which the electrical power storage device 208 is installed is lowered, the mechanical-electrical conversion unit 252 generates electrical power. Specifically, by the input unit 270 coming into contact with the electrical power storage device 208 or the retaining unit 206 during movement thereof, the input unit 270 receives the kinetic energy of the electrical power storage device 208 or the retaining unit 206. The conversion unit 272 converts the kinetic energy received by the input unit 270 into electrical energy. Specifically, the conversion unit 272 generates electrical power based on the kinetic energy, and thereby generates the AC electrical power.

In step S23 (the third step), the AC/DC conversion unit 254 converts the AC electrical power generated by the conversion unit 272 into a DC electrical power. The AC/DC conversion unit 254 supplies the converted DC electrical power to the sub-battery 294 or the capacitor 380. Consequently, the sub-battery 294 or the capacitor 380 is charged.

In step S24, the user operates the operation input unit 262. Based on an operation input from the operation input unit 262, the sub-battery 294 or the capacitor 380 starts supplying the DC electrical power to each of the components of the electrical power device 200 including the ECU 292. As a result, the electrical power device 200 including the ECU 292 is started.

The detection unit 251 sequentially detects the connected state between the connector 216 and the connector 238 of the electrical power storage device 208, and sequentially outputs the detection result to the ECU 292. In step S25, based on the detection result from the detection unit 251, the control unit 298 of the ECU 292 determines whether or not the connector 238 and the connector 216 are in a connected state (whether or not the connection is completed).

In the case that the detection result is to the effect that the connector 238 and the connector 216 are in the connected state, the control unit 298 determines that the electrical power storage device 208 is accommodated in the retaining unit 206, and further, that the connector 238 and the connector 216 are connected (step S25: YES). Thereafter, the ECU 292 proceeds to the process of step S26.

In step S26, the control unit 298 issues an instruction with respect to the activation command unit 300 to generate an activation signal. The activation command unit 300 receives the instruction from the control unit 298, and based on the DC electrical power (the DC voltage) supplied from the sub-battery 294, initiates generation of the activation signal.

Consequently, in step S27 (the fourth step), the activation command unit 300 starts supplying the activation signal to the activation control unit 304.

In step S28 (the fifth step), the activation control unit 304 switches the connection/disconnection unit 264 from OFF to ON, based on the activation signal supplied from the activation command unit 300. Consequently, the electrical power storage device 208 switches from the inactive state to the active state. Further, the BMU 266 executes the starting process of the electrical power storage device 208 including the initialization process of the electrical power storage device 208. As a result, the electrical power storage device 208 is started. Moreover, by the execution of the starting process, various signals or information become capable of being transmitted and received between the communication processing unit 308 and the communication unit 302.

In step S29, the electrical power storage device 208 starts supplying the DC electrical power from the electrical power storage unit 214 to the exterior (the electrical power device 200).

In step S30, the electrical power conversion unit 258 converts the DC electrical power into an AC electrical power based on a control from the ECU 292. The electrical power conversion unit 258 supplies the converted AC electrical power to the external load 288.

Thereafter, in the case that the user has decided to stop driving the electrical power device 200 (step S31: YES), then in step S32, the user pulls out the electrical power storage device 208 from the retaining unit 206. In accordance therewith, the connector 216 and the connector 238 become placed in the disconnected state. As a result, the supply of the DC electrical power from the electrical power storage device 208 to the electrical power device 200 is suspended. Accordingly, the electrical power device 200 switches from the started state to the unstarted state. Further, since the supply of the activation signal from the activation command unit 300 to the activation control unit 304 is suspended, the electrical power storage device 208 is switched from the active state to the inactive state.

In step S33, while the electrical power storage device 208 is being pulled out from the retaining unit 206, the input unit 270 that is in contact with the retaining unit 206 or the electrical power storage device 208 receives the kinetic energy of the retaining unit 206 or the electrical power storage device 208. The conversion unit 272 converts the kinetic energy received by the input unit 270 into electrical energy. More specifically, the conversion unit 272 generates an AC electrical power.

In step S34, the AC/DC conversion unit 254 converts the AC electrical power generated by the conversion unit 272 into a DC electrical power, and charges the sub-battery 294 or the capacitor 380 with the DC electrical power.

Moreover, according to the third embodiment, the connector 238 is of a configuration that enables the electrical power storage device 208 to be attached and detached without requiring any special tool or the like. The third embodiment can also be applied to a case in which the electrical power storage device 208 is not frequently attached to or detached from the connector 238.

Furthermore, according to the third embodiment, a description has been given concerning a case in which the electrical power storage device 208 or the retaining unit 206 moves up and down in the Z-direction inside the casing 202. The retaining unit 206 that retains the electrical power storage device 208 can also undergo translational motion or rotation motion. Even in this case, the mechanical-electrical conversion unit 252 (the mechanical-electrical conversion device 268) is capable of receiving the kinetic energy of the electrical power storage device 208 or the retaining unit 206, and can convert the kinetic energy into electrical energy.

Furthermore, according to the third embodiment, a description has been given in which the generator 276 is capable of functioning as a hand-cranked generator. More specifically, a description has been given concerning a case in which the user causes the generator 276 to generate electrical power using an upper limb such as a hand or the like. According to the third embodiment, the generator 276 may generate electrical power upon receiving a leg force (a pedal force) from the user. More specifically, the user may cause the generator 276 to generate electrical power using a lower limb such as a foot or the like.

Further, in the third embodiment, the electrical power system 210 is capable of being applied to various electrical power source systems that supply the electrical power to the load 288 or the like from at least one of the electrical power storage devices 208, or alternatively, that charge the at least one of the electrical power storage devices 208. The electrical power system 210 is capable of being installed in a residence, a business office, or alternatively, a public facility or the like.

The electrical power system 210 is also capable of being applied to an electrical power source system of various types of mobile bodies. Mobile bodies on which people are capable of riding, or alternatively, mobile bodies on which people are incapable of riding are included in the various types of mobile bodies. As the mobile bodies of such a type, there may be cited vehicles, aircraft, flying objects, ships, and the like. Further, as the electrical power supply systems of the vehicles, there may be cited an electrical power supply system of an electric vehicle such as an electric automobile or the like, and an electrical power supply system of a vehicle in which a drive motor is mounted such as a hybrid vehicle. More specifically, the electrical power system 210 is capable of being applied to electrical power supply systems of various types of vehicles such as a one-wheeled vehicle, a two-wheel vehicle, or alternatively, a four-wheel vehicle or the like. In the case that the electrical power system 210 is applied to a mobile body, as shown in FIG. 15 and FIG. 24, the control device 256 may be configured to be attachable and detachable with respect to the mobile body.

The electrical power system 210 is can also be applied to electrical power supply systems for various general-purpose devices. Specifically, as the various general-purpose devices, there may be cited (1) various charging devices, (2) various discharging devices, and (3) various working machines such as general-purpose working machines, lawn mowers, tillers, and blowers or the like. Further, as the various general-purpose devices, there may be cited (4) electrical devices in which electric motors are not included, such as floodlights and lighting devices or the like, and (5) various devices installed in residential dwellings, buildings, or the like. Even in this case, as shown in FIG. 15 and FIG. 24, the control device 256 may be configured to be attachable and detachable with respect to the general-purpose device.

Concerning items (1) through (5), such devices may be general-purpose devices that do not have a person riding thereon. Further, concerning item (3), the working machine may be a working machine that does not have a person riding thereon. Alternatively, concerning item (3), the working machine may be a working machine that has a person riding thereon. Furthermore, as examples of the aforementioned item (5), there may be cited (A) equipment that operates on the basis of DC electrical power, as in audio equipment such as clocks and radio cassette recorders and the like, and (B) equipment that operates on the basis of AC electrical power such as electric fans, juicers, mixers, or alternatively, incandescent electric lamps or the like. Further, as other examples of the aforementioned item (5), there may be cited (C) equipment that operates on the basis of DC electrical power that is converted from AC electrical power, such as televisions, radios, stereos, or alternatively, personal computers or the like. Furthermore, as other examples of the aforementioned item (5), there may be cited (D) inverter type equipment including washing machines, refrigerators, air conditioners, microwave ovens, and fluorescent lamps. The equipment of the aforementioned item (D) is equipment that operates on the basis of the AC electrical power, which after having been temporarily converted from the AC electrical power to the DC electrical power, is then further converted from the DC electrical power.

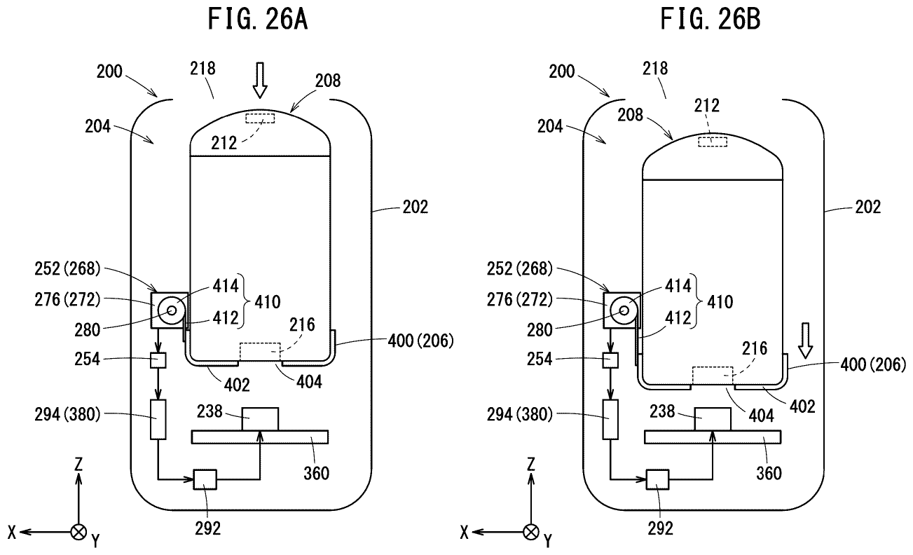

Next, a description will be given, with reference to FIG. 26A to FIG. 41, concerning further exemplary modifications (a ninth exemplary modification to an eighteenth exemplary modification) of the first to third embodiments. In this instance, representatively, the ninth exemplary modification to the eighteenth exemplary modification will be described using the constituent elements described in the third embodiment (refer to FIG. 11 to FIG. 25). Moreover, in the description of the ninth exemplary modification to the eighteenth exemplary modification, concerning features thereof that are common with the third embodiment, detailed description of such feature will be omitted. Further, the ninth exemplary modification to the eighteenth exemplary modification can also be applied to the first embodiment and the second embodiment (refer to FIG. 1 to FIG. 10B).

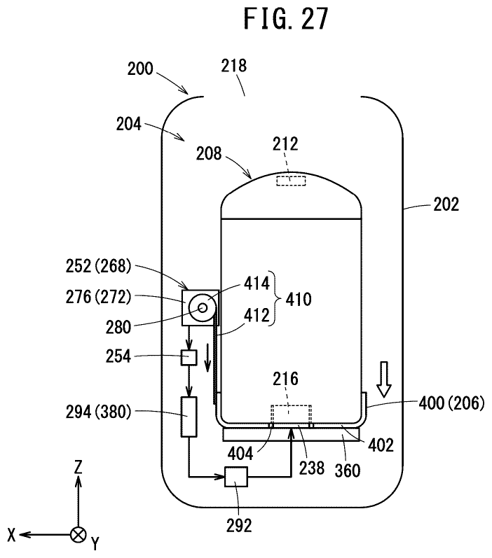

FIG. 26A to FIG. 27 are diagrams showing a ninth exemplary modification. The ninth exemplary modification differs from the third embodiment (refer to FIG. 11 to FIG. 25) in that the retaining unit 206 is a tray 400.

In comparison with the retaining unit 206 of the third embodiment, the tray 400 is a storage unit in which the bottom thereof is shallower. The tray 400 serves to retain the bottom part of the electrical power storage device 208. An insertion hole 404 is formed in a bottom plate 402 of the tray 400. The insertion hole 404 is formed in a manner so as to face toward the connector 216.

A spring member 410 (a motive power transmission unit, an urging member) is connected to the tray 400. The spring member 410 is a constant resistance spring (CR spring) in the form of a constant force spring. The spring member 410 includes a spring member 412 and a drum 414. The spring member 412 is wound around the drum 414. A distal end of the spring member 412 is connected to the tray 400. The drum 414 is coaxially connected to the rotating shaft member 280 of the generator 276.

In the case that the electrical power storage device 208 is not installed in the electrical power device 200, the tray 400 is spaced apart upwardly of the support plate 360 (refer to FIG. 26A, the second position).

When the user inserts the electrical power storage device 208 into the interior space 204, the electrical power storage device 208 is placed on the tray 400. Consequently, together with the electrical power storage device 208 being retained on the tray 400, the connector 216 and the insertion hole 404 face toward each other.

By the electrical power storage device 208 being placed on the tray 400, the electrical power storage device 208 and the tray 400 descend under the weight of the electrical power storage device 208 (refer to FIG. 26B). Since the distal end of the spring member 412 is connected to the tray 400, the drum 414 rotates accompanying the lowering of the tray 400, and the spring member 412 is drawn downwardly from the drum 414. By the rotating shaft member 280 being rotated accompanying the rotation of the drum 414, the generator 276 generates electrical power. The generator 276 stores the generated electrical power in the sub-battery 294 or the capacitor 380.

When the electrical power storage device 208 and the tray 400 are further lowered, the bottom plate 402 of the tray 400 comes into abutment against the support plate 360 (refer to FIG. 27, the first position). At this time, the connector 238 is inserted through the insertion hole 404, and is connected to the connector 216. Further, by the tray 400 coming into abutment against the support plate 360, the movement of the tray 400 is stopped. Consequently, the rotation of the drum 414 is stopped, and the generation of electrical power by the generator 276 also stops.

Further, when the user pulls out the electrical power storage device 208 from the tray 400, the connector 216 and the connector 238 are separated. By the electrical power storage device 208 rising, the tray 400 is released from the load of the electrical power storage device 208. A spring force acts on the spring member 412 in the direction (the upward direction) in which the drum 414 winds and takes in. Accompanying being released from the load of the electrical power storage device 208, the tray 400 is raised by the spring force of the spring member 412. Accordingly, when the electrical power storage device 208 is pulled out from the tray 400, the spring member 412 is wound and taken in around the drum 414, and the tray 400 is raised up to the position shown in FIG. 26A. When the drum 414 is being rotated in order to wind and take in the spring member 412, the generator 276 generates electrical power, and the generated electrical power is stored in the sub-battery 294 or the capacitor 380.

According to the ninth exemplary modification, since the spring member 410 is a constant force spring, in the case that the spring member 412 is pulled out from the drum 414, the load (the spring output) of the spring member 412 becomes constant, regardless of the amount by which the spring member 412 is pulled out. In accordance with this feature, in the ninth exemplary modification, it becomes unnecessary to use a rack, pinions, other springs, a damper, or the like. Further, according to the ninth exemplary modification, prior to the connector 238 and the connector 216 being placed in contact, the bottom part of the electrical power storage device 208 is retained on the tray 400, and therefore, it is possible to avoid a situation in which the connector 238 is damaged by an impact from the electrical power storage device 208.

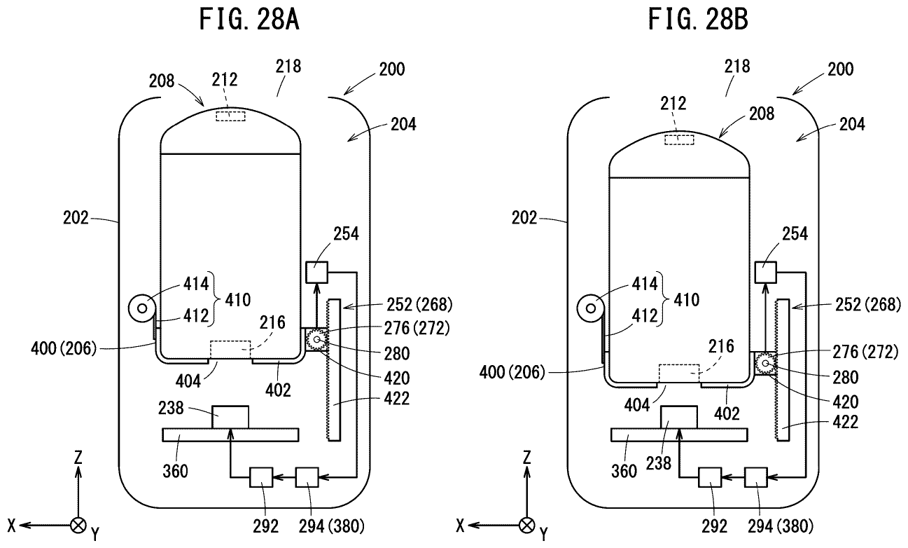

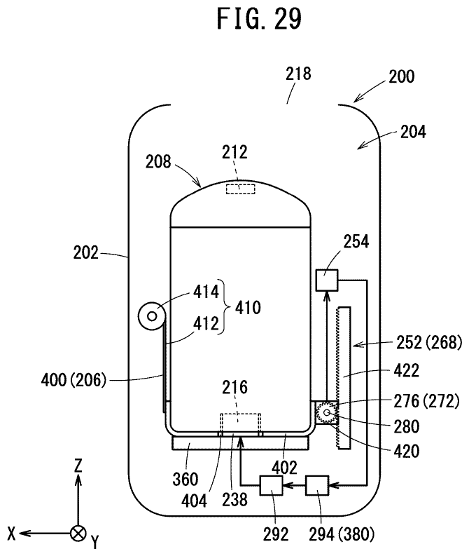

FIG. 28A to FIG. 29 are diagrams showing a tenth exemplary modification. The tenth exemplary modification differs from the ninth exemplary modification (refer to FIG. 26A to FIG. 27) in that the spring member 410 and the generator 276 are not connected to each other.

According to the tenth exemplary modification, in the same manner as in the ninth exemplary modification, a distal end of the spring member 412 of the spring member 410 is connected to one side part of the tray 400. Further, the generator 276 is fixed to another side part of the tray 400.

A pinion 420 (an electrical power transmission unit) is coaxially connected to the rotating shaft member 280 of the generator 276. A rack 422 extends in the Z-direction into the interior space 204 of the casing 202. The rack 422 extends in the Z-direction between a side of the support plate 360 and upwardly of the position (the second position) of the tray 400 shown in FIG. 28A. The rack 422 is fixed to the casing 202 via a fixing member (not shown). The pinion 420 enmeshes with the rack 422.

In the tenth exemplary modification as well, in the same manner as in the ninth exemplary modification, when the electrical power storage device 208 is placed on the tray 400, the electrical power storage device 208 and the tray 400 descend under the weight of the electrical power storage device 208 itself (refer to FIG. 28A and FIG. 28B). At this time, by the drum 414 rotating accompanying the tray 400 descending, the spring member 412 is pulled out downwardly from the drum 414. Furthermore, by the pinion 420 undergoing rotation accompanying the lowering of the tray 400, the rotating shaft member 280 rotates, and the generator 276 generates electrical power. The generator 276 stores the generated electrical power in the sub-battery 294 or the capacitor 380. Stated otherwise, the electrical power storage device 208 and the tray 400 are lowered in a manner so that the spring member 412 is pulled out downwardly from the drum 414, and further, the pinion 420 moves while being in engagement with the rack 422.

When the electrical power storage device 208 and the tray 400 are further lowered, the bottom plate 402 of the tray 400 comes into abutment against the support plate 360, and therefore, the connector 238 is inserted through the insertion hole 404, and is connected to the connector 216 (refer to FIG. 29). Further, by the tray 400 coming into abutment against the support plate 360, the movement of the tray 400 is stopped. Consequently, together with the rotation of the drum 414 being stopped, the pinion 420 stops rotating, and the generation of electrical power by the generator 276 also stops.

Further, when the user pulls out the electrical power storage device 208 from the tray 400, the connector 216 and the connector 238 are separated, and the tray 400 is released from the load of the electrical power storage device 208. Consequently, the tray 400 is raised by the spring force of the spring member 412. Accompanying the tray 400 being raised, the pinion 420 also rises while rotating. As a result, the spring member 412 is wound and taken in around the drum 414, and the tray 400 is raised up to the position shown in FIG. 28A. When the tray 400 has risen up to the position shown in FIG. 28A, the pinion 420 stops rotating. The generator 276 generates electrical power during the rotation of the pinion 420, and stores the generated electrical power in the sub-battery 294 or the capacitor 380.

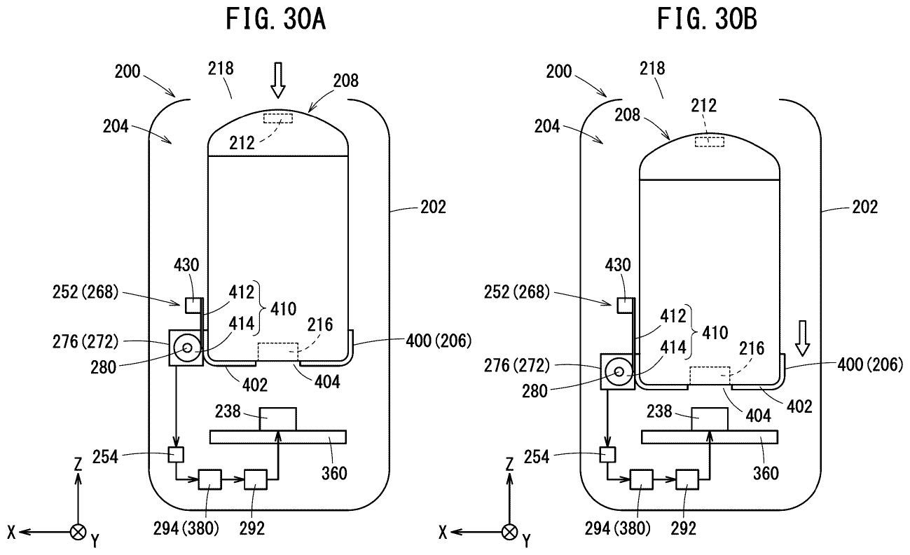

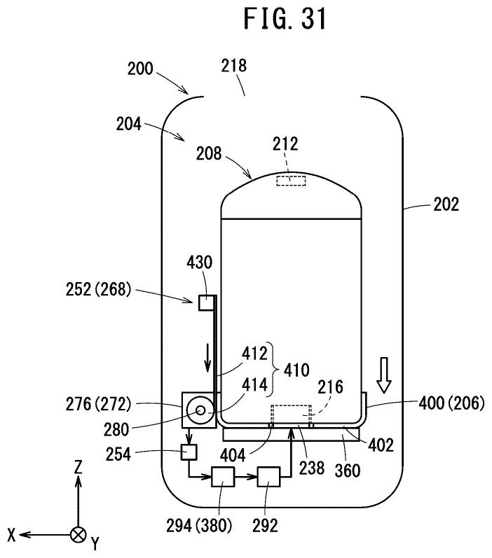

FIG. 30A to FIG. 31 are diagrams showing an eleventh exemplary modification. The eleventh exemplary modification differs from the ninth exemplary modification and the tenth exemplary modification (refer to FIG. 26A to FIG. 29) in that the spring member 410 and the generator 276 are connected to the tray 400.

In the eleventh exemplary modification, the generator 276 is fixed to one side portion of the tray 400. The drum 414 of the spring member 410 is coaxially connected to the rotating shaft member 280 of the generator 276. The distal end of the spring member 412 is fixed to a fixing part 430 that is positioned more upwardly than the tray 400. The fixing part 430 is fixed to the casing 202 via a fixing member (not shown).

In the eleventh exemplary modification as well, in the same manner as in the ninth exemplary modification and the tenth exemplary modification, when the electrical power storage device 208 is placed on the tray 400, the electrical power storage device 208 and the tray 400 descend under the weight of the electrical power storage device 208 itself (refer to FIG. 30A and FIG. 30B). As noted previously, the drum 414 of the spring member 410 is connected to the rotating shaft member 280 of the generator 276 that is fixed to the tray 400. Further, the distal end of the spring member 412 is fixed to the fixing part 430 that is positioned more upwardly than the tray 400. Therefore, when the tray 400 descends, the spring member 412 is pulled out from the drum 414. By the drum 414 being rotated accompanying the spring member 412 being pulled out, the rotating shaft member 280 rotates, and thereby the generator 276 generates electrical power. The generator 276 stores the generated electrical power in the sub-battery 294 or the capacitor 380.

When the electrical power storage device 208 and the tray 400 are further lowered, the bottom plate 402 of the tray 400 comes into abutment against the support plate 360, and the connector 238 is inserted through the insertion hole 404, and is connected to the connector 216 (refer to FIG. 31). When the tray 400 comes into abutment against the support plate 360, the movement of the tray 400 is stopped. Consequently, together with the rotation of the drum 414 being stopped, the generation of electrical power by the generator 276 also stops.

Further, when the user pulls out the electrical power storage device 208 from the tray 400, the connector 216 and the connector 238 are separated, and the tray 400 is released from the load of the electrical power storage device 208. The spring member 410 is connected to the tray 400 via the generator 276. Further, the distal end of the spring member 412 is fixed to the fixing part 430. Therefore, when the tray 400 is released from the load of the electrical power storage device 208, the drum 414 rotates in a manner so as to wind and take in the spring member 412. Consequently, the tray 400 is raised by the spring force of the spring member 412, and the generator 276 generates electrical power due to the rotation of the rotating shaft member 280 accompanying the rotation of the drum 414. The generated electrical power is stored in the sub-battery 294 or the capacitor 380. When the tray 400 has risen to the position (the second position) shown in FIG. 30A, the spring member 412 is wound and taken in around the drum 414, and together therewith, the generator 276 stops generating electrical power.

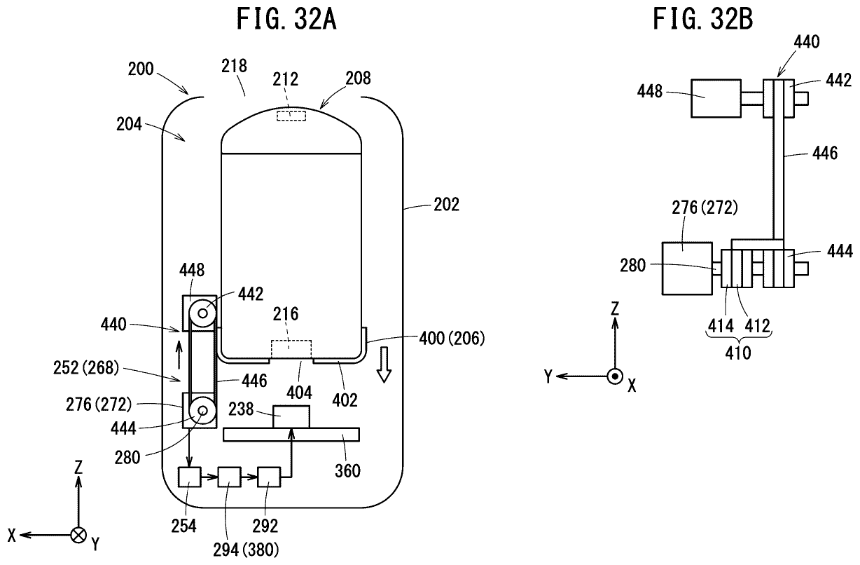

FIG. 32A to FIG. 34B are diagrams showing a twelfth exemplary modification. The twelfth exemplary modification differs from the ninth exemplary modification to the eleventh exemplary modification (refer to FIG. 26A to FIG. 31) in that a lifting and lowering mechanism 440 for causing the tray 400 to be lifted and lowered is provided.

In the twelfth exemplary modification, the generator 276 is fixed to the support plate 360. The drum 414 of the spring member 410 is coaxially connected to the rotating shaft member 280 of the generator 276.

The lifting and lowering mechanism 440 is provided between the tray 400 and the spring member 410. The lifting and lowering mechanism 440 includes a first pulley 442, a second pulley 444, and a belt 446. The first pulley 442 is positioned upwardly of the tray 400, the generator 276, and the spring member 410. The first pulley 442 is rotatably fixed to a fixing part 448. The fixing part 448 is fixed to the casing 202 via a fixing member (not shown). The second pulley 444 is coaxially connected to the rotating shaft member 280 and the drum 414. The belt 446 is stretched around the first pulley 442 and the second pulley 444.

One side part of the tray 400 is fixed to the belt 446. The tray 400 is fixed to the belt 446 at the position shown in FIG. 32A, in a manner so as to be connected at a location in close proximity to the first pulley 442 on the belt 446. A distal end of the spring member 412 is fixed to the belt 446. The distal end of the spring member 412 is fixed to the belt 446 at the position shown in FIG. 32A and FIG. 32B, in a manner so as to be connected at a location in close proximity to the second pulley 444 on the belt 446.

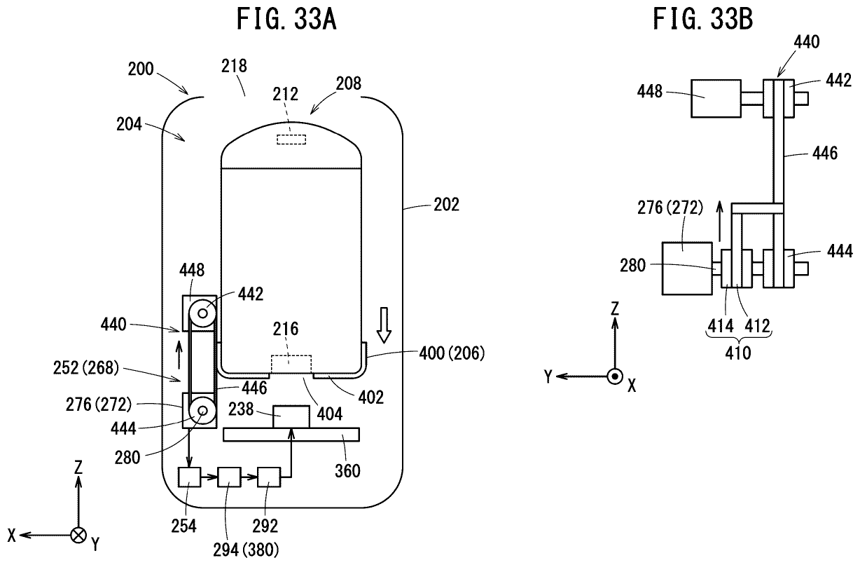

In the twelfth exemplary modification as well, in the same manner as in the ninth exemplary modification to the eleventh exemplary modification, when the electrical power storage device 208 is placed on the tray 400, the electrical power storage device 208 and the tray 400 descend under the weight of the electrical power storage device 208 itself (refer to FIG. 32A and FIG. 33A). The belt 446 rotates accompanying the electrical power storage device 208 and the tray 400 descending, and the first pulley 442 and the second pulley 444 rotate, respectively. Accompanying the rotation of the second pulley 444, the rotating shaft member 280 and the drum 414 also rotate. Consequently, the spring member 412 is pulled upwardly from the drum 414 (refer to FIG. 32B to FIG. 33B). Further, the generator 276 generates electrical power due to being rotated by the rotating shaft member 280, and stores the generated electrical power in the sub-battery 294 or the capacitor 380.

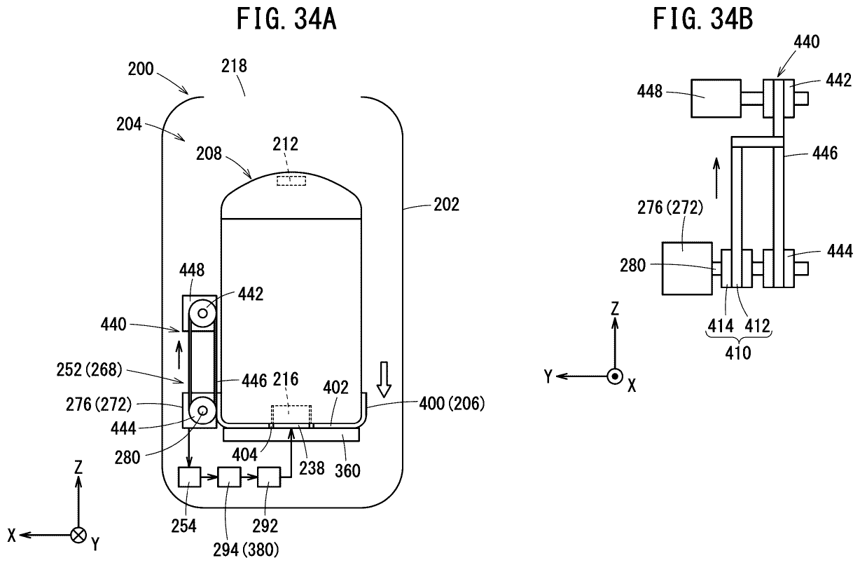

When the electrical power storage device 208 and the tray 400 are further lowered, the bottom plate 402 of the tray 400 comes into abutment against the support plate 360, and the connector 238 is inserted through the insertion hole 404, and is connected to the connector 216 (refer to FIG. 34A). When the tray 400 comes into abutment against the support plate 360, the movement of the tray 400 is stopped. Consequently, the rotation of the first pulley 442, the second pulley 444, and the belt 446 is stopped. As a result, together with the distal end of the spring member 412 being pulled upwardly from the drum 414 to a predetermined height, the generation of electrical power by the generator 276 also stops.

Further, when the user pulls out the electrical power storage device 208 from the tray 400, the connector 216 and the connector 238 are separated, and the tray 400 is released from the load of the electrical power storage device 208. By the tray 400 being released from the load of the electrical power storage device 208, the drum 414 rotates in a manner so as to wind and take in the spring member 412. Consequently, the belt 446 that is connected to the distal end of the spring member 412 rotates in an opposite direction to when the electrical power storage device 208 and the tray 400 are lowered (refer to FIG. 32A to FIB. 34B). As a result, the first pulley 442 and the second pulley 444 also rotate in the opposite direction to when the electrical power storage device 208 and the tray 400 are lowered. Accordingly, the tray 400 is raised due to the rotation of the belt 446 accompanying the spring force of the spring member 412. Further, the generator 276 generates electrical power due to the rotation of the rotating shaft member 280 accompanying the rotation of the drum 414. The generated electrical power is stored in the sub-battery 294 or the capacitor 380. When the tray 400 is raised up to the position shown in FIG. 32A, the spring member 412 is wound and taken in around the drum 414. Consequently, the rotation of the first pulley 442, the second pulley 444, and the belt 446 is stopped, and together therewith, the generator 276 stops generating electrical power.

Moreover, according to the twelfth exemplary modification, in the case that the electrical power storage device 208 is retained diagonally, the belt 446 is also disposed at an angle. In accordance with this feature, the belt 446 functions as a belt conveyor, and therefore, the frictional force of the belt 446 can be reduced.

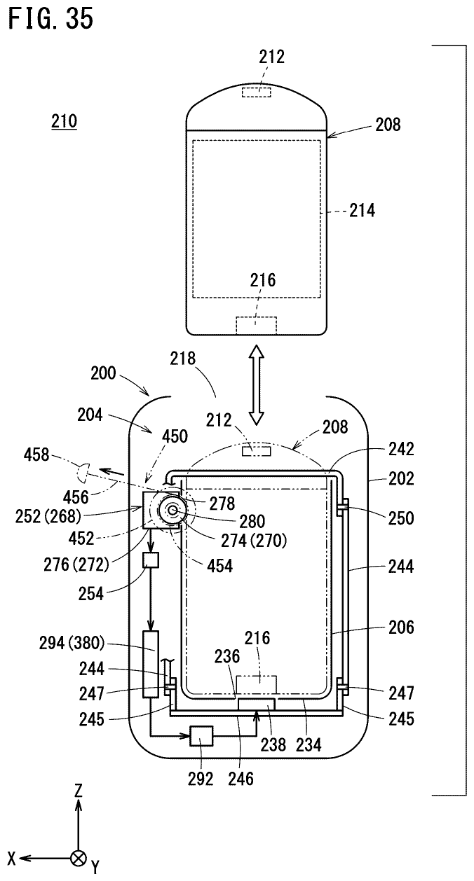

FIG. 35 is a diagram showing a thirteenth exemplary modification. According to the thirteenth exemplary modification, a recoil member 450 (another input unit) is provided in the electrical power device 200. The recoil member 450 is installed, for example, on the outer surface of the casing 202. The recoil member 450 is connected to the rotating shaft member 280 of the generator 276.

The recoil member 450 includes a cover 452, a pulley 454, a string 456, and a lever 458. The cover 452 is attached to the outer surface of the casing 202. The pulley 454 is disposed on the inner side of the cover 452. The pulley 454 is coaxially connected to the rotating shaft member 280. The string 456 is wound around the pulley 454. The lever 458 is connected to a distal end of the string 456 that is pulled out from the pulley 454. The lever 458 is provided on the outer side of the cover 452.

When the user pulls on the lever 458 under human power, the string 456 is pulled out from the pulley 454. By the string 456 being pulled out, the pulley 454 rotates. By the rotating shaft member 280 being rotated accompanying the rotation of the pulley 454, the generator 276 generates electrical power. The generator 276 stores the generated electrical power in the sub-battery 294 or the capacitor 380.

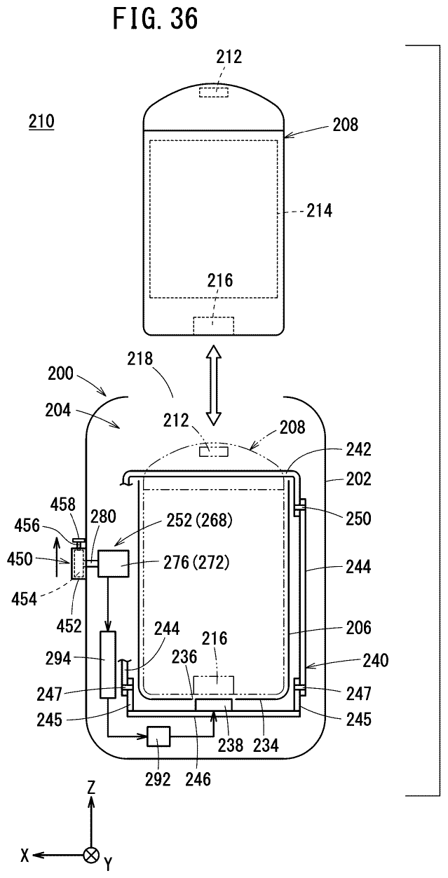

FIG. 36 is a diagram showing a fourteenth exemplary modification. In the fourteenth exemplary modification, similar to the thirteenth exemplary modification, the recoil member 450 is provided on a side surface of the casing 202 of the electrical power device 200. In the fourteenth exemplary modification as well, when the user pulls on the lever 458 under human power, the string 456 is pulled out from the pulley 454, and the pulley 454 rotates. By the rotating shaft member 280 being rotated accompanying the rotation of the pulley 454, the generator 276 generates electrical power. The generator 276 stores the generated electrical power in the sub-battery 294 or the capacitor 380. Moreover, it should be noted that the fourteenth exemplary modification illustrates a case in which the generator 276 is a DC generator. In the case that the generator 276 is an AC generator, the electrical power generated by the generator 276 is converted into a DC electrical power by the AC/DC conversion unit 254 (refer to FIG. 35), and the converted electrical power is stored in the sub-battery 294 or the capacitor 380.

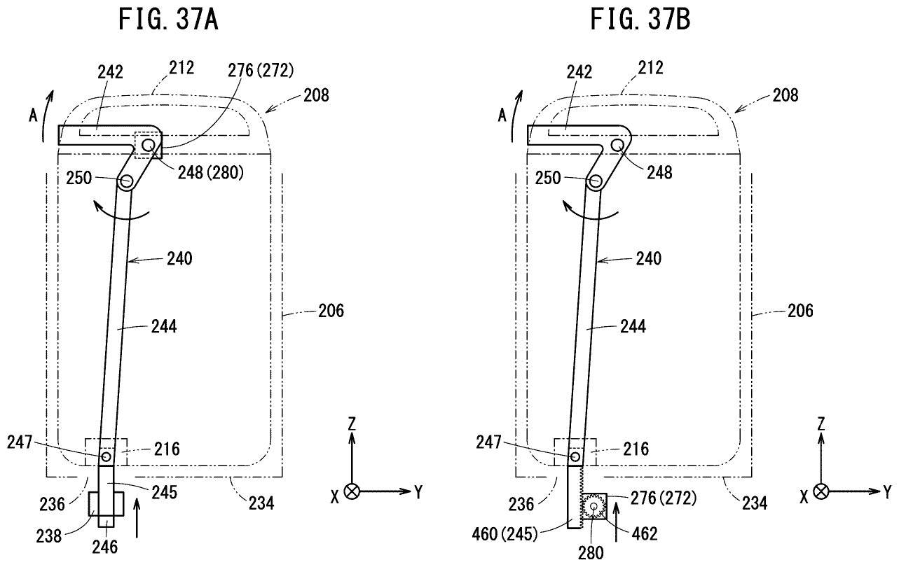

FIG. 37A and FIG. 37B are diagrams showing a fifteenth exemplary modification. In the fifteenth exemplary modification, the generator 276 generates electrical power accompanying the connector displacement mechanism 240 being operated.

In the example of FIG. 37A, the rotating shaft members 248 that axially support the operating lever 242 serve in a dual manner as the rotating shaft member 280. In the example shown in FIG. 37A, when the operating lever 242 is rotated about the rotating shaft members 248, the rotating shaft member 280, which is the rotating shaft members 248, rotates, and thereby the generator 276 generates electrical power.

In the example shown in FIG. 37B, one of the connecting walls 245 from among the two connecting walls 245 is configured in the form of a rack 460. The generator 276 is disposed in close proximity to the rack 460. A pinion 462 is coaxially connected to the rotating shaft member 280 of the generator 276. The pinion 462 enmeshes with the rack 460.

In the example shown in FIG. 37B, when the rack 460, which is one of the connecting walls 245, is raised and lowered, the pinion 462 that is enmeshed with the rack 460 rotates. By the rotating shaft member 280 being rotated accompanying the rotation of the pinion 462, the generator 276 generates electrical power.

According to the fifteenth exemplary modification, in either of the examples shown in FIG. 37A and FIG. 37B, the generator 276 is capable of storing the generated electrical power in the sub-battery 294 or the capacitor 380.

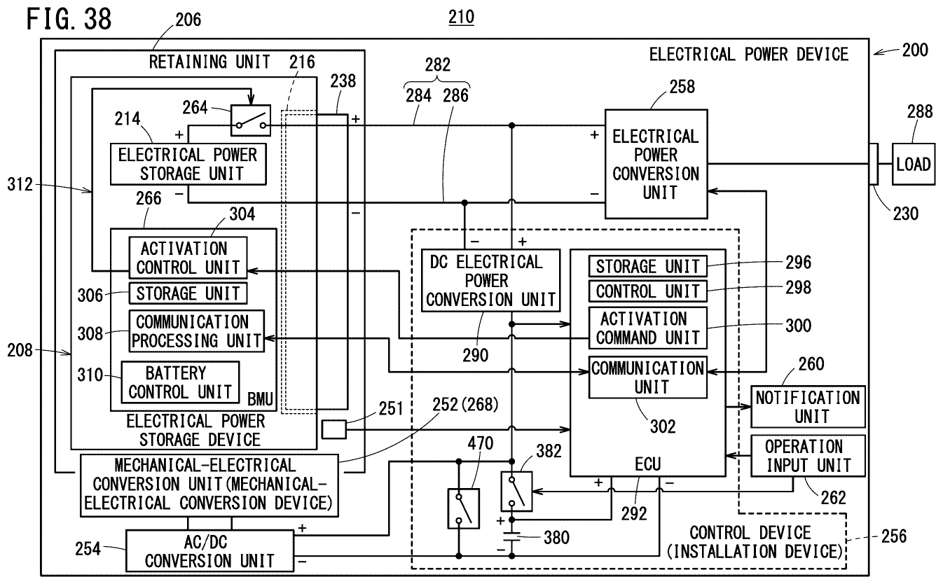

FIG. 38 is a diagram showing a sixteenth exemplary modification. In the sixteenth exemplary modification, between the AC/DC conversion unit 254 and the switch 382 and the capacitor 380, another switch 470 is connected in parallel with respect to the switch 382 and the capacitor 380.

According to the sixteenth exemplary modification, by controlling the manner in which the two switches 382 and 470 are turned ON and OFF, the amount of electrical power generated by the generator 276 (an amount of regenerative electrical power) can be changed. Moreover, it should be noted that the ON and OFF states of the switches 382 and 470 may be carried out under a control from the control unit 298 of the ECU 292. Alternatively, the user may operate the operation input unit 262, and the control unit 298 may control the ON and OFF states of the switches 382 and 470 based on the content of the operation input. Alternatively, the switches 382 and 470 may be turned ON and ON in accordance with operations of the operation input unit 262 input by the user.

In this instance, the reason why the amount of regenerative electrical power can be changed is as follows.

The connector 216 of the electrical power storage device 208 and the connector 238 of the electrical power device 200 are required to have a certain level of durability. When the electrical power storage device 208 is inserted into the electrical power device 200 at a relatively high rate, the connectors 216 and 238 may wear out, and there is a possibility of causing the connectors 216 and 238 to malfunction. Therefore, as noted previously, in the electrical power device 200, when the electrical power storage device 208 is installed therein, the electrical power storage device 208 is temporarily retained by the retaining unit 206, and thereafter, the retaining unit 206 is caused to be moved (lowered) relatively, and to cause the two connectors 216 and 238 to be connected.

The relative movement speed of the retaining unit 206 and the electrical power storage device 208 changes depending on the force when the user inserts the electrical power storage device 208, the temperature of a movement mechanism that causes the retaining unit 206 or the connector 238 to be relatively moved, and the voltage supplied to the movement mechanism, or the like. Stated otherwise, the relative movement speed of the retaining unit 206 and the electrical power storage device 208 might not be stable, depending on the surrounding environment of the retaining unit 206 and the electrical power storage device 208. Further, from the standpoint of improving the marketability of the electrical power device 200 and the electrical power storage device 208, it is preferable to enable the electrical power storage device 208 and retaining unit 206 to be moved at a stable speed. Furthermore, in order to realize a reduction in the size and scale and a reduction in the cost of the electrical power device 200, it is preferable to be capable of eliminating the use of components such as dampers or the like.

Thus, in the sixteenth exemplary modification, the relative movement speed of the retaining unit 206 and the electrical power storage device 208 is controlled by controlling the ON and OFF states of the two switches 382 and 470, and thereby controlling the amount of electrical power (regenerative electrical power) that is stored in the capacitor 380.

Specifically, in the case that both of the switches 382 and 470 are turned OFF, even if the generator 276 generates electrical power, the generated electrical power (regenerative electrical power) is not stored in the capacitor 380. In other words, even if the generator 276 generates electrical power, an electrical current does not flow to the capacitor 380. Consequently, the rotational resistance (resistance of the motor) when the rotating shaft member 280 of the generator 276 rotates becomes smaller. In this case, the rotational resistance and the spring resistance of the spring member 412 act on the retaining unit 206 and the electrical power storage device 208, in opposition to the lowering of the retaining unit 206 and the electrical power storage device 208. However, since the rotational resistance is small, the retaining unit 206 and the electrical power storage device 208 move at a relatively fast movement speed, and thereby the two connectors 216 and 238 are connected. In this case, since the two switches 382 and 470 are turned OFF, the capacitor 380 can be protected from being subjected to an excessive voltage.

Further, when the switch 382 is turned ON and the switch 470 is turned OFF, the electrical power generated by the generator 276 (the regenerative electrical power) is stored in the capacitor 380. In this case, the retaining unit 206 and the electrical power storage device 208 move at a normal movement speed, and thereby the two connectors 216 and 238 are connected.

Furthermore, when the switch 382 is turned OFF and the switch 470 is turned ON, the electrical connection between the generator 276 and the capacitor 380 is suspended, and thereby the generator 276 becomes placed in a short-circuit state. Consequently, the electrical current generated by the generator 276 becomes maximum, and the rotational resistance of the rotating shaft member 280 increases. As a result, in response to the retaining unit 206 and the electrical power storage device 208 being lowered, the resistance (the rotational resistance, the spring resistance) to the retaining unit 206 and the electrical power storage device 208 becomes large. Accordingly, the movement speed of the retaining unit 206 and the electrical power storage device 208 becomes smaller, and the two connectors 216 and 238 are connected at a low movement speed.

Further, in the case that the switch 382 is turned ON, and the switch 470 is repeatedly turned ON and OFF in a short period of time, during a time period in which the switch 382 is turned ON and the switch 470 is turned OFF, the generator 276 stores the generated electrical power in the capacitor 380. Further, during the time period in which both of the switches 382 and 470 are turned ON, since the generator 276 becomes placed in the short-circuit state, the rotational resistance of the rotating shaft member 280 becomes large. Furthermore, the storage of electrical power in the capacitor 380 is temporarily interrupted. In this case, it is possible to adjust the voltage that is stored in the capacitor 380, and to prevent the capacitor 380 from becoming subjected to the excessive voltage. Further, the retaining unit 206 and the electrical power storage device 208 move at a normal movement speed, and thereby the two connectors 216 and 238 are connected.

Moreover, when the generator 276 stops generating electrical power, in the case that the switch 382 is turned ON and the switch 470 is turned OFF, since the electrical charge accumulated in the capacitor 380 can be discharged, the voltage accumulated in the capacitor 380 can be adjusted.

Further, when the generator 276 stops generating electrical power, in the case that both of the switches 382 and 470 are turned OFF, since the discharging of the capacitor 380 is suppressed, the voltage that is stored in the capacitor 380 can be maintained.

In this manner, according to the sixteenth exemplary modification, the ON and OFF states of the switches 382 and 470 are controlled, and by causing the rotational resistance of the generator 276 to be changed, the movement speed at the time that the retaining unit 206 and the electrical power storage device 208 descend can be controlled.

It should be noted that, according to the sixteenth exemplary modification, a case has been described in which the electrical power storage unit of the electrical power device 200 is the capacitor 380. Even in the case that the electrical power storage unit of the electrical power device 200 is the sub-battery 294, by turning the two switches 382 and 470 ON and OFF in the manner described above, the aforementioned functions can be realized.

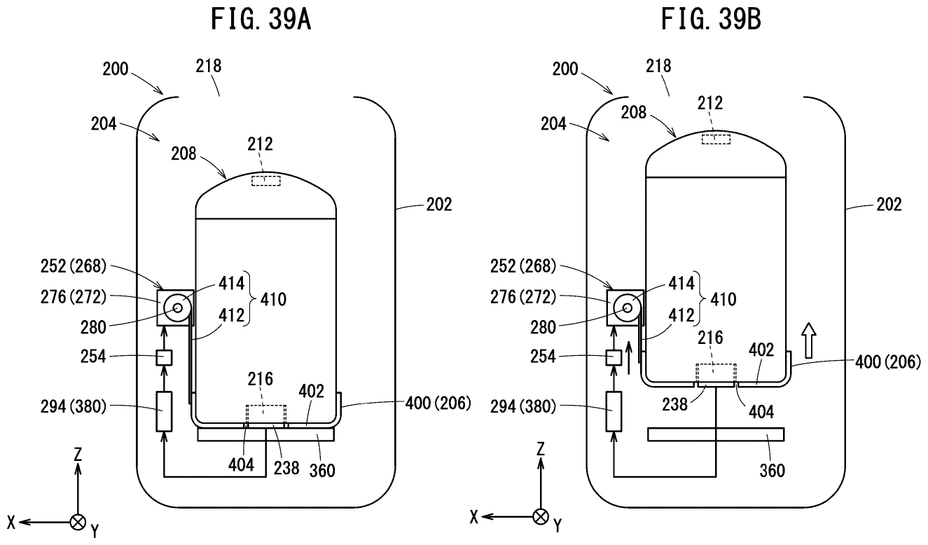

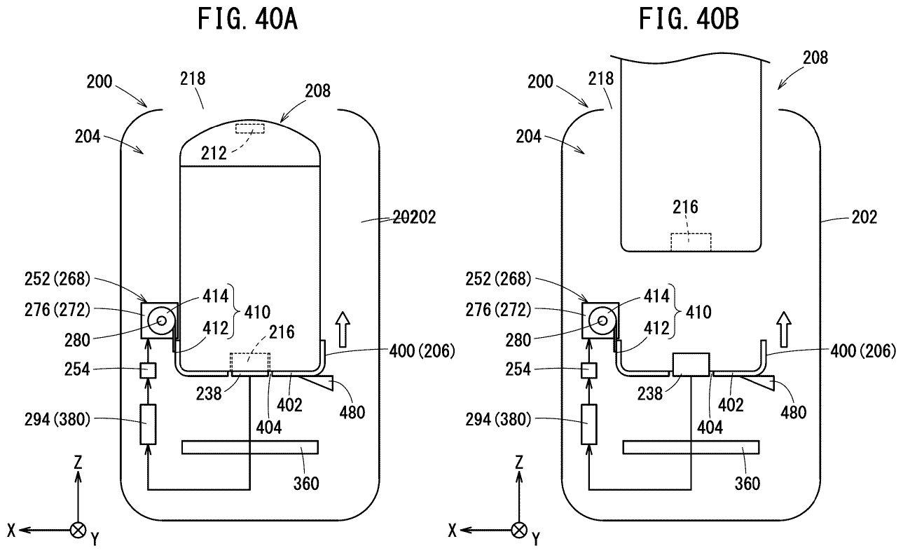

FIG. 39A to FIG. 40B are diagrams showing a seventeenth exemplary modification. In the seventeenth modification, the generator 276 functions as an electric motor (a motor).

FIG. 39A, similar to the ninth exemplary modification shown in FIG. 27, shows a state in which the tray 400 is lowered and the two connectors 216, 238 are connected. In this case, the sub-battery 294 or the capacitor 380 is constantly charged at all times with the electrical power supplied from the electrical power storage device 208.

When the cover 220 is opened by the user, the generator 276 functions as an electric motor, due to being supplied with the electrical power (a power-running electrical power) from the sub-battery 294 or the capacitor 380. Specifically, the generator 276 receives the electrical power and is driven (provides a powering drive), and thereby causes the rotating shaft member 280 in a direction opposite to that during the generation of electrical power. Consequently, the drum 414 of the spring member 410 also rotates in the opposite direction, and winding and taking in of the spring member 412 starts. Accompanying the spring member 412 being wound in the upward direction, the electrical power storage device 208 and the tray 400 receive an upwardly directed force from the spring member 412 and rise together (refer to FIG. 39B).

According to the seventeenth exemplary modification, in a state a being connected to the connector 216 of the electrical power storage device 208, the connector 238 of the electrical power device 200 is capable of rising together with the electrical power storage device 208. Stated otherwise, according to the seventeenth exemplary modification, the connector 238 is not fixed to the support plate 360. The connector 238 is placed on the support plate 360 in a manner so as to be capable of being separated away from the support plate 360.

By the spring member 412 being wound and taken in around the drum 414, the electrical power storage device 208 and the tray 400 rise to the position (the second position) shown in FIG. 40A. At this time, the tray 400 is supported from below by a support member 480 such as a claw member or a ratchet mechanism or the like. After the electrical power storage device 208 and the tray 400 have risen to the position shown in FIG. 40A, the generator 276 stops driving. Moreover, it should be noted that the support member 480 is supported on the casing 202 so as to be capable of advancing and retracting with respect to the tray 400.

Next, when the user pulls out the electrical power storage device 208 from the tray 400, the connector 216 and the connector 238 are separated (refer to FIG. 40B). The connector 238 remains at the position shown in FIG. 40B. Consequently, when the user inserts the electrical power storage device 208 into the electrical power device 200, the two connectors 216 and 238 can be quickly connected.

In this manner, according to the seventeenth exemplary modification, by the tray 400 being caused to rise, without incurring any additional cost, it is possible to assist the taking out of the electrical power storage device 208 from the electrical power device 200.

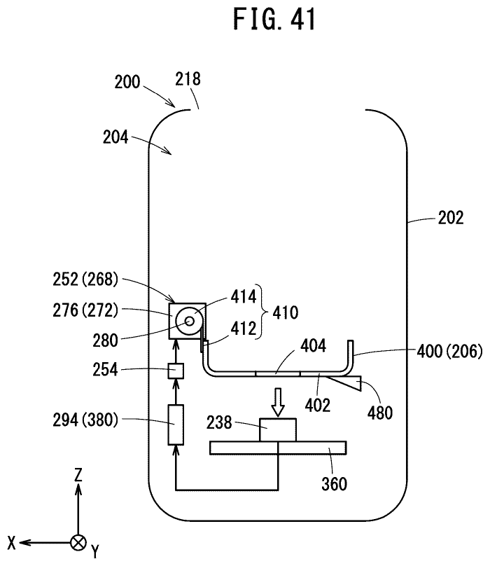

FIG. 41 is a diagram showing an eighteenth exemplary modification. The eighteenth exemplary modification is a partial modification of the seventeenth exemplary modification (refer to FIG. 39A to FIG. 40B).

According to the eighteenth exemplary modification, after the connector 238 has remained in the position shown in FIG. 40B, the connector 238 is lowered until reaching the support plate 360 (see FIG. 41). In the eighteenth exemplary modification, by the connector 238 being caused to descend, it is possible to prevent damage from occurring to the connector 238.

Concerning the aforementioned first embodiment to the third embodiment, the first exemplary embodiment to the fourth exemplary embodiment, and the first exemplary modification to the eighteenth exemplary modification (hereinafter also referred to as the present embodiments), descriptions will be given below concerning further exemplary modifications thereof.

In the descriptions provided above, the battery 12 was inserted and removed in the vertical direction with respect to the electrical power devices 10 and 60 (refer to FIG. 6A to FIG. 10B). Further, the electrical power storage device 208 was inserted and removed in the vertical direction with respect to the electrical power device 200 (refer to FIG. 13 to FIG. 14B, FIG. 16B to FIG. 23B, FIG. 26A to FIG. 37B, and FIG. 39A to FIG. 41). In the present embodiment, the batteries 12 can also be inserted and removed in an oblique direction with respect to the electrical power devices 10 and 60. Further, the electrical power storage device 208 can also be inserted and removed in an oblique direction with respect to the electrical power device 200. In this case, the battery 12 and the electrical power storage device 208 are retained in an oblique direction in the interior of the electrical power devices 10, 60, and 200.

In the description provided above, a description has been given concerning a case in which the electrical power devices 10 and 60 are applied to a vehicle. In the present embodiment, similar to the electrical power device 200, the electrical power devices 10 and 60 can also be applied to an electrical power source device.

According to the third embodiment, the switch 382 was provided (refer to FIG. 24). The voltage of the capacitor 380 is primarily used in order to generate the activation signal. More specifically, the activation command unit 300 functions as an ON/OFF switch with respect to the capacitor 380. Therefore, it is also possible for the switch 382 to be omitted. However, as described above, by providing the switch 382, when the switch 382 is turned OFF, it becomes possible to effectively suppress a spontaneous discharge from the capacitor 380.

In the description provided above, a case has been described in which the switch 382 is turned ON and OFF based on an operation by the user of the operation input unit 262. The switch 382 can also be turned ON and OFF in the following manner. More specifically, the switch 382 may be turned ON or OFF in accordance with a control from the control unit 298 of the ECU 292. Alternatively, when the user may operate the operation input unit 262, the control unit 298 may cause the ON and OFF states of the switch 382 to be controlled based on the content of the operation input by the operation input unit 262.

According to the present embodiment, the capacitors 22 and 380 may be built, for example, into a display interface unit of the electrical power devices 10, 60, and 200. In this case, the display interface unit is provided, for example, on a side surface or an upper surface of the electrical power device 200.

In the present embodiment, in the interior of the electrical power device 200, a rectangular shaped fixed frame may be installed upwardly of the retaining unit 206 including the tray 400, and the retaining unit 206 and the fixed frame may be connected by a plurality of spring members 410. Each of the plurality of spring members 410 has a constant spring output. Therefore, the retaining unit 206 that retains the electrical power storage device 208 can be made to descend efficiently. As a result, the two connectors 216 and 238 can be connected without incurring any damage.

According to the present embodiment, in the case that the electrical power devices 10, 60, and 200 are applied to a vehicle, the user, by rotating the wheels of the vehicle, may cause the motor 18 that is connected to the vehicle wheels, or alternatively, the load 288 that is the motor connected to the vehicle wheels, to be regeneratively driven (generate electrical power). Consequently, the electrical power generated by the motor 18 or the load 288 can be stored in the capacitors 22 and 380. Stated otherwise, according to the present embodiment, in the same manner as the case of starting the engine by pushing the vehicle, the generation of electrical power can be carried out, and the electrical power can be stored in the capacitors 22 and 380.

Further, according to the present embodiment, in the case that the electrical power devices 10, 60, and 200 are applied to a vehicle, the user, by way of his or her leg strength, may cause the motor 18, or the load 288 that is a motor, to be rotated, and thereby may carry out a regenerative drive (generate electrical power). Even in this case, the electrical power generated by the motor 18 or the load 288 can be stored in the capacitors 22 and 380. Stated otherwise, in the same manner as in starting the engine by cranking using leg power, according to the present embodiment, the generation of electrical power can be carried out, and the electrical power can be stored in the capacitors 22 and 380.

According to the present embodiment, a description has been given concerning a case in which the generator 276 is an AC generator. The generator 276 may also be a DC generator.

According to the present embodiment, a description has been given concerning a case in which, when the battery 12 is lowered, the roller 96, the push-down bar 102, etc., which are the input units, come into contact with the battery 12. According to the present embodiment, as in the third embodiment, when the battery 12 is lowered in a state of being installed in the installation unit 14, the input units may come into contact with the installation unit 14.

Concerning the invention that is capable of being grasped from the above-described embodiment, a description thereof will be given below.

The first aspect of the present invention is characterized by the electrical power device (10, 60, 200) equipped with the connection unit (44, 238) to which the electrical power storage device (12, 208) is connected, the electrical operation unit (34, 258) electrically connected to the connection unit, the retaining unit (14, 206) configured to attachably and detachably retain the electrical power storage device, and the mechanical-electrical conversion unit (62, 252), wherein the electrical power storage device includes the electrical power storage unit (41, 214), and the activation processing unit (52, 312) configured to switch the state of the electrical power storage device to the active state in which the electrical power storage unit and the exterior of the electrical power storage unit are electrically connectable, or alternatively, to the inactive state in which the electrical power storage unit and the exterior of the electrical power storage unit are not electrically connectable, wherein the electrical power device, or alternatively, the installation device (256) installed in the electrical power device includes the activation command unit (32, 300) configured to output the command to the activation processing unit, and the other electrical power storage unit (22, 294, 380) electrically connected to the activation command unit, and wherein the activation processing unit is provided so as to be switched to the active state or the inactive state in accordance with the command output from the activation command unit, and the mechanical-electrical conversion unit includes the input unit (74, 94, 102, 270) disposed in a manner so as to receive the kinetic energy accompanying movement of the electrical power storage device in a case that the electrical power storage device is attached and detached with respect to the retaining unit, and the conversion unit (80, 272) configured to convert the kinetic energy input to the input unit into electrical energy, the mechanical-electrical conversion unit being electrically connected to the other electrical power storage unit.

According to the present invention, it is possible to reduce the size and scale of the sub-battery, or to eliminate the sub-battery. More specifically, it is possible to reduce the size and scale of the other electrical power storage unit that is mounted in the electrical power device, and thus the capacity of the other electrical power storage unit can be reduced. Consequently, together with making it possible to avoid an increase in the size and scale of the electrical power device, it is possible to suppress a rise in the cost of the electrical power device. Accordingly, with the present invention, the cost and weight of the electrical power device can be reduced, and the size of the electrical power device can be made smaller. Further, it becomes unnecessary to carry out maintenance on the electrical power device.

In the first aspect of the present invention, the retaining unit may be configured to be movable while in a state of retaining the electrical power storage device, and the input unit may be provided as the retaining unit, or as a portion of the retaining unit, may be provided so as to be mechanically connected to the retaining unit, or alternatively, may be disposed at a position where the input unit is capable of coming into contact with the retaining unit on the movement trajectory of the retaining unit.

In accordance with such features, in the case that the retaining unit by which the electrical power storage device is retained is moved, the input unit can easily receive the kinetic energy of the retaining unit.

In the first aspect of the present invention, the input unit may be provided as the retaining unit, or alternatively, as a portion of the retaining unit, and the conversion unit may include the rotating electric machine (80, 276) electrically connected to the other electrical power storage unit, and the motive power transmission unit (88, 90, 104, 372, 374, 410, 420) configured to mechanically connect the input unit and the rotating electric machine.

In accordance with such features, in the case that the retaining unit by which the electrical power storage device is retained moves, the kinetic energy of the retaining unit can be easily transmitted from the input unit to the rotating electric machine.

In the first aspect of the present invention, the retaining unit may be configured to be movable between the first position defined by the position of the retaining unit in the case that the electrical power storage device is used in the electrical power device, and the second position defined by the position of the retaining unit in the case that the electrical power storage device is detached from the retaining unit.

In accordance with this feature, the retaining unit by which the electrical power storage device is retained can be easily moved.

In the first aspect of the present invention, the conversion unit may further include the urging member (410) configured to urge the retaining member in a direction from the first position toward the second position.

In accordance with this feature, the retaining unit by which the electrical power storage device is retained can be moved more easily.

In the first aspect of the present invention, the rotating electric machine may be configured to be capable of generating the regenerative electrical power by being regeneratively driven, and may be configured to be capable of changing the amount of the regenerative electrical power that is generated.

In accordance with this feature, by changing the amount of the regenerative electrical power, the rotational resistance of the rotating electric machine can be changed. As a result, since the contact resistance between the electrical power storage device or the retaining unit and the input unit can be changed, the movement speed of the electrical power storage device and the retaining unit in the case that the electrical power storage device is inserted into the electrical power device can be adjusted. Accordingly, it is possible to suppress a failure of the connection unit of the electrical power device and the other connection unit of the electrical power storage device caused by the connection between the connection unit and the other connection unit. Further, it becomes possible to appropriately adjust the voltage of the electrical power storage unit.

In the first aspect of the present invention, the rotating electric machine may be configured to be capable of generating a rotational motive power by power-driving, and be configured to be capable of driving the retaining unit by the rotational motive power that is generated.

In accordance with this feature, since the rotating electric machine functions as an electric motor, the retaining unit retaining the electrical power storage device can be moved. As a result, the electrical power storage device can easily be pulled out from the retaining unit.

In the first aspect of the present invention, the electrical power storage device may further include the other connection unit configured to be connectable to the connection unit, and the retaining unit may be provided so as to abut against the electrical power storage device, prior to the connection unit and the other connection unit abutting against each other.

In accordance with this feature, it becomes possible for the input unit or the retaining unit to absorb (buffer) the mechanical energy (the kinetic energy) of the electrical power storage device in the case that the electrical power storage device is retained by the retaining unit. As a result, the occurrence of damage to the connection unit and the other connection unit can be suppressed.

In the first aspect of the present invention, the connection unit may be configured to be relatively movable with respect to the retaining unit by the drive unit.

In accordance with this feature, after the electrical power storage device has been retained by the retaining unit, it becomes possible to cause the connection unit of the electrical power device and the other connection unit of the electrical power storage device to be connected. As a result, the occurrence of damage to the connection unit and the other connection unit can be further suppressed.

In the first aspect of the present invention, the input unit may be disposed at a position where the input unit is capable of coming into contact with the electrical power storage device, on a movement trajectory of the electrical power storage device in the case that the electrical power storage device is attached and detached with respect to the retaining unit.

In accordance with this feature, in the case that the electrical power storage device is moved, the input unit can easily receive the kinetic energy of the electrical power storage device.

In the first aspect of the present invention, the electrical power storage device may further include the other connection unit configured to be connectable to the connection unit, and the input unit may be provided so as to abut against the electrical power storage device, prior to the connection unit and the other connection unit abutting against each other.

In accordance with this feature, it becomes possible for the input unit or the retaining unit to absorb (buffer) the mechanical energy (the kinetic energy) of the electrical power storage device in the case that the electrical power storage device is retained by the retaining unit. As a result, the occurrence of damage to the connection unit and the other connection unit can be suppressed.

In the first aspect of the present invention, there may further be provided connection/disconnection unit (20, 382) disposed on the electrical power transmission pathway between the mechanical-electrical conversion unit and the other electrical power storage unit, and configured to be capable of switching between the disconnected state and the connected state.

In accordance with this feature, it is possible to suppress the electrical charge accumulated in the electrical power storage unit from being spontaneously discharged.

In the first aspect of the present invention, the electrical power device may be capable of being switched between the started state and the unstarted state, and the connection/disconnection unit may be switched from the connected state to the disconnected state, in the case that the electrical power device is switched from the started state to the unstarted state.

In accordance with this feature, it is possible to further suppress the electrical charge accumulated in the electrical power storage unit from being spontaneously discharged.

In the first aspect of the present invention, the electrical operation unit may be the electrical power conversion unit (34, 258) configured to convert the electrical power of the electrical power storage device that is connected to the connection unit, and the other electrical power storage unit may be the capacitor (22, 380) provided in parallel with the electrical power conversion unit.

In accordance with this feature, the capacitor that is originally disposed in the electrical power device can be utilized as a starting electrical power source of the electrical power storage device.

In the first aspect of the present invention, the electrical power conversion unit may carry out the electrical power conversion between the DC electrical power and the AC electrical power.

In accordance with this feature, the present invention can be suitably applied to an electrical power device having an inverter.

In the first aspect of the present invention, the mechanical-electrical conversion unit may be configured so as to input to the conversion unit the motive power from the other input unit (350, 352, 356, 450) into which human power is input.

In accordance with this feature, even in the case that the user has input the human power to the conversion unit using the other input unit, the conversion unit is capable of converting the input energy of the motive power into electrical energy.

In the first aspect of the present invention, the other input unit may be configured to be attachable and detachable with respect to the mechanical-electrical conversion unit.

In accordance with this feature, the usability of the electrical power device is improved.

In the first aspect of the present invention, the electrical power storage unit may be the battery, and the other electrical power storage unit may be the battery (294) or the capacitor (22, 380).

In accordance with this feature, the electrical energy that is converted by the conversion unit can be easily stored.

The second aspect of the present invention is characterized by the electrical power device equipped with the connection unit to which the electrical power storage device is connected, the electrical operation unit electrically connected to the connection unit, the retaining unit configured to attachably and detachably retain the electrical power storage device, and the mechanical-electrical conversion unit, wherein the electrical power storage device includes the electrical power storage unit, and the activation processing unit configured to switch the state of the electrical power storage device to the active state in which the electrical power storage unit and the exterior of the electrical power storage unit are electrically connectable, or alternatively, to the inactive state in which the electrical power storage unit and the exterior of the electrical power storage unit are not electrically connectable, wherein the electrical power device, or alternatively, the installation device installed in the electrical power device comprises the activation command unit configured to output the command to the activation processing unit, and the other electrical power storage unit electrically connected to the activation command unit, and wherein the activation processing unit is provided so as to be switched to the active state or the inactive state in accordance with the command output from the activation command unit, and the mechanical-electrical conversion unit includes the input unit disposed in a manner so as to receive the kinetic energy accompanying the input of human power, and the conversion unit configured to convert the kinetic energy input to the input unit into the electrical energy, the mechanical-electrical conversion unit being electrically connected to the other electrical power storage unit.

In the present invention as well, the same advantageous effects as those of the first aspect are obtained.

In the second aspect of the present invention, there may further be provided the motive power transmission mechanism (240) configured to transmit at least one of the motive powers from among the motive power in order to cause the connection unit to be moved, and the motive power in order to cause the pressing member (249), which is pressed against the electrical power storage device retained by the retaining unit, to be moved, and the input unit may be provided as the motive power transmission mechanism, or as a portion of the motive power transmission mechanism, may be provided so as to be mechanically connected to the motive power transmission mechanism, or alternatively, may be disposed at a position where the input unit is capable of coming into contact with the motive power transmission mechanism on the movement trajectory of the motive power transmission mechanism.

In accordance with such features, in the case that the retaining unit by which the electrical power storage device is retained is moved, the input unit can easily receive the kinetic energy of the retaining unit.

In the second aspect of the present invention, the input unit may be disposed in a manner so as to receive the input of the force of the upper limb or the force of the lower limb.

In accordance with this feature, even in the case that the user has input the human power into the input unit, the conversion unit is capable of converting the energy of the human power that was input into electrical energy.

In the second aspect of the present invention, the electrical power device may be the vehicle including the vehicle wheel, the electrical operation unit may be the electric motor configured to drive the wheel, the input unit may be the vehicle wheel that receives the input of the human power, and is driven thereby, and the conversion unit may be the electric motor.

In accordance with such features, the present invention can be easily applied to vehicles.

The third aspect of the present invention is characterized by the mechanical-electrical conversion device (268) equipped with the input unit, and the conversion unit configured to convert the kinetic energy input to the input unit into the electrical energy, wherein, in the retention device (10, 60, 200) including the retaining unit on which the component (12, 208) is attachably and detachably retained, the input unit is disposed in a manner so as to receive the kinetic energy accompanying the movement of the component in the case that the component is attached and detached with respect to the retaining unit.

In the present invention as well, the same advantageous effects as those of the first aspect are obtained.

In the third aspect of the present invention, the input unit may be disposed at the position where the input unit is capable of coming into contact with the component on the movement trajectory of the component in the case that the component is attached and detached with respect to the retaining unit, or alternatively, may be provided as the retaining unit, or as the portion of the retaining unit, in the case that the retaining unit is provided to be movable in a state with the component retained on the retaining unit, may be provided so as to be mechanically connected to the retaining unit, or alternatively, may be disposed at the position where the input unit is capable of coming into contact with the retaining unit on the movement trajectory of the retaining unit.

In accordance with such features, in the case that the retaining unit by which the component is retained is moved, the input unit can easily receive the kinetic energy of the retaining unit.

The fourth aspect of the present invention is characterized by the electrical power storage device including the electrical power storage unit, the electrical power storage device including the activation processing unit configured to switch the state of the electrical power storage device to the active state in which the electrical power storage unit and the exterior of the electrical power storage device are electrically connectable, or alternatively, the inactive state in which the electrical power storage unit and the exterior of the electrical power storage device are not electrically connectable, and the other connection unit, wherein the other connection unit is electrically connected to the mechanical-electrical conversion unit including the input unit disposed in a manner so as to receive kinetic energy accompanying the input of human power, and the conversion unit configured to convert the kinetic energy input to the input unit into electrical energy, is electrically connected to the activation processing unit, or alternatively, is electrically connected to the activation command unit configured to output the command to the activation processing unit.

In the present invention as well, the same advantageous effects as those of the first aspect are obtained.

The fifth aspect of the present invention is characterized by the electrical power system (210) including the electrical power device according to the first aspect or the second aspect and the electrical power storage device.

In the present invention as well, the same advantageous effects as those of the first aspect are obtained.

The sixth aspect of the present invention is characterized by the method of controlling the electrical power system equipped with the electrical power storage device, and the electrical power device to which the electrical power storage device is connected, wherein the electrical power storage device includes the electrical power storage unit, and the activation processing unit configured to switch the state of the electrical power storage device to the active state in which the electrical power storage unit and the exterior of the electrical power storage unit are electrically connectable, or alternatively, to the inactive state in which the electrical power storage unit and the exterior of the electrical power storage unit are not electrically connectable, the electrical power device includes the connection unit to which the electrical power storage device is connected, the electrical operation unit electrically connected to the connection unit, the retaining unit configured to attachably and detachably retain the electrical power storage device, and the mechanical-electrical conversion unit, the electrical power device, or alternatively, the installation device installed in the electrical power device includes the activation command unit configured to output the command to the activation processing unit, and the other electrical power storage unit electrically connected to the activation command unit, and the mechanical-electrical conversion unit includes the input unit disposed in a manner so as to receive the kinetic energy accompanying the movement of the electrical power storage device in the case that the electrical power storage device is attached and detached with respect to the retaining unit, and the conversion unit configured to convert the kinetic energy input to the input unit into electrical energy, the mechanical-electrical conversion unit being electrically connected to the other electrical power storage unit, the method of controlling comprising the first step (step S1, step S21) in which the electrical power storage device is installed in the retaining unit, the second step (step S12, step S22) in which the mechanical-electrical conversion unit receives the kinetic energy accompanying the movement of the electrical power storage device, and converts the kinetic energy into electrical energy, the third step (step S13, step S23) in which the other electrical power storage unit stores the electrical energy converted by the mechanical-electrical conversion unit, the fourth step (step S5, step S27) in which the activation command unit outputs the command to the activation processing unit by the stored electrical power of the other electrical power storage unit, and the fifth step (step S6, step S28) in which the activation processing unit receives the command, and switches the electrical power storage device to the active state.

In the present invention as well, the same advantageous effects as those of the first aspect are obtained.

The seventh aspect of the present invention is characterized by the program configured to cause the computer (28, 292) to execute the method of controlling the electrical power system according to the sixth aspect.

In the present invention as well, the same advantageous effects as those of the first aspect are obtained.

The eighth aspect of the present invention is characterized by the storage medium (296) configured to store the program according to the seventh aspect.

In the present invention as well, the same advantageous effects as those of the first aspect are obtained.

Moreover, it should be noted that the present invention is not limited to the disclosure described above, but various configurations may be adopted therein without departing from the essence and gist of the present invention.

1. An electrical power device equipped with a connection unit to which an electrical power storage device is connected, an electrical operation unit electrically connected to the connection unit, a retaining unit configured to attachably and detachably retain the electrical power storage device, and a mechanical-electrical conversion unit,
wherein the electrical power storage device comprises:
an electrical power storage unit; and
an activation processing unit configured to switch a state of the electrical power storage device to an active state in which the electrical power storage unit and an exterior of the electrical power storage unit are electrically connectable, or alternatively, to an inactive state in which the electrical power storage unit and the exterior of the electrical power storage unit are not electrically connectable,
wherein the electrical power device, or alternatively, an installation device installed in the electrical power device comprises:
a computer;
an activation command unit, the computer executing a program stored in a memory to cause the activation command unit to output a command to the activation processing unit; and
another electrical power storage unit electrically connected to the activation command unit, and
wherein the activation processing unit is provided so as to be switched to the active state or the inactive state in accordance with the command output from the activation command unit, and
the mechanical-electrical conversion unit comprises an input unit disposed in a manner so as to receive kinetic energy accompanying movement of the electrical power storage device in a case that the electrical power storage device is attached and detached with respect to the retaining unit, and a conversion unit configured to convert the kinetic energy input to the input unit into electrical energy, the mechanical-electrical conversion unit being electrically connected to the other electrical power storage unit.

2. The electrical power device according to claim 1, wherein
the retaining unit is configured to be movable while in a state of retaining the electrical power storage device, and
the input unit:
is provided as the retaining unit, or as a portion of the retaining unit;
is provided so as to be mechanically connected to the retaining unit; or alternatively,
is disposed at a position where the input unit is capable of coming into contact with the retaining unit on a movement trajectory of the retaining unit.

3. The electrical power device according to claim 2, wherein
the input unit is provided as the retaining unit, or alternatively, as a portion of the retaining unit, and
the conversion unit comprises:
a rotating electric machine electrically connected to the other electrical power storage unit; and
a motive power transmission unit configured to mechanically connect the input unit and the rotating electric machine.

4. The electrical power device according to claim 3, wherein the retaining unit is configured to be movable between a first position defined by a position of the retaining unit in a case that the electrical power storage device is used in the electrical power device, and a second position defined by a position of the retaining unit in a case that the electrical power storage device is detached from the retaining unit.

5. The electrical power device according to claim 4, wherein the conversion unit further comprises an urging member configured to urge the retaining member in a direction from the first position toward the second position.

6. The electrical power device according to claim 3, wherein the rotating electric machine is configured to be capable of generating a regenerative electrical power by being regeneratively driven, and is configured to be capable of changing an amount of the regenerative electrical power that is generated.

7. The electrical power device according to claim 3, wherein the rotating electric machine is configured to be capable of generating a rotational motive power by power-driving, and is configured to be capable of driving the retaining unit by the rotational motive power that is generated.

8. The electrical power device according to claim 2, wherein:
the electrical power storage device further comprises another connection unit configured to be connectable to the connection unit; and
the retaining unit is provided so as to abut against the electrical power storage device, prior to the connection unit and the other connection unit abutting against each other.

9. The electrical power device according to claim 8, wherein the connection unit is configured to be relatively movable with respect to the retaining unit by a drive unit.

10. The electrical power device according to claim 1, wherein the input unit is disposed at a position where the input unit is capable of coming into contact with the electrical power storage device, on a movement trajectory of the electrical power storage device in a case that the electrical power storage device is attached and detached with respect to the retaining unit.

11. The electrical power device according to claim 10, wherein:
the electrical power storage device further comprises another connection unit configured to be connectable to the connection unit; and
the input unit is provided so as to abut against the electrical power storage device, prior to the connection unit and the other connection unit abutting against each other.

12. The electrical power device according to claim 1, further comprising a connection/disconnection unit disposed on the electrical power transmission pathway between the mechanical-electrical conversion unit and the other electrical power storage unit, and configured to be capable of switching between a disconnected state and a connected state.

13. The electrical power device according to claim 12, wherein:
the electrical power device is capable of being switched between a started state and an unstarted state; and
the connection/disconnection unit is switched from the connected state to the disconnected state, in a case that the electrical power device is switched from the started state to the unstarted state.

14. The electrical power device according to claim 1, wherein:
the electrical operation unit is an electrical power conversion unit configured to convert the electrical power of the electrical power storage device that is connected to the connection unit; and
the other electrical power storage unit is a capacitor provided in parallel with the electrical power conversion unit.

15. The electrical power device according to claim 14, wherein the electrical power conversion unit carries out electrical power conversion between a DC electrical power and an AC electrical power.

16. The electrical power device according to claim 1, wherein the mechanical-electrical conversion unit is configured so as to input to the conversion unit a motive power from another input unit into which human power is input.

17. The electrical power device according to claim 16, wherein the other input unit is configured to be attachable and detachable with respect to the mechanical-electrical conversion unit.

18. The electrical power device according to claim 1, wherein:
the electrical power storage unit is a battery; and
the other electrical power storage unit is a battery or a capacitor.

19. An electrical power device equipped with a connection unit to which an electrical power storage device is connected, an electrical operation unit electrically connected to the connection unit, a retaining unit configured to attachably and detachably retain the electrical power storage device, and a mechanical-electrical conversion unit;
wherein the electrical power storage device comprises:
an electrical power storage unit; and
an activation processing unit configured to switch a state of the electrical power storage device to an active state in which the electrical power storage unit and an exterior of the electrical power storage unit are electrically connectable, or alternatively, to an inactive state in which the electrical power storage unit and the exterior of the electrical power storage unit are not electrically connectable,
wherein the electrical power device, or alternatively, an installation device installed in the electrical power device comprises:
a computer;
an activation command unit, the computer executing a program stored in a memory to cause the activation command unit to output a command to the activation processing unit; and
another electrical power storage unit electrically connected to the activation command unit, and
wherein the activation processing unit is provided so as to be switched to the active state or the inactive state in accordance with the command output from the activation command unit, and
the mechanical-electrical conversion unit comprises an input unit disposed in a manner so as to receive kinetic energy accompanying an input of human power, and a conversion unit configured to convert the kinetic energy input to the input unit into electrical energy, the mechanical-electrical conversion unit being electrically connected to the other electrical power storage unit.

20. The electrical power device according to claim 19, further comprising a motive power transmission mechanism configured to transmit at least one of motive powers from among a motive power in order to cause the connection unit to be moved, and a motive power in order to cause a pressing member, which is pressed against the electrical power storage device retained by the retaining unit, to be moved,
wherein the input unit:
is provided as the motive power transmission mechanism, or as a portion of the motive power transmission mechanism;
is provided so as to be mechanically connected to the motive power transmission mechanism; or alternatively,
is disposed at a position where the input unit is capable of coming into contact with the motive power transmission mechanism on a movement trajectory of the motive power transmission mechanism.

21. The electrical power device according to claim 19, wherein the input unit is disposed in a manner so as to receive an input of a force of an upper limb or a force of a lower limb.

22. The electrical power device according to claim 19, wherein:
the electrical power device is a vehicle including a vehicle wheel;
the electrical operation unit is an electric motor configured to drive the wheel;
the input unit is the vehicle wheel that receives the input of the human power, and is driven thereby; and
the conversion unit is the electric motor.

23. A mechanical-electrical conversion device equipped with an input unit, and a conversion unit configured to convert kinetic energy input to the input unit into electrical energy;
wherein, in a retention device comprising a retaining unit on which a component is attachably and detachably retained, the input unit is disposed in a manner so as to receive the kinetic energy accompanying movement of the component in a case that the component is attached and detached with respect to the retaining unit.

24. The mechanical-electrical conversion device according to claim 23,
wherein the input unit:
is disposed at a position where the input unit is capable of coming into contact with the component on a movement trajectory of the component in the case that the component is attached and detached with respect to the retaining unit;
or alternatively,
is provided as the retaining unit, or as a portion of the retaining unit, in a case that the retaining unit is provided to be movable in a state with the component retained on the retaining unit; is provided so as to be mechanically connected to the retaining unit; or alternatively, is disposed at a position where the input unit is capable of coming into contact with the retaining unit on a movement trajectory of the retaining unit.

25. An electrical power storage device including an electrical power storage unit, the electrical power storage device comprising:
an activation processing unit configured to switch a state of the electrical power storage device to an active state in which the electrical power storage unit and an exterior of the electrical power storage device are electrically connectable, or alternatively, an inactive state in which the electrical power storage unit and the exterior of the electrical power storage device are not electrically connectable; and
another connection unit;
wherein the other connection unit:
is electrically connected to a mechanical-electrical conversion unit comprising an input unit disposed in a manner so as to receive kinetic energy accompanying an input of human power, and a conversion unit configured to convert the kinetic energy input to the input unit into electrical energy;
is electrically connected to the activation processing unit; or alternatively,
is electrically connected to an activation command unit, a computer executing a program stored in a memory to cause the activation command unit configured to output a command to the activation processing unit.

26. An electrical power system comprising the electrical power device according to claim 1 and the electrical power storage device.

27. A method of controlling an electrical power system equipped with an electrical power storage device, and an electrical power device to which the electrical power storage device is connected, wherein:
the electrical power storage device comprises an electrical power storage unit, and an activation processing unit configured to switch a state of the electrical power storage device to an active state in which the electrical power storage unit and an exterior of the electrical power storage unit are electrically connectable, or alternatively, to an inactive state in which the electrical power storage unit and the exterior of the electrical power storage unit are not electrically connectable;
the electrical power device comprises a connection unit to which the electrical power storage device is connected, an electrical operation unit electrically connected to the connection unit, a retaining unit configured to attachably and detachably retain the electrical power storage device, and a mechanical-electrical conversion unit;
the electrical power device, or alternatively, an installation device installed in the electrical power device comprises a computer, an activation command unit, the computer executing a program stored in a memory to cause the activation command unit to output a command to the activation processing unit, and another electrical power storage unit electrically connected to the activation command unit; and
the mechanical-electrical conversion unit comprises an input unit disposed in a manner so as to receive kinetic energy accompanying movement of the electrical power storage device in a case that the electrical power storage device is attached and detached with respect to the retaining unit, and a conversion unit configured to convert the kinetic energy input to the input unit into electrical energy, the mechanical-electrical conversion unit being electrically connected to the other electrical power storage unit;
the method of controlling comprising:
installing the electrical power storage device in the retaining unit;
receiving the kinetic energy accompanying movement of the electrical power storage device and converting the kinetic energy into electrical energy, by the mechanical-electrical conversion unit;
storing in the other electrical power storage unit the electrical energy converted by the mechanical-electrical conversion unit;
executing by the computer a program stored in a memory to cause the activation command unit to output the command to the activation processing unit by a stored electrical power of the other electrical power storage unit; and
receiving the command and switching the electrical power storage device to the active state, by the activation processing unit.

28. (canceled)

29. A storage medium configured to store a program that causes a computer to execute the method of controlling the electrical power system according to claim 27.
